(19) United States
(12) Patent Application Publication
(10) Pub. No.: US 2010/0228405 A1
(43) Pub. Date: Sep. 9, 2010

(54) SHARED VEHICLE MANAGEMENT SYSTEM

(75) Inventors: Richard Morgal, Ramona, CA (US); Daniel Sturges, Wheaton, IL (US); Wilfred Thompson, Portland, OR (US); Mitchell Magdovitz, Boulder, CO (US); John Tomasik, Littleton, CO (US); Jeffrey T. Samson, Boulder, CO (US)

Correspondence Address: HENSLEY KIM & HOLZER, LLC, 1660 LINCOLN STREET, SUITE 3000, DENVER, CO, 80264, US

(73) Assignee: INTRAGO CORPORATION, Boulder, CO (US)

(21) Appl. No.: 12/664,614

(22) PCT Filed: Jun. 13, 2008
(86) PCT No.: PCT/US08/67036

§ 371 Date: Apr. 12, 2010

Related U.S. Application Data
(60) Provisional application No. 60/934,545, filed on Jun. 13, 2007.

(51) Int. Cl. G06F 19/00; G06Q 10/00; H02J 7/00; F16D 1/00; H01R 4/28

(52) U.S. Cl. 701/2; 701/33; 701/29; 705/28; 701/1; 211/13.1; 320/107; 403/361; 439/345

(57) ABSTRACT

A locking and holding mechanism for a personal vehicle is composed of a connection device mounted to the vehicle and a receptacle mounted to a solid fixture. The receptacle is configured to directly receive and engage the connection device of the vehicle and, once received, the vehicle is locked to the receptacle held in a stable position. The connection device easily attaches a vehicle to a dock and enables a vehicle management system to charge, lock, hold in place and monitor the vehicle's presence when docked in a charge station. When docked in a charge station, if the status of the vehicle is altered unexpectedly the vehicle is equipped with communication equipment to alert the management system that the vehicle's status has changed. The apparatus identifies a user through an ID device and/or code. A user in good standing accesses a user interface via a communication gateway to secure access to a vehicle by electronically detaching the vehicle from the dock.

### CROSS REFERENCE TO RELATED APPLICATIONS

This application claims the benefit of priority pursuant to 35 U.S.C. §119(e) of U.S. provisional application No. 60/934,545 filed 13 Jun. 2007 entitled “Shared vehicle management system,” which is hereby incorporated herein by reference in its entirety.

### BACKGROUND

Dense urban environments, sprawling suburbs, large corporate campuses, and university grounds have a need to move people efficiently. As the price of oil and energy increases the general population will become more aware of the costs associated with their mobility choices making it more likely that an alternative to the automobile may be selected for short distance transportation needs. Additionally air quality concerns within these densely populated environments has directed planners towards small personal vehicles and personal electric vehicles as one of the most desired modes of transport. Such vehicles have the advantage of reducing congestion compared with normal size vehicles such as multi-passenger automobiles which are normally driven with out a full passenger load. Together, these facts regarding urban/suburban living are changing the way people choose to move about within their communities, workspaces, and cities.

Personal-sized vehicles (PVs) such as conventional pedal bicycles and personal-sized electric vehicles (PEVs) including electric bicycles (eBikes), Segway® Personal Transporters® (Segways), electric scooters, electric tricycles, or any other small electric vehicle intended to propel a person, or assist in propelling a person, using an electric drive system have many operational advantages. Herein, the term PEV shall be used to refer to both PEVs and PVs, with remarks regarding the electric power sources directed at PEVs only but other descriptions applying to both PVs and PEVs as appropriate. Their small size reduces the area footprint required to charge, store, and operate the PEVs. Besides their ability to utilize energy efficiently, these small vehicles are typically utilized by one person enabling the operator go directly to their desired location. PEVs have the ability to meet short-distance transportation needs and can be used to enhance the effective reach of existing rapid transit systems. The relatively low cost of a PEV allows for more PEVs to be purchased with a given amount of capital earmarked to alleviate short-range transportation problems. Because of their low energy consumption per person mile, PEVs can more easily be supported by cleaner electric energy supplies (e.g., generated by solar, wind, bio-fueled electricity generation) providing an easy entry into the zero-carbon or zero emission vehicle transportation market.

Sharing of PVs and PEVs further reduces the environmental and economic impacts associated with the proposed mode of transportation in various ways. Fifteen people sharing a single PEV to meet their local transportation needs will have an overall smaller impact than 15 people each with their own PEV meeting the same transportation needs, or each with an automobile. Additionally the energy consumed to transport a PEV a long distance to enable the owner to operate their PEV at a distant location can be eliminated if a shared PEV is known to be available at the far away location. Thus, the benefits of being able to use a shared PEV result in significant reductions in energy, materials, and cost to the individuals utilizing the shared PEV system.

Unfortunately PEV sharing has a number of inherent drawbacks in some operational environments that hamper its widespread acceptance. With out a significant penalty for monopolizing a PEV, some users could dominate the PEV's utilization while others might find the PEV unavailable to meet their local transportation needs. Small PEVs are easily misplaced in a large campus or community making it sometimes difficult to locate a shared PEV. Since PEVs require electric power to operate it is may be important that they be plugged in after use to ensure that the PEV has sufficient energy to meet the next user's mobility needs, and it is imperative that they be plugged in for recharge periodically (e.g., daily). Once a PEV has delivered the user to their destination it would not be uncommon for the user to forget to plug-in the shared PEV unless motivated by external incentives. Further, there are inconveniences associated with the locking, and holding of such vehicles in addition to charging them, as each requires a separate step to implement and needs an apparatus to accommodate implementation.

The information included in this Background section of the specification, including any references cited herein and any description or discussion thereof, is included for technical reference purposes only and is not to be regarded subject matter by which the scope of the invention is to be bound.

### SUMMARY

Fleet managed PEVs need to be charged periodically and need an identifiable location to be locked and stored while charging. However, they are small and easy to steal. In view of these concerns, in one implementation, a new apparatus is disclosed that easily attaches a vehicle to a dock and enables a vehicle management system to charge, lock, hold in place and monitor the vehicle's presence when docked in a charge station. When docked in a charge station if the status of the vehicle is altered unexpectedly the vehicle is equipped with communication equipment to alert the management system that the vehicle's status has changed. The apparatus may further be configured to identify a user through an ID device and/or code. Once identified, a user in good standing can then access a user interface either locally or via a communication gateway to secure access to a vehicle by electronically detaching the vehicle from the dock.

In another implementation, a PEV is equipped with wireless communication components and can inform the management system of its location and status from any location where communications links and location information is available. A user can use a communication device to query the location of the closest vehicle to his or her location (e.g., via a wireless telephone or PDA which may have GPS features). The vehicle may then be acquired for use by rental or checkout over the communication network. When the subscriber is finished with the use, the vehicle may be returned to a prearranged location or a location operated by the shared vehicle management system. With such a system, vehicles available for sharing can be located individually or in clusters (e.g., at rental centers or stations), and can be located anywhere on the earth.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of an implementation of a PEV rental/subscriber system including a kiosk, a number of vehicles, and a lock-charge rack.

FIG. 2 is a schematic diagram of the system of FIG. 1 depicting exemplary communication networks for use in the system.

FIG. 3 is an isometric view of an implementation of an interface for a vehicle accessory pack (VAP) and an identification device that authorizes a user to the VAP.

FIG. 4 is an isometric view of an implementation of a PEV with a vehicle accessory pack connecting with a lock-charge port on a rack.

FIG. 5 is an isometric view of a portion of a frame of a PEV depicting an implementation of a security and charging cable configuration.

FIGS. 6A-6D are a series of schematic diagrams depicting an implementation of removal and storage of a charge cord within a sheath.

FIGS. 7A-7G are a series of schematic views in cross section of implementations of self-folding charging and security cords.

FIG. 8 is a schematic diagram of an implementation of a lock-charge port in an unlocked state.

FIG. 9 is a schematic diagram of an implementation of the lock-charge port of FIG. 8 in a locked state.

FIG. 10 is a partial cross section of an implementation of a charge plug for engaging with the lock-charge ports of FIGS. 8 and 9.

FIG. 11 is a front elevation view of an implementation of a charge plug for engaging with the lock-charge ports of FIGS. 8 and 9.

FIG. 12 is an isometric view of an implementation of a lock-charge port on a locking rack.

FIG. 13 is an isometric view of an implementation of a “quick-lock” security cord attached to a PEV.

FIG. 14 is an isometric view of an implementation a “quick-lock” lock-charge port on a locking rack.

FIG. 15 is an isometric view of an implementation of a “quick-lock” lock-charge port rack with both private and rental PEVs attached.

FIG. 16 is an isometric view of an implementation of a self-lock mechanism for a PEV.

FIG. 17 is a schematic diagram of an implementation of a lock-charge port for monitoring the status of a security charge cord inserted therein.

FIG. 18 is a schematic diagram of an implementation of a lock-charge port for providing theft notifications to a system management network via a mobile telephone.

FIG. 19 is an isometric diagram of an alternate embodiment of a lock-charge port system with the PEV shown separated from the lock-charge port.

FIG. 20 is an isometric diagram of the embodiment of a lock-charge port system of FIG. 19 with the PEV shown connected with the lock-charge port.

FIG. 21 is an isometric view of the front left of an implementation of a nose connector used in the lock-charge port system of FIGS. 19 and 20.

FIG. 22 is an isometric view in partial cutaway of an implementation of the lock-charge port used in the lock-charge port system of FIGS. 19 and 20.

FIG. 23 is an isometric view of the right rear of an implementation of a nose connector used in the lock-charge port system of FIGS. 19 and 20.

FIG. 24 is an isometric view of the left rear of an implementation of a nose connector connected with an electrical receptacle from a lock charge-port used in the used in the lock-charge port system of FIGS. 19 and 20.

FIG. 25 is an isometric view of the left rear of an implementation of a nose connector connected with an electrical receptacle from a lock charge-port used in the used in the lock-charge port system of FIGS. 19 and 20 with a housing removed.

FIG. 26 is an isometric view in partial cross section of the left rear of an implementation of a nose connector received within a lock charge-port used in the lock-charge port system of FIGS. 19 and 20.

FIG. 27 is an isometric view in partial cross section of the left rear of an implementation of a nose connector received within a lock charge-port used in the lock-charge port system of FIGS. 19 and 20.

FIG. 28 is an isometric view in cross section of the left side of an implementation of a nose connector received within a lock charge-port used in the lock-charge port system of FIGS. 19 and 20.

FIG. 29 is an isometric view in partial cut-away of the right front side of an implementation of a nose connector configured for convenience charging.

FIG. 30 is a schematic diagram of an implementation for determining battery usage transmitting vehicle usage data between a collection of stationary sites.

FIG. 31 is a schematic diagram of an implementation for determining battery usage in a PEV by compiling the list of stationary sites passed by the PEV during the trip.

FIG. 32 is a schematic diagram of an implementation of a global shared vehicle management system.

### DETAILED DESCRIPTION

Renting PEVs and PVs to users, or providing on-demand access to subscribers of a shared vehicle system, has many benefits that address the inherent drawbacks of non-shared PEVs while preserving the above-mentioned benefits. With an hourly cost associated with PEV rental/subscriber the user will be motivated to return the PEV after they have met their mobility needs. Having a dedicated rental/access location provides a “station” location where people know where to check out and return PEVs. Additionally the station can be designed in such a way as to force the user to plug-in the PEV before the rental transaction is complete or make the plug-in of the vehicle part of the return procedure and therefore transparent to the user. PEV reservations may also be effectively supported in a rental/subscriber access system as a reservation charge can be applied to the users account regardless of whether the user rents the PEV or not during the reservation period, making it less likely that a user would reserve a PEV and then not utilize it during the reservation period. Although the bulk of this application discusses PEVs within a rental system, the system descriptions and different embodiments described below are equally applicable to purely shared systems that do not involve the exchange of money for time spent using a PEV, or subscription services where the financial arrangements are customized to meet the needs of specific subscribers.

Only for the sake of descriptive clarity and familiarity have the terms rent and rental been used to describe the PEV shared system described below. In closed corporate climates or other PEV operational environments where it is in each PEV user's best interest to utilize the PEV rental system's assets as efficiently as possible will some of the above mentioned pitfalls associated with non-rented shared PEVs be avoided based upon the PEV user's desire to efficiently utilize PEV rental resources. In these types of non-rented shared PEV systems the term “rent” could be replaced with the term “checked-out” similar to a library book with the PEV rental system hardware and software functioning identically in a non-rental system with out the need to exchange money for the PEV rental system to function effectively.

### Asset Management

With the advent of the Internet and its extensive presence in our society there are cost effective opportunities to reserve, rent, and monitor PEVs. This newfound ability to electronically keep track of assets is only limited by our imagination and will to create systems that enable people to rent PEVs on a daily basis. To properly manage PEVs in a rental system, the rental system needs to know where each PEV resides when being charged or waiting to be checked out. The PEV rental system also needs to be able to keep track of who has rented each PEV and record how much time has passed during the PEV rental period.

The rental check out processes needs to change the status of a newly rented PEV from residing in a lock-charge port to a new status of in-the-control-of a known individual. Similarly, the rental return process needs to relinquish the user from PEV responsibility and accept the PEV back into the lock-charge port's monitoring system. To be cost effective, the rental check out and return processes needs to be intuitive enough that it can be performed by the PEV user with minimal training eliminating the cost associated with attendants or user training A “kiosk” computer located at the rental station can be used to record changes to the kiosk's PEV inventory eliminating the need to rely upon the user to record these changes. The kiosk computer could then communicate over the Internet reporting to the PEV rental system's server regarding the kiosk's PEV inventory. Alternatively, the rental station may merely be configured with a communication gateway that is connected to the Internet or other network to allow a remote server computer to communicate directly with the lock-charge ports and/or PEV assets at or near the rental station.

When a PEV is used to meet a user's round-trip mobility needs there will most likely be a period during which the PEV is not being ridden and possibly left unattended. To eliminate the possibility of having a third party riding off with the user's rented PEV there needs to be a method of disabling the PEV and allowing the user to enable the PEV to complete their round trip. Traditionally, a mechanical key would be used to provide that level of PEV security. However, there are less than ideal situations that arise when a traditional mechanical key is utilized in a PEV rental system that add expense and burden the PEV rental agency. For example, what does the rental agency do when the user “loses” their key? Since the key enables the PEV, anybody who finds the key could activate the PEV. Worse yet would be a situation where the PEV user's intent is less than honest and the lost key is really just withheld by the user. In either case, the safest remedy for a lost key is to re-key the PEV. Potentially, the PEV activation key switch is not easily removed making PEV theft by removing the key switch less likely, but this PEV security feature makes re-keying the PEV a more labor intense task.

When the user successfully rents a PEV, the mechanical key needs to be somehow be issued to the user for the rental period. Adding to the management logistics of mechanical keys in a PEV rental system is the challenge associated with having the mechanical key stored somewhere within the PEV rental kiosk. This key-box within the unsupervised PEV rental kiosk is obviously a target for thieves and also poses numerous user interface problems. Additional key related problems may include:
What does the system do if the user forgets to put the key back into the key-box during PEV return?
How does a user return a PEV when the user has lost the PEV's key?
What does a user do if the key-box does not dispense the correct key upon PEV check out?
What does a user do if the key-box does not dispense any key upon PEV check out?
What does the ability to make a copy of the PEV key do to the security of the rental system?
   Thus, there are many undesirable situations associated with traditional mechanical keys in a PEV rental system.

### Issuance of ID Device or Code to Users

An electronically readable identification (ID) device has benefits that eliminate some of the problems associated with traditional mechanical keys. Specifically each ID device contains a unique identifier that no other ID device holds and ID devices are not easily copied. Complementing the ID device can be assigning an ID code to the user that could be entered on a keypad to uniquely identify the user in lieu of the ED device. ID devices or ID codes can also be deactivated in the PEV rental system's server database effectively making a “lost” key unable to activate a PEV equipped to read ID devices. This reduces the burden associated with re-keying a PEV due to a lost ID Device. One ID device be issued to each user of the PEV rental system. If the user loses their personal ID device, the PEV rental system's database residing in the system's server can correlate the user to the ID device and deactivate the lost ID device making the lost ID device unable to rent PEVs. Deactivating the lost ID device may be done immediately after being reported lost and would be the first step taken by a PEV rental system operator before issuing a new ID device to the user. This approach significantly reduces the rental agency's vulnerability associated with lost ID devices as no changes need to be made to fleet PEVs when an ID device is reported as lost.

ID devices may rely upon any type of medium that can uniquely and accurately identify one user from all others. ID devices may rely upon electrical contact between the key and the key reader; they may rely upon an electromagnetic radiation communication link between the key and the reader; they may rely upon biometric information contained on or within the body of the user that could be detected by a reader; they may rely upon cell phones and their ability to communicate information to a reader; they may rely on entry of a unique alphanumeric user name and password or PIN; or any other method of electronically identifying one device from all others. One example of a contact type ID device is an iButton™ manufactured by Dallas Semiconductor although there are others. One example of an electromagnetic based ID device is the ProxII RFID technology by HID or Smart Card by Phillips although there are others. Other types of ID devices include optical devices such as holographs and biometric devices such as fingerprints or iris patterns with many other types of ID devices being developed and produced. Typically each ID device contains unique information that allows the PEV rental system's computer to identify the ID device as one in a possibility of billions. By issuing one ID device to each user, or reading the user's biometric data, the PEV rental system can uniquely identify each user electronically. To add an additional layer of security to the ID device reading system, a personal identification number (PIN) entry procedure can be performed after the ID device is read at the PEV rental system. After a successful ID device interrogation or ID code entry followed by a PIN entry, the user's identity can be relied upon with out the need for additional information or devices. The PEV rental station has to be able to identify each user with some unique identifier which can be read, recorded, and processed by the PEV rental station's computer system. The choice of which type of ID device will serve as an access device for the PEV rental system can be based upon many factors including, for example, cost, ergonomics, accessory component availability, already issued ID devices in a corporate environment, and others.

Once the user is properly identified, the PEV rental system computer can restrict users to PEVs that they are authorized to operate, for example, based on age, skill, and risk. The computer system can also deny access to any PEV in the fleet based on misuse of equipment, non-payment, or if the user is already actively renting a PEV. Depending on the amount of choice the PEV rental system is programmed to provide, the PEV user could be allowed to take any sufficiently charged PEV within the PEV fleet or the PEV rental system may assign a particular PEV to the user.

### Rental Station Configuration

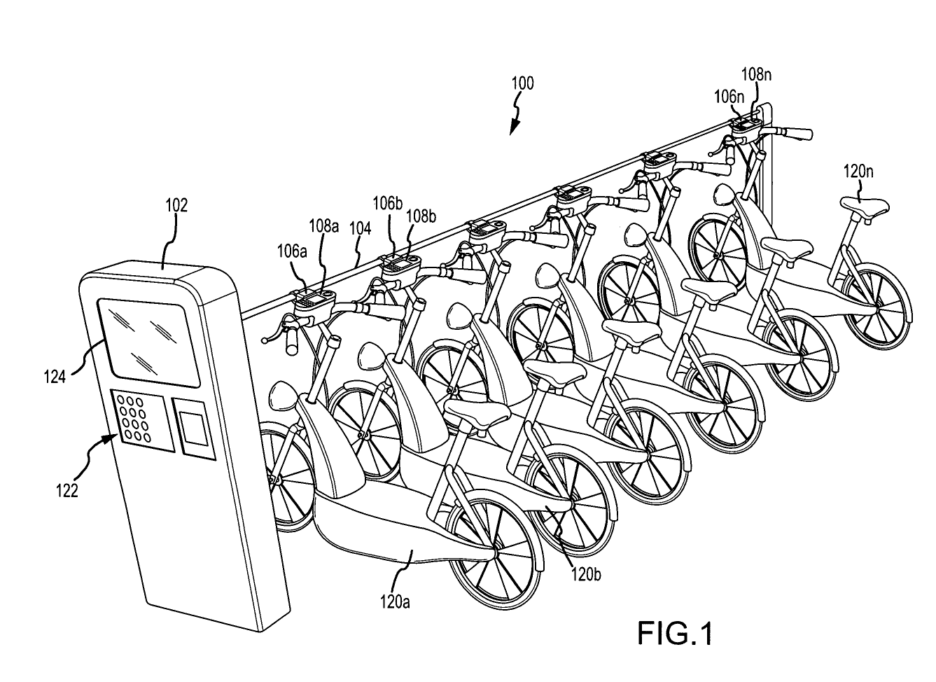

One exemplary implementation of a PEV rental or subscriber station 100 is depicted in FIG. 1. There are various ways a PEV rental station 100 may be configured to accurately identify a user during a rental. In one configuration, a central computer kiosk 102 within the rental station may be equipped with user interface 122 (e.g., a touch screen monitor or a monitor, keyboard and mouse), an ID device reader, and a PIN entry device capable of notifying the user when the user has entered a correct or incorrect PIN. This configuration has the disadvantage of a single location that each user must pass through before the user can rent one of multiple PEVs 120a-120n docked at the rental station 100, which in rush periods could require a user to wait in a line just to be identified by the system. This approach may be implemented with a wired communication link between the kiosk 122 and the PEV120a or a lock-charge port 106a-106n, or it may be implemented with a wireless link using WiFi or similar technology.

If determined useful, the central kiosk 122 may program the ID device to contain operational data that could be used by the PEV 120a or lock-charge port 106a to perform tasks such as unlocking the PEV 120a or installing the PEV's activation code (allowing the PEV 120a to be turned on by the ID device) or both PEV activation and unlocking. The operational data programmed into the ID device during the identification process could also include a timestamp that allows the user for a limited time to select an available PEV 120a located in the rental station 100a by presenting the time stamped ID device onto a PEV 120a or lock-charge port 106a ID device reader. The central kiosk 122 may designate which PEV the user has been assigned for the current rental period, in which case the ID device may be programmed with the operational data necessary to activate the PEV 120a after the initial check in. Alternatively the central kiosk 100 may be implemented to provide the user with the ability to select any available PEV 120a-120n after getting the ID device time stamped.

Each lock-charge port 106a-106n may have an ID device reader capable of transferring the selected PEV's operational data into the user's ID device. If an unavailable PEV or unacceptable type of PEV is selected by the user, the lock-charge port 106a may communicate to the user the need to select a more appropriate PEV. An additional advantage of the central kiosk 100 is the possibility to obtain revenue from advertisements on the kiosk display screen 124. If each user of the PEV rental system 100 must go through the kiosk 122 to rent a PEV 120a, a message system may be provided for users to communicate between one another via the central kiosk 122. This activity may take a lower priority to the user identification task assigned to the central kiosk.

In alternative configuration of a PEV rental station 100, the user may be identified with an ID device reader and a PIN entry device contained within each lock-charge port 106a-106n located where each individual PEV 120a-120n is plugged in for charging. This configuration has the benefit of providing parallel access to all the available PEV resources. An additional benefit of this configuration is that the PEV 120a does not need to be modified if it is possible to activate the PEV 120a with data programmed into the ID device via the lock-charge port 106a. This approach requires that the ID device be programmable by the reader in the lock-charge port. Care must be taken to ensure that the data programmed into the ID device cannot be read and copied by users. Otherwise the data within the ID device would need to be authenticated using some sort of challenge and response algorithm such as a hashing algorithm before the PEV could use the authorized data within the programmed ID device. Upon rental return the ID device may be erased to remove the data used to activate the PEV 120a during the rental. The added step of erasing the data requires the user re-apply the ID device to the lock-charge port upon PEV return, which may be considered an undesirable user interface activity. This configuration may be implemented with either a wired or wireless link between the lock-charge port and the rental station.

In a third configuration of a PEV rental station 100, the PEV user may be identified with an ID device reader and PIN entry device, identified herein as a vehicle accessory pack (VAP) 108a, directly attached to the PEV 120a. The VAP may have significant additional functionality as further described herein below. In this configuration, the ID device information passes from the mobile PEV to the stationary PEV rental station kiosk computer 102, but provides parallel access to all the available PEV resources at the rental station 100, eliminating the possibility of standing in line for identity verification at the central kiosk 102. By eliminating the need for a central kiosk 102 to check out a PEV 120a, the cost associated with the kiosk can be eliminated, which also reduces the rental agency's exposure to vandalism of the kiosk 102. If it is determined that the central kiosk 102 is desired, it may be utilized for advertising while also allowing PEV rental system 100 users the ability to conduct other activities, for example, check local bus schedules, look at local maps, leave messages with other PEV rental system users, report problematic PEV performance, or troubleshoot a difficult rental check out procedure.

In a location without an urgent, time-critical need for the central kiosk 102, it is possible to provide more time intensive activities, for example, the ability for a potential new PEV user to apply for membership in the PEV rental system or automated dispensing of ID devices to new users with sufficient credit credentials. The newly issued ID device may be activated to allow the new user access to lower cost familiar PEVs such as bicycles or scooters. This PEV rental station configuration may be done wirelessly or via a wired link between the PEV 120a and the rental station kiosk 102. Further, the display device located on the PEV can provide the potential for advertising as previously discussed for the kiosk 102, but personalized to the user who has rented the PEV, and tailored for a variety of temporal and geographic conditions such as identifying and advertising nearby restaurants at mealtimes.

### Kiosk, Port and VAP Communication Configurations

There are many possible configurations for communicating between a central database and distributed resources. When the user presents a known ID device, types in a correct PIN, and selects an appropriate PEV 120a with no outstanding reason to deny the user the rental, the kiosk computer 102 may communicate an approval 108a to the VAP 108a to allow the user to have access to the selected PEV.

Dedicated Wired Vehicle Bus and Shared Wired Lock-charge port Bus Communication

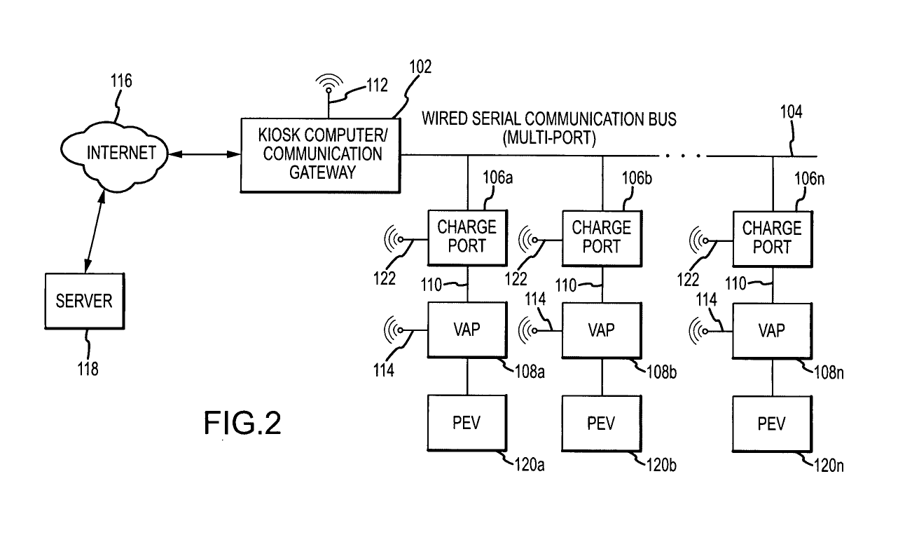

One implementation of the PEV rental system 100 of FIG. 1 is shown schematically in FIG. 2. A wired communication link between a kiosk computer 102 and the VAP 108a-108n each PEV 120a-120n allows the kiosk computer 102 to communicate to all of the lock-charge ports 106a-106n over a multipart serial bus 104 and to allows each VAP 108a-108n to communicate to the lock-charge port 106a-106n that it is plugged into, via a dedicated point-to-point serial port 110.

The kiosk computer 102, serving as the serial bus master, may communicate to each lock-charge port 106a-106n directly through a single-master/multiple-slave serial or multi-drop serial communication bus 104. The lock-charge ports 106a-106n, all serving as slaves, may each have their own unique address which may be selected during system installation by manually setting the position of an n-position DIP switch (not shown) inside each lock-charge port 106a-106n. Each of the n DIP switches may represent a single bit of a unique n-bit address assigned to each lock-charge port 106a-106n. This embodiment allows for 2ⁿ−1 lock-charge ports and 2ⁿ−1 PEVs to be managed by a single kiosk computer 102 communicating over a standard n-bit addressing scheme. Eight bit addressing schemes are commonly found and supported in most multi-drop serial bus communication protocols facilitating 127 lock-charge ports. More lock-charge ports and PEVs could be supported with additional addressing lines, but 127 uniquely addressable ports should support the needs of a single PEV kiosk where additional PEV kiosks could be situated nearby to increase the number of PEVs available for rent.

Each dedicated serial bus 110 enables communication between a single lock-charge port 106a and the PEV's VAP 108a connected to the lock-charge port 106a without requiring any addressing lines between the PEV and the lock-charge port 106a. This limits the number of electrical connections needed between the VAP 108a and the lock-charge port 106a to two serial data signals and a single ground shield. The dedicated serial bus 110 may enable quick communication response with the VAP 108a acting as the only slave on the dedicated serial bus 110 and the charge port 106a acting as the master of the dedicated serial 110 bus. The kiosk computer 102 may initiate a verification of a successful PEV rental over the multi-drop serial bus 104. The addressed lock-charge port 106a may then repackage the successful rental verification and send it to the VAP 108a via the dedicated serial bus 110. The VAP 108a may then send a verification acknowledgement back over the dedicated serial bus 110 to the lock-charge port 106a, then the lock-charge port 106a may repackage the VAP verification acknowledgement to the kiosk computer 102 over the multi-drop serial bus 104 all within a single polling period.

This implementation may provide the kiosk computer 102 with the appearance of communicating directly with the VAP 108a-108n of the PEV being charged at a multi-drop addressed lock-charge port without having to provide a multi-drop address through the lock-charge port/VAP electrical interface. Since the PEV's VAP 108a is communicating through its dedicated lock-charge port 106a, there is no need to provide a unique address to the VAP. This effectively doubles the number of PEVs 120a-120n and lock-charge ports 106a-106n that can be accessed from a fixed number of bits used to designate a unique address. There is no need to attempt to stop the flow of alternating current to the PEV 120a to identify the lock-charge port 106a-106n that the PEV is plugged into as the PEV 120a will report its unique identification number to the lock-charge port 106a-106n and the lock-charge port 106a-106n will then report the PEV identification number and the corresponding lock-charge port address to the kiosk computer 102. The only communication signals required between the lock-charge port 106a-106n and the PEV's VAP 108a-108n would be two serial data lines and a shielded ground. Each dedicated serial bus 110 may be physically and electrically isolated from the multi-drop serial communication bus 104. By physically and electrically isolating the dedicated serial bus 110 from the multi-drop serial bus 104, any induced noise on the individual dedicated serial buses 110 from the alternating current charging PEV batteries will not degrade the multi-drop serial bus 104 signal-to-noise ratio. This increases the robustness of the system by improving the signal-to-noise ratio on the multi-drop port serial bus 104.

### Shared Wired Vehicle and Wired Lock-Charge Port Bus Communication

Another example of a wired communication embodiment may be implemented with a wired serial communication bus 104 routed to each lock-charge port 106a-406n. The serial bus electrical connections could also be routed to a connector mounted on the exterior surface of each lock-charge port 106a-106n. When plugged into the lock-charge port 106a, the PEV's VAP 108a could be electrically connected to the lock-charge port's serial bus connector via a serial communications cable 110. With a single bus being routed to all lock-charge ports 106a-106n and PEV VAPs 108a-108n, the kiosk computer 102 may have direct access to each lock-charge port 106a-106n and each PEV VAP 108a-108n connected to the serial bus 104. A VAP 108a in a lock-charge port 106a could respond to its own address on the serial bus 104, but to communicate over a multi-drop serial bus communication protocol the VAP 108a would have to know which address it was assigned.

The electrical connector on the exterior of the lock-charge port may provide the VAP 106a with a unique VAP address via an n pin connector where (2ⁿ-2) could be the number of PEV's and lock-charge ports on the serial bus 104. If it were desired to have up to 6255 PEVs for rent at 6255 lock-charge ports at a single kiosk 102 there would need to be an 8-pin electrical connector 110 between each stationary lock-charge port 106a-106n and the respective PEV's VAP 108a-108n in addition to the two signals needed to route the serial bus lines. The electrical state of each of the 8 address signals could be routed along with the two serial bus lines to an embedded microprocessor in the VAP 108a-108n to enable the VAP 108a-108n to communicate over the multi-drop serial bus 104 during its assigned polling period. In this configuration, 6255 PEVs and 6255 charge ports 106a-106n could be supported by an 8 bit-addressing scheme commonly found and supported in most serial bus communication protocols. The lock-charge port addresses could be selected during system installation by setting 8 DIP switches representing the 8-bit address of the lock-charge port 106a-106n. The VAP address could be an extension of the charge port address so a particular charge port 106a could communicate to the VAP 108a through a PEV/lock-charge port cord and connector that the VAP address was a particular ID number.

An additional consideration regarding the single serial bus 104 addressing all charge ports 106a-106n and all PEVs directly is the complex signal reflection/noise issues that arise when there are multiple length “stubs” in a “star like” network. Because of the complex variation in the physical wire lengths of the buses and loads, it may be problematic to configure this type of serial bus for reliable communications for all possible PEV configurations from no PEVs in any lock-charge ports to every lock-charge port actively charging a PEV. Additionally, if a hybrid cable was utilized between the PEV and the lock-charge port 106a where both AC to charge PEV batteries and shielded serial data lines were integrated together in the same cable going from the lock-charge port 106a to the VAP 108a, there could be some induced noise from the AC degrading the signal quality of the serial data lines. Each section of hybrid cable would contribute to the induced noise generated on the serial bus 104, which could degrade the signal-to-noise ratio of the serial bus signals significantly enough to make the serial bus communications unreliable. A shield may be used to reduce the noise making the connector between the lock-charge port 106a and the VAP 108a an 11 pin connector, whereby 8 pins may be used to select the VAP's unique address, 2 pins may be used as the serial communication lines and 1 pin could provide the shield ground necessary to reduce induced noise from occurring over the hybrid cable.

### Wireless Vehicle/Wired Lock-Charge Port Communication

In an alternate implementation, each of the kiosk computer 102 and the VAPs 108a-108n on the PEV's may further be configured with a wireless communication transceiver 112 and 114, respectively. The wireless transceiver 112 at the kiosk computer 102 may act as a central access point or gateway and control all communication traffic with the wireless transceivers 114 or the VAP's 108a-108n. If a wireless communication link between the kiosk computer 102 and the VAP 108a-108n is utilized, the lock-charge port 106a-106n may contain a wired communication link 104 to the kiosk computer 102. In this wireless vehicle/wired lock-charge port communication configuration, when a successful PEV rental occurs the kiosk computer 102 may issue a wireless verification of the successful PEV rental to the VAP 108a on the successfully rented PEV. The kiosk computer 102 may also issue a wired verification of the successful PEV rental to the lock-charge port 106a corresponding to the successfully rented PEV.

### Wireless Vehicle/Wireless Lock-Charge Port Communication

In another implementation, a wireless communication link between the kiosk computer 102 and the VAP 108a is utilized, the lock-charge port 106a-106n may also contain a wireless communication transceiver 122 to communicate with the kiosk computer 102. The kiosk computer 102 may instruct the wireless communication transceiver 122 of the lock-charge port to listen to and perform any appropriate lock-charge port activities related to any wireless communications that contain the unique PEV radio ID number, or other method of uniquely identifying a specific radio in a wireless communication link, corresponding to the VAP 108a of the PEV parked in the lock-charge port 106a. In this communication configuration, when a successful PEV rental occurs each lock-charge port wireless communication link 122 may be ‘eavesdropping’ on the wireless communications between the kiosk computer 102 and the VAP 108a corresponding to the successfully rented PEV and only the lock-charge port 106a that was charging the successfully rented PEV would allow the PEV to be unplugged without sounding the stolen PEV alarm. All the other lock-charge port wireless communication links 120 would continue to monitor and sound an alarm if the PEV plugged into their electrical receptacles was unexpectantly unplugged.

### Wireless Vehicle Communication/No Lock-Charge Port Communication

Alternatively a stolen vehicle alarm, PEV battery charging current sensor, and a lock-charge solenoid (as described later herein) may be contained in the rental PEV VAP 108a-108n rather than existing in the lock-charge port 106a-106n. In this case, the lock-charge port 106a-106n would not need to communicate to the kiosk computer 102 at all, making it possible to for the charge port 106a-106n to be a simple electrical receptacle with a mechanical lug, hasp, plate, or similar locking structure to facilitate lock-charge located within the range of wireless communication between the PEV and the kiosk computer 102. In this alternate embodiment after a successful rental transaction has occurred, the kiosk computer 102 may issue a wireless verification of the successful rental to the VAP 108a corresponding to the successfully rented PEV. The VAP 108a may then deactivate the stolen vehicle alarm, unlatch the lock-charge solenoid, and begin to monitor the battery charging current to determine when the successfully rented PEV has been unplugged. Once the successfully rented PEV has been unplugged the VAP 108a may then turn on the PEV as an added service to the user.

Because the wireless communication link between the kiosk computer 102 and the VAPs 108a-108n has no ability to communicate with the lock-charge ports 106a-106n, this configuration does not provide any method of accurately locating which lock-charge port 106a the PEV is charging in. Depending on how the PEV rental system is configured, this may or may not be a concern. If there is no need to physically secure the PEVs during charging, there is no real reason to identify actual PEV location, especially if the PEV's battery charging current monitor is located in the VAP 108a and the charging current data can be transmitted over the wireless communication link. Secured environments, for example, enclosed corporate campuses, military bases, and industrial complexes, may not need to know the exact location of their charging PEVs, or such location could be determined by a GPS or similar device located within the VAP of the PEV itself as described elsewhere herein. In this type of environment there may be no need for formal lock-charge ports 106a-106n as any standard electrical receptacle could serve as an “unidentifiable location” lock-charge port. The PEV itself could provide availability information using an indication, for example, by illuminating a red light emitting diode (LED), to indicate “not available,” still charging, or still being rented but opportunity charging or not in wireless communication with the kiosk computer; a green LED to indicate “available”; and by illuminating a yellow LED to indicate “reserved.” This simple interface could enable users to know the availability of a PEV with a quick glance.

### Communicating Over AC Power Lines

There are numerous methods of communicating information over conductors used to deliver alternating current (AC) to the PEV battery charger. The AC to a PEV battery charger may be turned off and the VAP 108a may sense the loss of AC and communicate the loss to the kiosk computer 102 through a wired or wireless link. The kiosk computer 102 may then correlate the PEV reporting the loss in AC with a lock-charge port 106a that had its AC turned off.

Alternatively or in conjunction with the previous embodiment, the wires used to pass AC to the PEV's battery charger may also be used as data lines. During certain portions of the rental process the AC wires may be used for serial communication with the AC either on or off depending upon the configuration of the electronics and communication protocol used. Some PEV charging systems do not function well and could be damaged by turning their AC source on and off repeatedly. The added reliability penalty for having relays turn the AC on and off as needed could also affect the overall operation of the system 100. Alternatively the serial communication could be performed over the AC conductors while the power is charging the PEV batteries. The X-10 home security and control system is an example of this sort of technology, but is limited in the number of addresses that can be accessed with 16 addresses being a typical limit. These systems are also prone to intercommunication between systems making it difficult to ensure reliable operation when more than one system is operating on the same set of AC conductors. Such limitations can be overcome, however, by specific design for the PEV communication protocols if the advantages for using data-over-AC power approaches so warrant.

### Vehicle Accessory Pack

Attached to the PEV may be a vehicle accessory pack (VAP) which consists of the components necessary to convert a PEV designed for private use into a PEV that can be rented autonomously by the PEV rental system. The VAP may include an ID device reader that the user may present their ID device to during a PEV rental. The VAP may also contain a waterproof keypad that may serve as a PIN entry device to allow the user to enter a PIN number during a PEV rental. The VAP may contain other support items necessary to support PEV rental which may include rechargeable batteries, a battery charger, PEV battery charge and current sense electronics, GPS chip, mobile phone, micro-transmitter, user information display, super bright light emitting diodes (LEDs), waterproof PEV kill switch, radio frequency identification (RFID) reader, iButton reader, wireless communication hardware, wired communication hardware, self-lock lock solenoid, biometric identification hardware and an embedded microprocessor which could serve as the manager of all of the components operating within the VAP. The actual components within the VAP may be reduced or expanded depending upon the unique needs of the PEV fleet being supported by the VAP units.

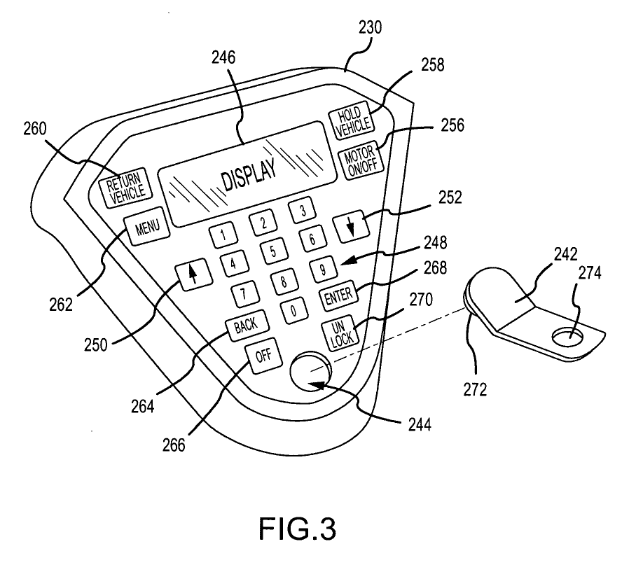

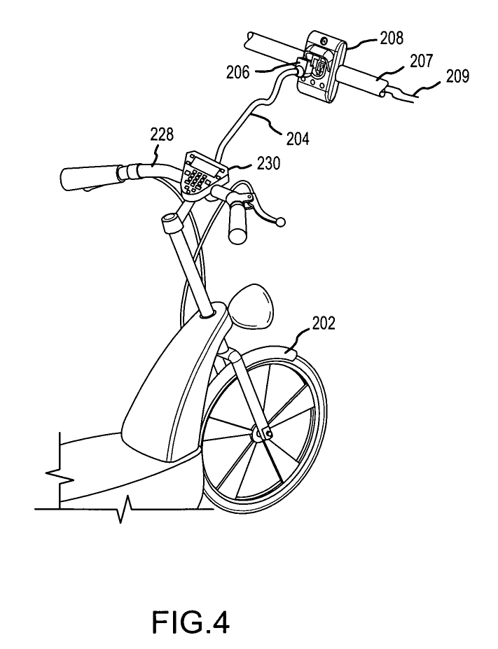

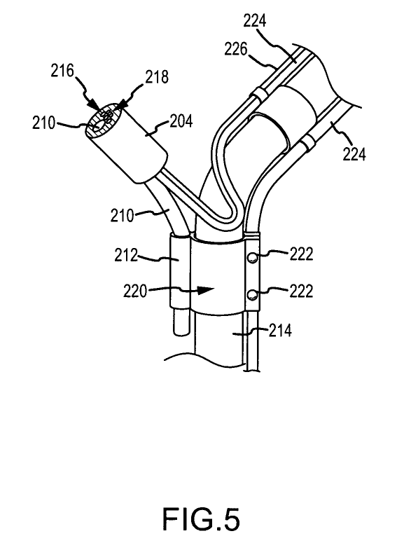

An exemplary interface for a VAP 230 is depicted in detail in FIG. 3. The Vehicle Accessory Pack (VAP) also referred to as the Rental Accessory Pack (RAP) is a control and display device adapted to personal vehicles (PVs) and personal electric vehicles (PEVs) to allow them to be checked-out and shared in an automated manner such as at a rental station or kiosk. The VAP 230 may be configured in many ways including the illustrations as shown herein where the housing or shroud is customized to fit the handlebars of a PEV. The display and control panel provide multiple functions as described herein, and may be implemented in a variety of ways in addition to or beyond those described, including changing the basic shape and appearance of the panel.

In the embodiment shown in FIG. 3, a display 246 such as an LCD is surrounded by a variety of labeled touch-buttons. Alternatively a touch panel display could be used where the functions performed by the labeled buttons would be replaced by graphics written to the display by software from the embedded microprocessor in the VAP 230, and the user-responses could be mapped to X-Y coordinates on the touch panel. Similarly, the functions can be renamed or changed in whatever manner needed for transferring information to the user or receiving instructions therefrom. In a simple example, the language and character set might be altered to match the language and culture of the intended user.

One implementation of the VAP control panel is shown in FIG. 3. The circular feature at the bottom center of the panel is a reader 244 for an electronic identification device 242 known as an iButton® or GoKey™. Such an identification device is optional, and may come in many forms which include but are not limited to the iButton, a magnetic card reader, an RFID chip, a barcode reader, etc. Alternatively, the user may be asked to enter an identification number on the numeric keypad rather than using an electronic identification device. The ID device 242 as shown has a button-shaped RFID interface 272 and defines an aperture 274 in the body sized to fit on a key ring.

The VAP 230 has a display 246 that may be an alphanumeric and/or graphics display panel of LCD or other technology. The display may be color or monochrome and could include a touch screen interface. The VAP 230 also provides a keypad 248, in this case a typical 10-key numeric entry pad is shown, although expanded alphanumeric versions are possible. The keypad 248 may be used to enter a unique identification code, e.g., the numeric equivalent to a barcode and PIN numbers for access and authorization purposes.

In addition to the standard keypad, several special purpose keys or buttons may be provided. A first button is labeled as a “Return Vehicle” button 260. One feature of the disclosed technology is the ability to return the vehicle from rental status without having to dock the vehicle at a docking station. Automated bicycle rental systems such as the Vélib system in Paris, France have been known to frustrate users when they attempt to return a rented vehicle to a docking kiosk where there are no available docking stations. In contrast, the technology disclosed herein may a utilize wireless communication configuration and allow the user to employ the “self-lock” feature described herein to secure the vehicle to a local pole, tree, or other appropriate point near the return station and then press the “Return Vehicle” button 260.

At that point the user's rental will be terminated, the status of the vehicle will be assessed, and a “Ready to Rent” message or indicator may be displayed so that the vehicle may be rented by another user. This feature allows vehicles to be rented and returned at virtually any location within wireless communication range without relying upon an available open docking station. Note that the wireless communication range can be global in scope if satellite communications are utilized or the wireless network is connected to a global network such as the Internet. In such cases, PEV return and rental may be implemented on each individual vehicle virtually anywhere, with or without docking stations. In local systems where docking stations are the preferred return location, users may be incentivized to rent vehicles that are not attached to a docking station through monetary advantage (e.g., a reduced rate or free rental period), plus helping balance the overall shared vehicle system by moving excess vehicles to other locations where docking stations are available.

A second feature is provided under the “hold vehicle” button 258. Another feature disclosed herein is the ability to place a vehicle on “hold.” Using this feature, the vehicle may be placed in a docking station or self-locked at a convenient location but held for the current user so that the vehicle may not be taken by a new user. In one embodiment of this feature, after placing the vehicle at a docking station or self locking the vehicle and pressing the “Hold Vehicle” button 258 the VAP display will prompt the user to enter a number of minutes. For the period of time entered, the vehicle will be held for the current user and if not taken by the current user by the end of the time period, may automatically display a “Ready to Rent” message or similar indicator making the vehicle available for any new user. The “Ready to Rent” display may also indicate the number of miles of range expected from the current state of charge for a PEV. The “Hold Vehicle” feature may also be initiated remotely. For example, a shared vehicle system subscriber might access the vehicle status at a current location using a wireless PDA or similar device. Once a desired vehicle is located, the subscriber may select “Hold Vehicle” so that the vehicle is waiting for a prescribed period of minutes for the subscribers arrival.

Additional buttons may perform more display specific functions. For example, a “Menu” button 262 may bring up a menu of options on the display 246 as defined by the operating software. In an electric vehicle a “Motor Off” pushbutton 256 may turn a motor assist function on or off. For example, electric bicycles commonly have the capability of being operated in a manual pedal mode. This “Motor Off” button 256 allows motor assist to be enabled or disabled at any time during the ride. Increase ↑ and decrease ↓ symbol buttons 250, 252 may be provided to increase and decrease a value as set on the display 246. For example, the Menu button 262 may allow these symbols to be assigned to control the maximum speed of a vehicle under electric power. They may also be used under Menu options to increase or decrease values for entry (e.g., number of minutes to hold the vehicle).

An “Enter” button 268 may be used to complete the entry of a sequence of numerals or other data. A “Back” button 264 may be provided to clear a previous character or go back to a previous screen as assigned by software. An “Off” button 266 may be provided to turn off the VAP 230 and disable the electric motor in the vehicle. A user generally must enter an identification device or number and PIN to regain access to the VAP 230. This “Off” function may be programmed in a variety of ways. For example, if the vehicle is not docked or self-locked when the “Off” button is activated, the display 246 may request that the user lock the vehicle in some manner before disabling the VAP 230. An “Unlock” button may be used to begin a rental sequence or take a vehicle off “Hold.” When pressed, the Unlock button may cause the display 246 to request the user to provide an identification and PIN before enabling the vehicle for use.

In addition to the buttons and features described above, a wide variety of additional enhancements may be implemented including, but not limited to, such features as GPS-enabled graphics, cell phone communications, location-based services, local and global help functions, alarms and control of vehicle-specific functions (e.g., headlights, tail lights, turn signals), and more.

In one implementation, the user may present an ID device to the ID device reader 244 on the PEV's VAP 230 to be electronically identified. The user information display 246 or bright LED prompting lights on the VAP 230 may then request the user type in a PIN using the VAP's keypad 248. The user would then respond by typing in the PIN. The embedded microprocessor could then pre-screen the user-presented data to determine if the ID device data or ID code was received within an appropriate data format and that the PIN contained the correct number of digits. If the received user input data was not in the correct format, the embedded processor may instruct the user to re-attempt the electronic identification process. If the ID device data and user's entered PIN were found to be correctly formatted, the VAP 230 may then communicate the ID device data, PIN data, and selected PEV data to the kiosk computer, through a wired or wireless communication link.

The kiosk computer may determine the status of the user's account and ensure the PEV selected by the user is appropriate for the age and skill level of the user. If the user were too young or not sufficiently skilled to rent the selected PEV, then the kiosk computer database may communicate to the VAP 230 that the PEV is not an appropriate PEV for the user and the VAP's user information display could then prompt the user to select a more appropriate PEV. Other reasons for denying a PEV rental could include an incorrect PIN, an unidentifiable ID device code, an outstanding balance due on a user's account, a prior and still current PEV rental by the user requesting to select an additional PEV, the selected PEV is not available for rental, the ID device has been deactivated because of being reported lost or stolen, or any other reason that could be useful when managing an electric vehicle fleet. All of the above reasons to deny a rental may be presented to the user via the user information display 246 or an LED display configuration.

### Integrated PEV Charging/Security Cord

There are numerous methods of routing electrical power from an electrical power receptacle at the charge port into a PEV. Typically each PEV original equipment manufacture (OEM) provides a removable power cord that plugs into the male NEMA5-15 or a male IEC type electrical receptacle in the PEV. The location of the electrical receptacle on the PEV is often not very accessible, requiring the user to locate the receptacle, orient the plug to fit into the receptacle, then insert the plug into the receptacle. Each PEV manufacturer seems to put their electrical receptacle in a different location making a standard user experience impossible when relying upon the OEM's placement of the electrical receptacle on the PEV.

To enhance the user's experience and facilitate ease of use through standardization, it may be helpful to position an electrical connection plug that the user interacts with in the same physical location, in relation to the user, on all PEVs provided through the PEV rental system, regardless of PEV make or model. Locating the electrical connection plug in a standard position may be facilitated by permanently attaching one end of an electrical charge cord to the PEV's OEM inlet power receptacle. A connection plug on the other end of the electrical charge cord would be the user-operated end and may be located on the PEV in a standard location and configured to easily plug into a receptacle on the electric PEV rental system's lock-charge port. A length of the electrical charge cord between the OEM receptacle on the PEV and the user end may be fixed to the frame or body of the PEV.

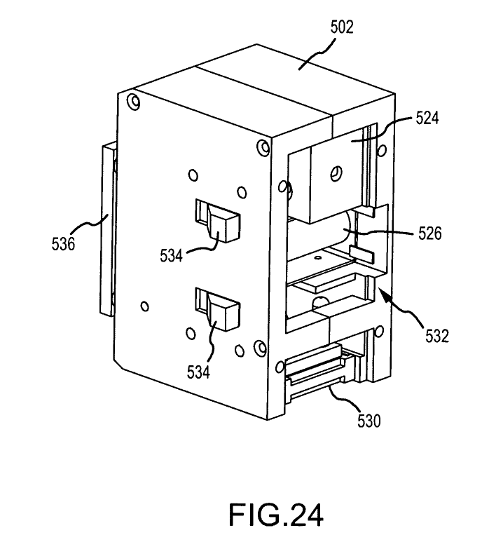

In one embodiment an electrical charge cord 204 for a PEV 202 as shown in FIG. 24 may travel wherever the user takes the PEV 202, ensuring availability of the charge cord 204 to facilitate opportunity charging. Positioning the charge plug 206 on the user-operated end of the charge cord 204 in a convenient, consistent physical location on the PEV 202 may increase the user's sense of familiarity when attempting to plug in a rented PEV 202 to a lock-charge port 208 or other power supply. The PEV charge cord 204 and connector plug 206 may also include serial data wires and an electro-magnetic shield integrated into the connector plug 206 and charge cord 204 if desirable to communicate through a wired link between the PEV 202 and the lock-charge port 208. The lock-charge port 208 is mounted on a rack 207 through which power and data wires 209 may be run to provide power and communication links to the lock charge port 208.

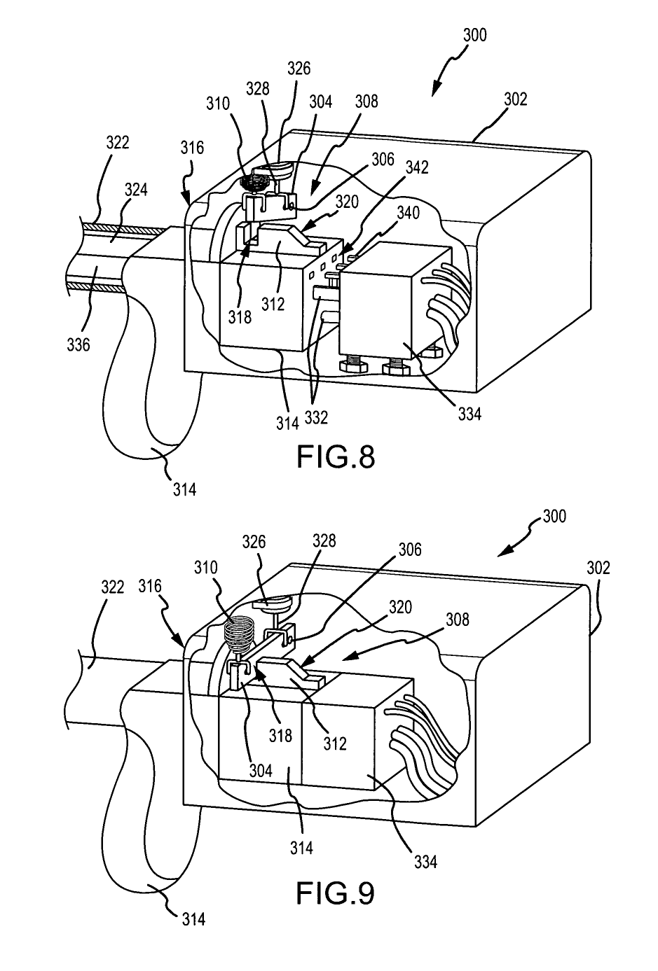

As shown in FIG. 35, the PEV charge cord 204 may also integrate a security cable 210 that may provide a reasonable level of physical security between the PEV 202 and the lock-charge port 208 when the PEV 202 is plugged into a lock-charge port 208. The security cable 210 in the charge cord 204 may be mechanically attached to the connector plug 206 in such a manner that all forces placed on the security cable 210 are transferred into the connector plug 206. The connector plug 206 may be configured to act as a latch to interface with a locking mechanism residing in the lock-charge port 208 such that when the latch is locked within the locking mechanism all mechanical forces experienced by the security cable 210 in the charge cord 204 may be mechanically transferred from the security cable 210 to the latch structure of the connector plug 206. The latch structure of the connection plug 206 may then transfer the encountered forces to the locking mechanism in the charge port 208 without interrupting the power or data passing between the lock-charge port 208 and the PEV 202. See FIGS. 8-16 and the related description for a detailed discussion of locking structures and mechanisms.

The other end of the security cable 210 may be permanently attached to a frame member 214 of the PEV 202 with a mechanical anchor 212 in a location near the power receptacle. Alternatively, the security cable 210 may be permanently attached to a frame member 214 the PEV 202 with a mechanical at a location on the PEV 202 where the forces exerted by a malicious user intending to overpower the security cable 210 would have the least mechanical advantage. The anchoring location and orientation of the mechanically strong security cable 210 may direct all forces experienced by the security cable 210 into the mechanical anchor 212 permanently attached to the frame member 214 with little or none of the forces experienced by the security cable 210 being transferred to the electrical wires 216 used to transmit power or data wires 218 to or from the PEV 202. The permanent security cable 210 connection to the PEV 202 may be difficult if not impossible for a user to remove or brake ensuring the charge cord 202 remains with the PEV 202 during the PEV rental.

Various mechanical anchors 222 may be implemented to permanently attach the security cable 210 to the PEV frame member 214 including, for example, a sturdy plate 220 wrapped around the end of the security cable 210. During manufacture of the security cable 210 the sturdy plate 220 may be mechanically strained around the end of the security cable 210 in such a manner to become permanently attached to the security cable 210. The sturdy plate 220 may define one or more holes sized and positioned to accept respective fasteners 222. The fasteners 222 may be inserted into the holes in the sturdy plate 222 to attach the sturdy plate 220 to the PEV 202. One method for attaching the plate 220 to the PEV may involve using specialty hardware not commonly found such as Spanner-headed bolts or tamperproof hardware. Alternatively, a permanent attachment point to the PEV 202 may be implemented by mechanically deforming the fastener, for example, by rolling the end of a fastener, like a rivet, and thus making it mechanically difficult to remove without cutting the mechanical anchor 212. To further secure a rivet-like fastener, the rivet may be positioned within a recess in the sturdy plate 220 making it impossible for a mechanical saw to cut the head of the rivet off to release the sturdy plate 220 from the PEV 202.

The charge cord 2 204 may integrate with the security cable 210 in a single protective sheath or embedded within a solid molded protective encapsulant. The security cable 210 and the electrical wires 216 and data cable 218 of the charge cord 204 may separate near the location where the security cable 210 is attached to the frame member 214. The electrical wires 216 may be contained in a single electrical cord 224 and the data wires may be contained in a single data cord 226. The electrical cord 224 may form a loop or sag before similarly bring attachments to the frame members 214 of the PEV to provide strain relief and mechanical separation between the security cable 210 and the electrical wires 216 and data cable 218. The electrical cord 224 may then be routed to service the electrical needs of the PEV 202 either directly to the PEV's electrical receptacle or to the VAP 230. Alternately, the electrical cord 224 may split to be routed to both the VAP 230 and the PEV electrical receptacle. In another embodiment, the electrical cord 224 may first travel to the VAP 230 and then return to the PEV receptacle as indicated in FIG. 35.

The charge cord 204 between the PEV and lock-charge port 208 may also include serial data wires 218 and an electro-magnetic shield to be integrated into the charge cord 204 if it is desirable to communicate through a wired link between the PEV and the lock-charge port 208. The serial data wires 208 may be contained in a single data cord 226 upon splitting from the charge cord 204. The data cord 226 may be configured to have a loop or sag in adjacent to where the security cable 210 attaches to the PEV to provide stain relief. The serial data 226 may be routed to either the VAP or to the PEV's electrical receptacle, or both as needed to provide a serial link between the PEV and the lock-charge port 208.

By providing a secure mechanical cable connection between the PEV charging cord 204 and the PEV frame member 214, it may be possible to rely upon the mechanical security cable 210 to secure the PEV to the lock-charge port 208. When charge cord 204 incorporating the security cable 210 is locked into the lock-charge port, there is little chance of an accidental unplugging of the PEV 202 from the lock-charge port 208, reducing the number of false alarms associated with PEVs 202 being accidentally or maliciously unplugged. This security features increases the significance of an “unplugged” PEV 202 being interpreted by the PEV rental system as a cut security cable or overpowered security cable lock. The security cable may prohibit mischievous youth from unplugging PEVs 202 as a prank and aid to ensure the PEVs 202 are not swapped or relocated within the PEV rental system without authorization.

Since the PEV rental system is intended to be an automated PEV dispensing system, little or no supervision will be provided. Without some form of security cable 210 preventing the swapping of PEVs 202 in lock-charge ports 208 it could be possible for youth not yet old enough to ride an electrically motorized scooter to swap an eBike with a scooter and possibly trick the system into believing the youth is renting an eBike when in fact the PEV swap could allow the youth to rent the scooter, endangering his own safety and the safety of others. By preventing a PEV 202 from being unplugged from their lock-charge ports until the PEV 202 is actually rented, the PEV rental system is less likely to be fooled by users with ill intent towards the system.

In an alternative embodiment, the security cable may be physically separate from the electrical cord with the physically separate electrical cord and security cable both be attached to the user-operated plug that is inserted into the lock-charge port. Additionally if serial data lines were included in the interface between the PEV and lock-charge port, the serial data cords may be physically separate from the electrical cord and the security cable if desired. It is not necessary to integrate the security cable, electrical cord, and/or serial data lines. The intent of such integration is to reduce the likelihood of individual wires getting tangled or caught up in the user's activities. The integration of the security cable, electrical cord, and serial data lines into the single charge cord 204, if utilized, enables the user with the single action of plugging the plug connector 206 into the lock-charge port 208 to establish a secure physical connection, an efficient power connection, and, if utilized, an effective wired communication connection between the lock-charge port 208 and the PEV 202. By enabling the user to perform all these tasks in a single action the rental system will be favorably received by the user while meeting the numerous unique needs for autonomous operation of a PEV rental system.

### Consistent Charge Plug Location on the Rental Vehicle

A process for enabling a user to become accustomed to a safe, intuitive, and simple process for connecting and disconnecting the PEV 202 from a lock-charge port 208 and conveniently storing the charging cord 204 in a familiar location on all PEV's in a fleet may help to remove one of the barriers associated with a user renting an unfamiliar PEV 202. If the specific storage location of the charge cord 204 on the PEV 202 and the user's movements required to plug or unplug a PEV 202 are uniform for all PEVs within the fleet, then a familiar user interface is created for all rental PEVs in the fleet. By locating an on-vehicle-storage-location of the charge cord 204 in front of the user near the handlebars 228 of all PEVs 202 in the fleet, a familiar interface may be created that is not in the user's way during PEV operation but is readily available during PEV rental and return.

In one implementation, the electrical prongs of the charge plug 206 may be inserted into a receiving area of the VAP 230, enabling the charge plug 206 to be securely inserted into its storage location during PEV use. The receiving area could hold the charge plug 206 in place by applying a slight pressure to the charge plug's electrical prongs using a mechanical U-shaped clasp during PEV operation. The U-shaped clasp may allow an upward and rearward motion to be initiated by the user to remove the charge plug 206 from its storage location in order to attach the PEV to the lock-charge port 208. Similarly, when the charge plug 206 is being placed into the receiving area, the U-shaped clasp could easily allow a downward and forward motion of the charge plug 206 to enable the user to secure the charge plug 206 in its on-vehicle-storage-location intuitively. Other methods of securing the charge plug 206 may include clasping the plug body itself to the PEV frame, the VAP 230 or other PEV structure.

After the user has been granted access to the PEV 202 by successfully renting a PEV 202, the display on the VAP may instruct the user to unplug the PEV's user-operated charge plug 206 from the lock-charge port 208. The orientation of the user's hand when grasping the charge plug 206 to remove it from the charge port 208 may be such that the user may not have to change the grip on the charge plug 206 to stow the charge plug 206 in receiving area. The VAP 230 may be programmed to start the PEV 202 only when the charge plug 206 has been properly inserted into its storage location on the PEV 202. After the PEV 202 has been successfully rented and the charge plug 206 has been inserted into its storage location, the VAP 230 may be programmed to require that the charge plug 206 remain in its on-vehicle-storage-location to enable the PEV 202 to move under its own power. This may prevent the user from performing undesirable and possibly dangerous activities with the charge cord 204 and charge plug 206 while the PEV 202 is in motion. It may also ensure that the wheel of the PEV 202 could not roll over the charge plug 206 under power of the PEV 202, preventing the PEV 202 from stressing the charge plug 206 and charge cord 204 under its own power and reducing the possibility of intentional and accidental damage to the charge plug 206, charge cord 204, VAP 230 and PEV 202. If the PEV 202 is deactivated due to the removal of charge plug 206 from the on-vehicle-storage-location, the VAP 230 may alert the user of the reason for inactivation of the PEV 202 enabling quick feedback as to why the PEV is no longer operating as expected.

Plenty of finger room may be made available around the charge plug 206 in the on-vehicle-storage-location to facilitate easy access to the user. The shape of the VAP 230 and surrounding PEV surfaces may be such that water from rain or condensation would be channeled away from and around the storage location of the charge plug 206. A hood or cover over the body of the charge plug 206 could also protect the charge plug body from rain and condensation during the rental period. This hood could be made out of a flexible transparent plastic that would retain its shape, such as clear, firm silicone, enabling the user to see the charge plug 206 within its storage location on the PEV 202. The flexibility of the transparent hood may allow the user to grab the charge plug 206 and remove it from the storage location with out worry of interference between the hood and the charge plug 206. The hood may be shaped to reduce the likelihood that it would interfere with the charge plug 206 when inserted into the PEV storage location.

The orientation of the charge plug 206 in its on-vehicle-storage-location may allow the user to grab the charge plug 206 in such a manner to enable the user to plug the charge plug 206 into the lock-charge port 208 without having to change the grip on the charge plug 206. This one step motion would further simplify the user's motions when returning a rented PEV 202 making the action of attaching the charge plug 206 to the lock-charge port 208 more intuitive and innate while at the same time terminating the user's PEV rental period and, if implemented, establishing a wired communication link between the PEV rental system and the newly returned PEV 202.

### Charge Cord Storage

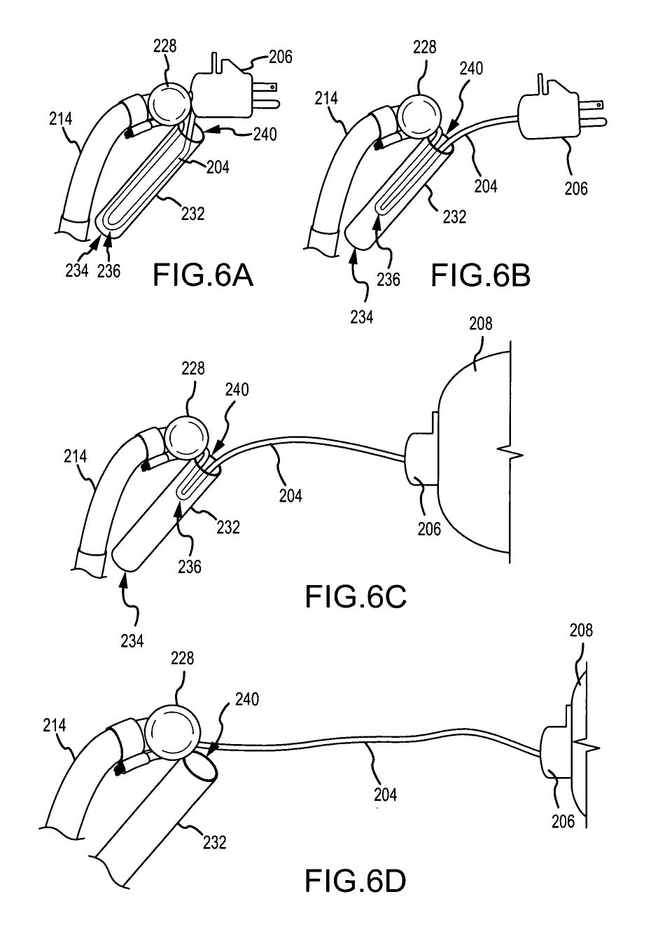

Care should be taken to keep the charge cord 204 from becoming tangled or from dropping onto wet ground when operated by the user. The PEV-mounted charge cord 204 may be stored in a convenient storage sheath 232 as depicted in FIGS. 6A-6D when the user is operating the PEV 202. Besides keeping the charge cord 204 from becoming accidentally entangled on a stationary object during PEV operation, the storage sheath 232 may also protect the charge plug 206 from getting dirty or wet during PEV operation. The position of the sheath 232 may be in the same location in relation to the user regardless of the make or model of the PEV 202, thereby enhancing the user's experience by providing a consistent interface and operation between the different types of PEVs offered for rent. Once installed into the sheath 232, the charge plug 206 may be protected from incoming rain, fog, and dew by being positioned under a slight overhang in the front of the sheath 232. Two access notches in the sheath 232 on either side of the charge plug 206 may allow the user to grip the charge plug 206 while it is in its protective enclosure. A hole in the bottom of the sheath could provide drainage of any water that was collected by the sheath during exposure to weather.

When the user removes the charge plug 206 from the storage location the charge cord 204 may be configured to easily deploy out of the charge cord storage sheath 232 on the PEV 202 and drape over the backside of the PEV's handlebars 228 enabling the user to ignore the location and orientation of the handlebars 228 during the act of plugging the PEV 202 into the lock-charge port 208, simplifying the action of plugging in the PEV 202. Alternatively the charge plug's storage location could be positioned in front of and slightly above the handlebars 228 making it possible to route the charge cord 204 in front of the handlebars 228. By having the charge cord 204 pass in front of the handlebars 228 there may be less likelihood than the charge cord 204 will become entangled with the VAP 230.

The sheath 232 may contain a self-retracting mechanism that may gently pull the cord and plug into the sheath 232 with little or no assistance by the user. The self-retracting mechanism may be implemented by means of a spring extended by the user when removing the charge cord 204 from the sheath 232 at the time of plugging the PEV 202 into the lock-charge port 208. Upon unplugging the PEV 202 from the lock-charge port 208, the spring could gently retract the charge cord 204 and charge plug 206 into the sheath 232. When the charge cord 204 is plugged into the lock-charge port 208, the spring used to retract the charge cord 204 integrated with the electrical cord 224 would need to be long enough to allow the security cable 210 to fully extend and become taught between the lock-charge port 208 and the PEV 202 enabling any abusive forces experienced by the security cable 210 to be transferred to the security cable's secure mechanical attachments on the PEV 202 and lock-charge port 208. The retraction spring may be positioned to experience very little or none of the forces experienced by the security cable 210 during general or abusive handling of the PEV 202 and/or the security cable 210 when attached to the lock-charge port 208.

### Self-Folding Charge Cord

When the PEV 202 has been successfully rented and the user has unplugged the charge plug 206 from the lock-charge port 208 the charge cord 204 may be sufficiently rigid to enable the user to easily direct the charge cord 204 into the storage sheath 232. The charge cord 204 may also be flexible enough to allow the charge cord 204 to bend 180 degrees while recoiling into the storage sheath 232. The user may easily perform the recoil of the charge cord 204 into the sheath 232 with one hand by relying upon the relative stiffness of the charge cord 204 in the direction parallel to the axis of the charge cord 204. The axial stiffness of the charge cord 204 may be balanced with the ability of the charge cord 204 to bend 180 degrees along any part of the security cable 210 when an appropriate force is applied to the charge plug end of the charge cord 204. This allows the charge cord 204 to fit within the sheath 232 by doubling over inside the sheath 232, thus reducing the physical length of the sheath 232 for a given length charge cord 204. FIGS. 46A-6D show one possible embodiment of a self-folding charge 204 cord each with a different amount of the charge cord 204 extending from the storage sheath 232. For example, a 36 inch long charge cord 204 could be stored inside an 18 inch long sheath 232.

The balance between the axial stiffness of the charge cord 204 and its ability to easily bend 180 degrees may be facilitated in a number of ways. In one embodiment a long piece of narrow, curved, thin metal, similar to the metal tape found inside a common self-re-coiling tape-measuring device, may be utilized within the charge cord 204 as a self-folding tape. In these tape-measuring devices a slight semi-circular curvature transverses to the length is formed into the metal tape upon manufacture. This slight semi-circular curvature allows the metal tape to be fairly rigid when extended out of its case. When the metal tape is retracted into its case, the slight semi-circular curvature easily flattens out to facilitate compact storage. If one unwinds a section of metal tape out of a common tape-measure device and attempts to bend the longitudinal ends of the metal tape together, the tape will bend up to, and past, 180 degrees quite easily. If one end of the metal tape is held stationary, the 180 degree bend in the tape can be easily moved anywhere along the length of the tape by moving the other end of the tape up and down, parallel to the stationary end of the tape.

The physical behavior of the metal tape-measure tape described above may be applied to the charge cord 204 to facilitate a self-folding charge cord 204 on the PEV 202. The self-folding tape may be integrated into the charge cord 204. The end of the charge cord 204 affixed to the PEV 202 corresponds to the stationary end of the above-described self-recoiling tape measure. The 180 degree bend in the self folding tape may be located inside the sheath 232 and the movable end of the self-folding tape may be attached to the charge plug 206. As before, the electrical wires 216, data wires 218, and the security cable 210 may be attached to the self folding tape and integrated together as the charge cord 204. Alternatively, each of these components could be separate and merely attached to the self-folding tape. When the user unplugs the PEV 202 from the lock-charge port 208 the user may simply feed the charge cord 204 into the sheath 202 and the 180 degree bend in the self-folding tape would travel down towards the bottom of the sheath 232. The sheath 232 may be of sufficient length to enable the user to position the charge plug 206 in its storage location. For example, a 36″ long charge cord 204 could be easily contained in an 18″ long storage sheath 232. The sheath 232 could be tube resembling the typical mechanical structural elements found on most PEVs.

An alternative embodiment of the self-folding charge cord 204 could use steel wire braid or spring steel wire braid or high carbon steel wire braid, all capable of retaining a pre-formed shape, that could be braided and formed in such a manner as to function similarly to the self folding tape described above. The braided wire could also serve as the security cable 210 providing a sufficient deterrent to ensure that the PEV 202 would not be easily removed from the lock-charge port 208 under moderate forces. The steel wires could be braided into a long, flat, narrow braid similar in shape to the tape found in common self-recoil tape-measuring devices. The steel wire braid may be formed using a simple wheeled mechanical former that bends the individual wires within the braid into a semi-circular cross sectional shape to facilitate the axial stiffness desired for the self-folding charge cord 204. The pre-formed, braided steel wire may also be embedded in a flexible plastic material by means of co-molding or injection molding to preserve the semi-circular, curved cross-sectional shape of the braided wires to provide the desired axial stiffness. The pre-forming of the steel wire braid could be performed either before or after the braid is encased in the flexible plastic material depending upon the ability of the plastic to endure the forming process and the ability of the braided steel wire to preserve its formed shape after being embedded in plastic. Additionally, the curvature of the steel wire braid could be formed in the injection mold when the steel wire braid is being encased in the plastic.

The electrical wires 216 used to supply battery charging power to the PEV 202 may also be co-molded with the braided steel wire to form an integrated charge cord 204. These electrical wires 216 may be electrically insulated from the braided wire using a flexible wire insulation to allow the charge cord 204 to bend 180 degrees. The weave of the braided wire may be such that the individual steel wire strands traverse from one side of the braid to the other side of the braid at an angle between 20 and 70 degrees with respect to the length of the braid to provide stiffening of the charge cable 204. The more perpendicular the steel wires are braided in relation to the overall length of the charge cord 204, the more flexible the charge cord 204 will be to bend 180 degrees and the more rigid the charge cord 204 will be when an axial force is asserted onto the charge cord 204. The less perpendicular the steel wires are braided in relation to the overall length of the charge cord 204, the less flexible the charge cord 204 will be to bend 180 degrees and the less rigid the charge cord will be when an axial force is asserted onto the charge cord 204.

Finding the right balance for the intended application requires a balance between the desired axial rigidity and the effort required to bend the cord 180 degrees. The thickness of the wires used in the braid and the density of the braid may also be varied to provide the correct rigidity and bend-ability of the self-folding charge cord 204. The thickness of the steel wires in the braid may be sized appropriately for adequate strength to endure the forces expected in public rental environments. The braided nature of the steel wire may make it more difficult to cut by a thief or vandal. Threads of carbon fiber or Kevlar may be included in the braid or added during the plastic encasement process to add additional strength to the braid making it more difficult to cut or break.

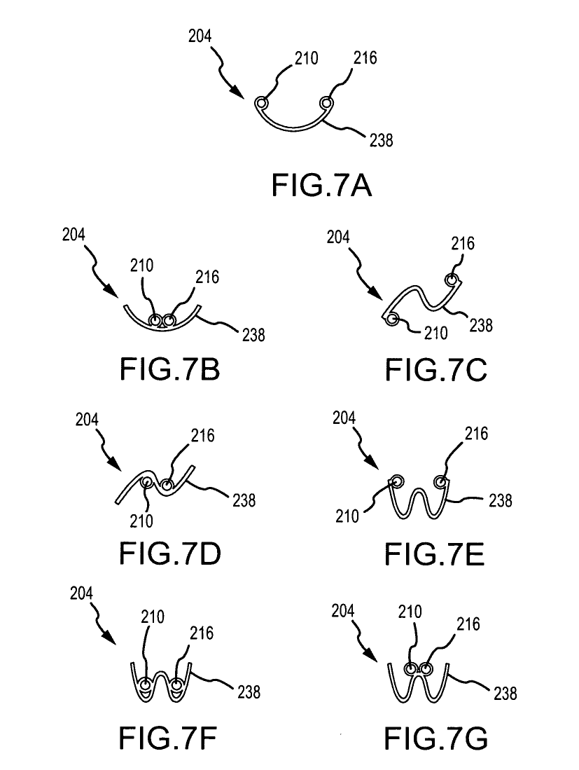

Alternatively a security cable 210 with a circular cross section could be co-molded along with the electric wires 216 and data wires 218 to encapsulate the security cable 210 and wires into a plastic body configured into a long, flat, narrow tape-like shape with a semicircular cross section as depicted in FIGS. 7A-7G. The security cable 210 and insulated electrical wires 216 and data wires 218 may be routed in parallel with the long dimension of the plastic body. The shape and durometer of the plastic body may thus provide the appropriate flexibility and rigidity to provide the self-folding feature of the PEV's charge cord 204. The security cable 210 electrical wires 216 data wires 218 may alternatively be co-molded along the edges of the plastic body or they may be molded to run along the center of the plastic body. The composition of the plastic body material providing the flexible yet rigid feature of the charge cord 204 needs to be able to remember its formed shape after being manipulated. Ultra-violet-stabilized, high-density polyethylene or polyethylene terephthalate are potentially suitable plastics to form the plastic body. These plastics provide a physical memory of their molded shape while providing enough flexibility to allow the material to bend 180 degrees. Alternative plastic compositions may prove to be more suitable to implement the self-folding charge cord. Care should be taken to ensure the embedded security cable 210, electrical wires 216, data wires 218 are suitably bonded to the plastic body material to ensure the self-folding charge cord 204 is long-lived and robust enough to endure the stresses and strains of an unattended PEV rental system.

The width and shape of the semi-circular cross section of the self-folding charge cord 204 has a significant impact on the behavior of the self-folding charge cord 204. By having a semi-circular cross section, as shown in FIGS. 7A and 7B, the charge cord 204 functions quite effectively to keep the folded within the storage sheath 232 as long as the charge cord 204 remains untwisted. FIG. 7A depicts a semi-circular “U”-shaped cross section of a self folding charge cord 204 with the security cable 210 position on one side of the plastic body 238 formed as the “U” and the electrical wire 216 positioned on the other side of the “U.” FIG. 7B depicts a semi-circular “U”-shaped cross section of a self folding charge cord 204 with the security cable 210 and the electrical wires 216 both positioned within the center of the plastic body 238 formed as the “U.” If the cord becomes twisted, the semi-circular cross section of the self-folding charge cord 204 may become inflexible to certain types of movements that could be encountered when the user attempts to use the charge cord 204 to wrap around a stationary object. When attempting to wrap the charge cord 204 around a stationary object the self-folding charge cord may bind or kink making its behavior unpleasant to experience.

Other cross-sectional shapes besides a semi-circular shape may be more suitable to allow the self-folding charge cord 204 the ability to bend and conform to the user's needs when attempting to wrap the charge cord around a stationary object.

A curved “N” cross-section shape as shown in FIGS. 7C and 7D may be used as an alternative to the semi-circular “U” cross-sectional shape and would still facilitate a rigid charge cord 204. The curved “N” shape has two ridges compared to the single ridge of the semi-circular “U” cross section shape providing more axial rigidity from the increased number of ridges that run down the length of the self-folding charge cord 204. This implementation may enable a less stiff material to be used as the plastic body 238 with the additional ridges providing the rigidity needed for the self-folding charge cord 204. Since a less stiff plastic material can be used to make the plastic body 238, there would be less resistance to bending the charge cord 204 in all directions. Additionally, the cross-sectional area may be smaller in overall size as the two ridges may be positioned closer together than when relying upon the large single ridge of the semi-circular cross section.

The curved “N” cross-section shape is also more balanced in its response to outside forces as it is effectively a combination of two semi-circular cross sections with the added feature that the two semi-circles are pointing away from one another. By having the semi-circles face in two different directions the self-folding charge cord 204 will bend 180 degrees in either direction with equal ease which could be a benefit when trying to manipulate the self-folding charge cord 204 by bending it in all directions. The curved “N” cross-section shape also has the ability to collapse onto itself in a more controlled manner when compared to the single “U” semi-circular cross section shape. This ability to collapse upon itself could allow the “N” cross-section shape to be more manageable and predictable in behavior making it simpler to interact with when bending the self-folding charge cord in all directions.

FIG. 7C depicts an “N”-shaped cross section embodiment of the self-folding charge cord 204 with security cable 210 position on one edge of the plastic body 238 formed as the “N” and with the electrical wires 216 positioned on an opposite edge of the “N.” FIG. 7D depicts another embodiment of an “N”-shaped cross section to the self-folding charge cord 204 with the security cable 210 and the electrical wires 216 positioned on opposite sides of the plastic body 238 formed as the “N,” but adjacent each other within the middle of the “N.”

A curved “W” cross section shape as shown in FIGS. 7E-7G may also be used as an alternative to the semi-circular “U” cross-sectional shape and would still facilitate a rigid charge cord 204. Similar in benefits to the curved “N” cross-section shape, the curved “W” has three ridges running down the length of the self-folding charge cord 204. With more ridges along the charge cord 204 an even less rigid plastic material could be used to comprise the plastic body 238 of the self-folding charge cord 204 when compared to either the single semi-circular cross-section shape or the “N” cross-section shape. This enables ease of bending in all directions while providing the axial rigidity needed to direct the charge cord 204 into the storage sheath 232. The performance of the curved “W” cross-section shape is similar to the single “U” semi-circular shape because o the odd number of ridges with the two outer ridges pointing in one direction and the center ridge pointing in a direction 180 degrees from the other two ridges. Since there is an odd number of ridges, the curved “W” cross-section shape will bend 180 degrees more easily when opening the two outer semi-circles flat and compressing the center ridge flat than when bending the “W” cross section shape in the other direction where the two outer semi-circles are compressed flat and the center ridge is opened flat. This asymmetrical behavior associated with forces required to manipulate the charge cord 204 in a particular direction may have advantages associated with how behavior of the cord is experienced by the user.

FIG. 7E depicts a first embodiment of a “W”-shaped cross-section of the self-folding charge cord 204 with the security cable 210 positioned on one interior edge of the plastic body 238 formed as the “W” and with the electrical wires 216 positioned on an opposite interior edge of the “W.” FIG. 7F depicts a second embodiment of a “W”-shaped cross section of the self-folding chard cord 204 with the security cable in one of the concave wells of the plastic body 238 forming the “W” and with the electrical wires 216 in the other concave well forming the “W.” FIG. 7G depicts a third embodiment of a “W”-shaped cross section of the self-folding charge cord 204 with both the security cable 210 and the electrical wires 216 positioned on the corner hump of the plastic body 238 formed as the “W.”

There may be times when the user removes the entire charge cord 204 from the sheath 232 such as when the self-lock feature is employed (as described further herein) or after someone has tried to overpower the cable/lock mechanism. Under these circumstances it may be necessary for the user to position the 180 degree bend 236 in the self-folding charge cord 204 back into the storage sheath 232. To facilitate ease of placing the 180 degree bend 236 in the self-folding charge cord 204 back into the sheath 232 it may be possible fabricate the self-folding charge cord 204 with a relaxed portion of the axially rigid, metal tape, self braid, or plastic body 238 at a location near the opening of the charge cord sheath. The relaxed portion of the axially rigid cord would be the first location where the charge cord 204 would bend 180 degrees when force was placed axially on the charge cord 204 by the user. The user could then start the 180 degree bend 236 of the charge cord 204 just above the opening 240 of the storage sheath 232 and then direct the 180 degree bend 236 into the sheath 232. Since the charge cord 204 will be somewhat flexible, it will be possible for the user to insert the self-folding charge cord 204 into the storage sheath 232 using two hands and some additional effort if the user was unaware of the charge cord design's one-handed ease of use features. Under typical usage the 180 degree bend 236 in the charge cord 204 would reside within the storage sheath 232 and would not regularly need to be replaced within the storage sheath 232.

The insulated electrical wires 216 may be co-molded to the edges of the charge cord 204 making the edges of the charge cord 204 thicker and easier to handle. Insulated data wires 218 and an insulated electrical ground wire could also be co-molded along the edges of the charge cord 204. Alternatively, the electrical wires 216 could be co-molded along the center of the self-folding charge cord 204 making it easier to electrically connect the electrical wires 216 at either end of the self-folding charge cord 204. The data wires 218 and the electrical grounding wire could also be co-molded along the center of the charge cord 204. There are numerous possibilities regarding where the insulated electrical wires 216, data wires 218 and ground wires could be located on the self-folding charge cord 204.

The presence of the electric wires 216 integrated into the self-folding charge cord 204 could stop a would-be thief or vandal due to their general caution regarding electricity. The relatively wide profile of the self-folding charge cord 204 may provide a surface area where a warning could be printed regarding the dangers of severing the charge cord 204 further discouraging potential malicious attacks on the charge cord 204 and providing a general safety warning regarding the possibility of electrical shock.

The sheath 232 may be made out of rigid material or flexible textile-like material with a smooth yet durable inner surface that would endure the wear associated with the self-folding charge cord 204 rubbing against the inside surface of the sheath 232. The bottom 234 of the sheath 232 may have some structure for attachment to the frame 214 of the PEV 202 to keep the sheath 232 from moving during PEV operation. The bottom 234 of the sheath 232 may be open to provide moisture drainage and to prevent trash and leaves from building up inside. Alternatively, the sheath 232 may have a mesh bottom to keep dirt and moisture from building up inside the sheath 232. It may prove advantageous in some operational environments to have a sheath 232 with a solid bottom 234 defining with a small hole to allow water to drain out of the bottom 234.

Alternative methods of retracting the charge cord 204 may require some mechanical retracting mechanism. Alternative retracting mechanisms are fragile, costly, bulky, and require some method of diverting excessive stress placed on the charge cord by abusive individuals. On small PEVs 202 there is little room for a bulky charge cord retractor. Since the retracting mechanism resides within the self-folding charge cord 204 in the embodiments described above there is no need to divert abusive forces away from the retracting mechanism of the self-folding charge cord 204 as the forces exerted by an abusive individual will be transferred from the PEV 202 into a mechanical fastener and then transferred directly into the security cable 210 or braided mesh within the self-folding charge cord 204. The relatively simple mechanics behind the self-folding charge cord 204 would ensure that the charge cord 204 could endure most attempts to manually extract a PEV 202 from its lock-charge port 208.

The motion required to fold up the self-folding charge cord 204 under typical operation would be the shortest path between the lock-charge port 208 and the storage location of the charge plug 206 on the PEV 202 making it intuitively obvious how the user should retract the charge cord 204 into the storage sheath 232. If implemented appropriately it would be likely that the user would have no idea how the charge cord 204 and charge plug 206 “just knew where to go” upon removing the charge plug 206 from the lock-charge port 208. Similarly, the charge cord 204 may be extended from the sheath with very little effort by the user giving the user the experience that the “cord just did what I wanted it to do” when attempting to plug the PEV 202 into the lock-charge port 208.

### Port-Lock Feature

A “Port-Lock” system as used herein refers to a combination lock-charge port 302 that is associated with a PEV rental or check-out location as further described with respect to FIGS. 8 and 9. A locking mechanism 308 capable of enduring mechanical stresses comparable to what is experienced by heavy duty bicycle locks or motorcycle locks is mechanically anchored within each lock-charge port 302 3. In one possible embodiment as a Port-Lock, under the charge port cover 302 a spring-loaded bar 304, hinged 306 on one side, may serve as the primary component of the locking mechanism 308 where a spring 310 would be stiff enough to hold the unhinged side of the locking bar 304 in the locked position. A ramped latch 312 formed on the charge plug 314 entering into a lock charge opening 316 in the charge port cover 302 under the locking bar 304 at an orthogonal angle may easily raise the locking bar 304 when the latch 312 is inserted into the lock charge opening 316. Once the latch 312 is completely inserted into the lock charge opening 316, the spring holding 310 the locking bar 304 against the latch 312 will cause the locking bar 304 to fall into a locked position behind a notch 318 formed behind the ramp 320 of the latch as shown in FIGS. 8-10. Once the locking bar 304 moves into the locked position behind the notch 318 in the latch 312, the spring 310 will not allow the locking bar 304 to rise sufficiently to enable the removal of the latch 312.

An electrically activated solenoid 326 may also be securely integrated into the locking mechanism 308 as shown in FIGS. 8 and 9. The solenoid 326 may be mounted in a fixed position with respect to the charge port cover 302 when no power is applied to the solenoid 326 no forces are generated by the solenoid 326 except for minor frictional forces associated with the solenoid plunger 328 moving within its cylinder housing 330. The solenoid 326 may be sized sufficiently large enough and positioned appropriately to be able to overpower the force created by the spring 310 enabling the solenoid 326 to raise the locking bar 304 when the solenoid 326 is electrically energized. Once free end of the locking bar 304 is raised to a raised position the charge plug 314 and latch 312 may be easily removed from the lock charge opening 316 of the plug from the lock-charge port 300.

In addition to mechanically accepting the latch 312, the lock-charge port 300 may also interfere with the male electrical prongs 332 on the charge plug 314. The lock-charge port 300 may be confirmed in such a manner that the locking mechanism 308 could only engage the notch 318 in the latch 312 on the charge plug 314 when the male prongs 332 are also properly inserted into an electrical receptacle 334. When properly inserted into the electrical receptacle 334, the male prongs 332 of the charge plug 314 may be electrically connected to the hot, neutral, and ground alternating current signals commonly found in household, commercial, and industrial electrical outlets. Electrical energy delivered from the lock-charge port 300 would pass through the charge plug 314 and reach the PEV by passing though the electrical wires 336 in the charge cord 322 to connect to the PEV's electrical power inlet receptacle.

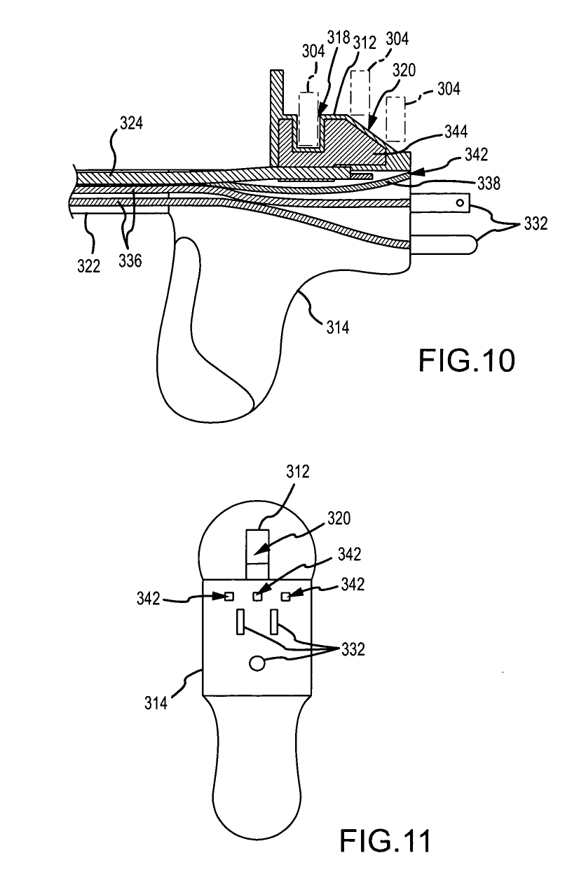

A wired data communication link 338 may also be connected between the PEV and the lock-charge port 300 when the charge plug 314 is inserted into the assembly as indicated in FIGS. 10 and 11. The data wires 338 may run through the charge cord 322 and terminate at one end at data receptacles 342 in the charge plug 314. The electrical receptacle 334 may also operate as a data receptacle and be configured with data pins 340 for engagement within the data receptacles on the charge plug 314. The charge plug 314 is mechanically locked to the locking mechanism 308 as soon as the male electrical prongs 332 are entirely received within the electrical receptacle 334 and the data pins 340 are received within the data receptacles 342 in the charge plug 314. Electricity would begin to flow from the lock-charge port into the PEV's battery charging system while the Port-Lock secured the electrical connection from being unplugged.

As previously described herein, a steel cable 324 capable of bearing the large mechanical forces encountered by cable locking systems may be contained within the PEV's charge cord 322 as shown in FIG. 10. One end of the steel cable 324 inside the charge cord 322 may be securely fastened to the ramped latch 312 on the charge plug 314, enabling any mechanical forces on the steel cable 324 to be transferred into the ramped latch 312. As shown in FIG. 10, a steel-reinforced member 344 may be encased within the charge plug 314 to provide the shape for the ramps 320 and notch 318 of the latch 312. The steel cable 324 may be crimpled or otherwise retained within a channel or hole within the steel-reinforced member 344 to physically retain the steel cable 324 within the charge plug 314. When the latch 312 is inserted into the lock-charge port 300, the mechanical forces would be transferred into the lock-charge port 300. The other end of the electrical charge cord 322 may have the steel cable 324 permanently fastened to the PEV providing a robust mechanical anchor to the PEV for the charge cord 322.

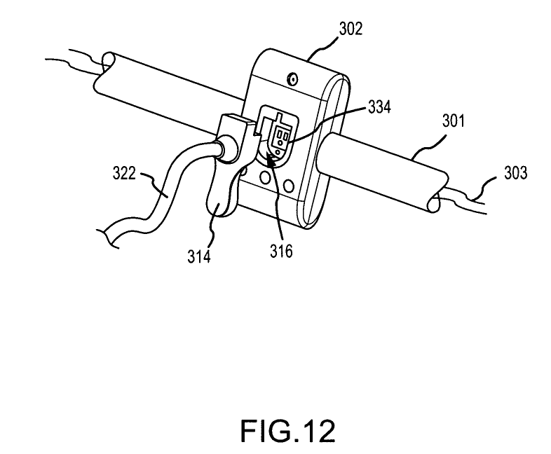

With this type of locking mechanism 308 it may be possible for a user to capture the latch 312 within the locking mechanism 308 by simply inserting the charge plug 314 into the lock charge opening 316. This type of passive locking system may be used by the lock-charge port 3 302 to accept a latch 312 that is mechanically integrated into the user operated charge plug 314 of a PEV charge cord 322 as shown in FIG. 12. All the components of the locking mechanism 308 including the locking bar 304, spring 310, latch 312, hinge 306 and chassis components may be sized sufficiently to handle the mechanical stresses that would be delivered to the latch 312 during typical attempts to overpower the locking mechanism 308.

The lock-charge port 300 may be implemented with an alternating current (AC) sensor (not shown) to enable the port to measure the magnitude of electrical power being delivered to the PEV through power cables 303 in the security rack 301. This AC sensor could be used to estimate the change in the PEV electrical battery's state of charge during charging. The AC sensor could also be used to detect when the charge plug 314 has been removed from the electrical receptacle 314. If the charge plug 314 is removed in an unauthorized manner, the lock-charge port 300 could alert its kiosk computer or a central computer server that a PEV theft may have occurred. Thus, a quick notification of the mishandling of capital equipment is provided. This could also initiate the time stamping of distributed surveillance cameras around the lock-charge port 300 and reporting of the discrepancy to security personnel of a potential PEV theft in process. Since the kiosk computer keeps track of all of the PEVs residing in its lock-charge ports 300 the kiosk computer could specify which PEV was stolen and from which port. This may enable law enforcement officers an opportunity to check for fingerprints if surveillance cameras indicated that the thief's bare hands were used to overpower the lock-charge port 300 and provide the unique PEV identification number of the PEV stolen.

After the user has successfully rents a PEV, the lock-charge port 300 corresponding to the successfully rented PEV needs to be unlocked to allow the user to unplug their PEV from its lock-charge port 300. The kiosk computer orchestrating the PEV rental procedure may issue to the corresponding lock-charge port 300 a command to energize the solenoid 326. At the same time, the PEV's VAP may be instructed by the kiosk computer to post a notification on the VAP's user interface that the PEV should now be unplugged from the lock-charge port 300. When the solenoid 326 is energized, an LED or other indicator in the lock-charge port 300 could also notify the user that the PEV should now be unplugged from the lock-charge port 300. This provides multiple locations for the user to refer regarding the next step in the rental process.

Since the lock-charge port 300 is capable of sensing the charging current passing through the lock-charge port 300 to the PEV, it is possible for the lock-charge port 300 to detect when the current is no longer flowing, indicating that the PEV has been unplugged by the user. The lock-charge port 300 could continue to energize the solenoid 326 to maintain the plunger 328 in an outthrust position for a pre-determined amount of time to insure that the user does not accidentally re-insert the charge plug 314 and inadvertently re-lock the PEV to the lock-charge port 300. The VAP could then sense the lack of grid power and, if implemented, serial data, and then prompt the user via the VAP's user interface to stow the charge cord 322 back into its protective sheath or holster. After unplugging the PEV the rental check out would be complete and the VAP could then turn the PEV on automatically as an additional convenience to the user.

### Quick-Lock Feature

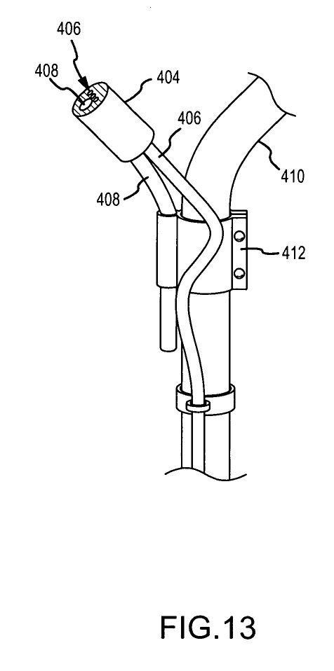

An alternative embodiment to the lock-charge port 300 feature described above may be a Quick-Lock Strip 400, as shown in FIGS. 13-15, which may be installed at a popular PEV destination away from a rental or check-out facility. The Quick-Lock strip 400 may consist of numerous Quick-Lock lock-charge ports 402 all physically connected to a security rack 401 and electrically connected via power cables 403 to the electric grid allowing numerous PEVs 422 equipped to interlock with a Quick-Lock lock-charge port 402 to be quickly locked to the Quick-Lock strip 400. While locked to the Quick-Lock strip 400, each PEV 422 may participate in free opportunity charging, providing an incentive to PEV users to frequent the establishment providing the Quick-Lock strip 400. The Quick-Lock strip does not facilitate renting or check-out of PEVs 422. By not having to connect to the PEV rental system or check-out and not needing a PEV rental system computer or an Internet connection, the Quick-Lock strip 400 could be significantly cheaper to implement when compared to a Port-Lock system connected to a central rental or check-out computer and server and for performing reservations, billing, location tracking, and the like.

The Quick-Lock charge ports 402 may each be stand-alone lock-charge ports each connected to an electrical power source (e.g., the power grid) with no communication needed between the other Quick-Lock lock-charge ports 402 in the Quick-Lock charge strip 400. The locking mechanism and electrical data receptacle of the Quick-Lock lock-charge port 402 may be the same as previously described with respect to the Port-Lock lock-charge port in FIGS. 8-12. The Quick-Locks lock-charge ports 402 could be configured to communicate to the VAP of a PEV 422 plugged into the Quick-Lock lock-charge port 402 via a wireless link or a wired link depending upon how the VAP is configured to communicate to stationary lock-charge ports. The wired data communication link would function similarly to the VAP in a Port-Lock lock-charge port, but without the lock-charge port to rental computer communication link making each VAP to Quick-Lock lock-charge port 402 a point to point communication link.

It could be possible to sell a Quick-Lock accessory pack to private owners of PEVs 422 allowing each private PEV owner the ability to utilize Quick-Lock strips 400 installed at popular PEV destinations. The Quick-Lock accessory pack could include a charge-coed 402 with an electrical cord 406 and security cable 408 that could be permanently attached to the frame 410 of the privately owned PEV 422 with a user installed mechanical anchor 412. One possible embodiment of this concept is shown in FIG. 13. The charge plug 412 at the end of the charge cord 404 of all Quick-Lock accessory packs could contain an additional tab 416 or other shape discrepancy that would make it physically impossible for the Quick-Lock charge cord 404 to be inserted into a Port-Lock rental lock-charge port 402.

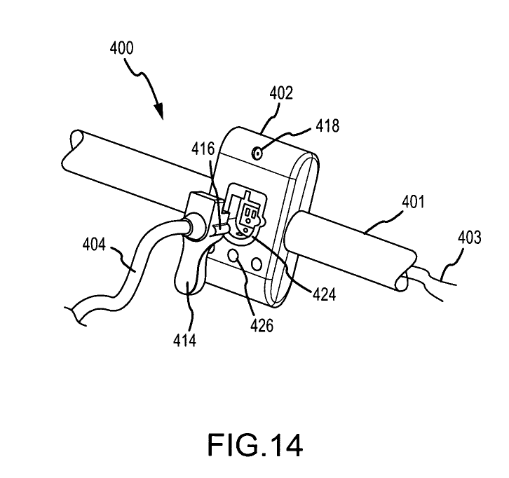

One exemplary embodiment of a charge plug shape for a Quick-Lock VAP is shown in FIG. 14. This feature of the Quick-Lock charge plug 412 included in the Quick-Lock VAP could eliminate the possibility of a privately owned PEV 422 equipped with a Quick-Lock accessory pack from being plugged into a Port-Lock rental lock-charge port. The additional tab 416 or other shape discrepancy on the Quick-Lock accessory pack charge plug 414 would not be needed on rental PEV charge plugs (e.g., as depicted previously on FIGS. 2 and 9-12), which could still be inserted into a Quick-Lock lock-charge port 402. In this manner, the Quick-Lock lock-charge port 402 may be compatible with both rental or closed campus PEVs and privately owned PEVs equipped to utilize the Quick-Lock lock-charge port 402.

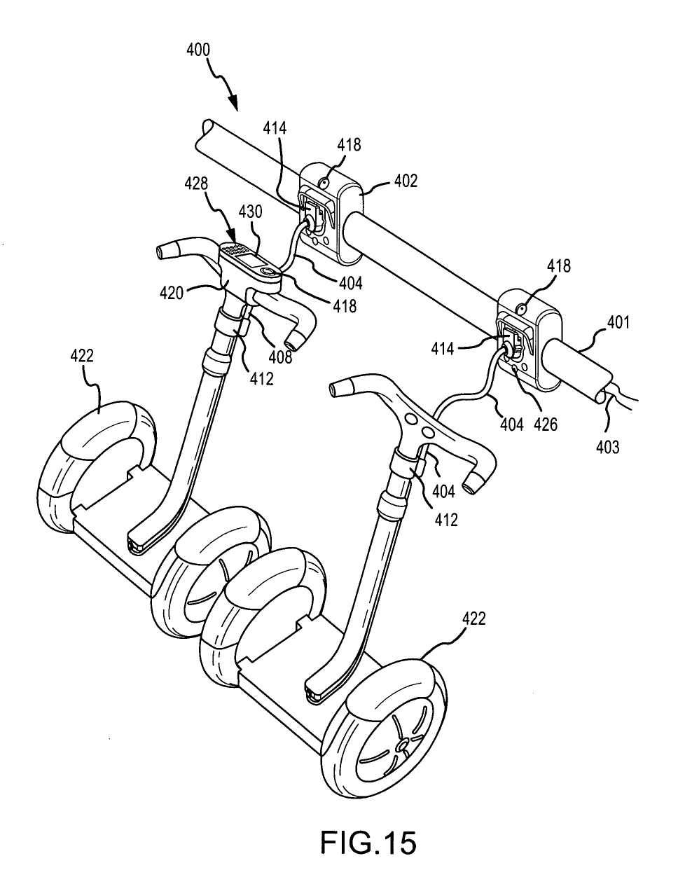

As shown in FIG. 15, the Quick-Lock accessory pack may or may not include a VAP depending upon how the Quick-Lock strip 400 is implemented. The added cost of putting an ID device reader 4 418 and/or a PIN entry keypad into each Quick-Lock lock-charge port 402 may be less of a financial disincentive than having a user install a VAP 4 420 on their private PEV 4422. If each charge port on a Quick-Lock strip contained an ID device reader 4 418 and/or a PIN entry keypad, if needed to enter a PIN to unlock a PEV from the Quick-Lock strip, then the Quick-Lock accessory pack mounted onto each OEM PEV could consist of only a charge cord 404 with one end plugged into the PEV's inlet power receptacle and the other end with a charge plug 4 414 configured for insertion into a Quick-Lock lock-charge port 402. The ramped latch (312) in the charge plug 414 would be mechanically attached to the security cable (324) within the charge cord 404 and able to transfer forces from an abusive user effectively from the security cable (314) to the Quick-Lock charge port 402. The opposite end of the charge cord 404 may be permanently attached to the PEV 422 to transfer abusive forces from users from the PEV 422 into the security cable (324). A charge cord sheath could also be included in the Quick-Lock accessory pack. However, in this manner, VAP would not need to be purchased by private owners of PEVs wanting to utilize the security and opportunity charging features of the Quick-Lock strips 400 located within their community.

The Quick-Lock accessory pack may also provide the user with an ID device, e.g., a button key as previously shown in FIG. 3 and described with respect thereto that would be readable by all Quick-Lock lock-charge ports 402 in the supported area. This ID device would be used to lock and unlock their PEV from the Quick-Lock lock-charge port 402. If the privately owned PEV 422 was activated by the same type of ID device that the Quick-Lock lock-charge port 402 was capable of reading, the private PEV owner could use their personal ID device to unlock the Quick-Lock lock-charge port 402. If the ID device used by the private PEV 422 was not readable by the Quick-Lock lock-charge port 402, then the owner of the private PEV 422 would have to use an ID device issued with the Quick-Lock accessory pack to lock and unlock their PEV 422 from the Quick-Lock lock-charge port 402 and use a separate ID device or key to start their PEV 422. A key ring loop on the ID device could be provided in the Quick-Lock accessory pack to enable the private PEV owner to attach their Quick-Lock ID device to their PEV's existing key or ID device.

For example, a private owner of an i180 Segway® could install a Quick-Lock accessory pack onto the i180 Segway®. If the Quick-Lock lock-charge ports 402 in the area use an iButton® ID device to lock and unlock the Quick-Lock lock-charge ports 402, then the i180 user could use their i180 iButton® for both activating the i180 Segway® and locking and unlocking the Quick-Lock lock-charge ports 402. As another example, if a privately owned eGo® scooter was equipped with a Quick-Lock accessory pack in an operational area where iButtons® are used to lock and unlock Quick-Lock lock-charge ports 402, the eGo® scooter owner would need to place an iButton® onto his key ring to lock and unlock his scooter from the Quick-Lock lock-charge port 402 and use the mechanical key to activate their PEV 422 once it is unlocked from the Quick-Lock lock-charge port 402.

The user of a Quick-Lock lock-charge port 402 could either be in the possession of a rented PEV 422 equipped to interface with the Quick-Lock lock-charge port 402 via the PEV's VAP 420 or the owner of a private PEV 422 could install a Quick-Lock accessory pack enabling his privately owned PEV 422 to be locked and unlocked within the Quick-Lock lock-charge port 402. Either PEV user would approach an available Quick-Lock lock-charge port 402 and park his PEV 422 in front of the Quick-Lock lock-charge port 402. The user would then insert the PEV's charge plug 414 into the Quick-Lock lock-charge port 402 external receptacle 424. The rented PEV's VAP 420 unit could then communicate over the wired communication link to the Quick-Lock lock-charge port 402 reporting the ID device data that the VAP 420 requires to activate the PEV 422. The embedded microprocessor in the Quick-Lock lock-charge port 402 would then store the ID device data and the Quick-Lock lock-charge port 402 would be locked to secure the PEV 422 to the Quick-Lock lock-charge port 402. The transfer of ID device data or ID Code and the user's PIN data, if necessary, from the PEV's VAP 420 to the embedded microprocessor of the Quick-Lock lock-charge port 402 effectively trains the Quick-Lock lock-charge port 402 to act as an extension of the PEV's VAP 420 in requiring an appropriate ID device to unlock the PEV 422 from the Quick-Lock lock-charge port 402.

If the user is in possession of a privately owned PEV 422 equipped with a Quick-Lock accessory pack, the user would place his ID device on the Quick-Lock lock-charge port 402 ID device reader 418 effectively transferring the unique identification code of the ID device into the Quick-Lock microprocessor. If the system is configured to accept the user's PIN before unlocking the Quick-Lock, the PIN information may be manually entered into the Quick-Lock charge port via a PIN entry keypad on the lock-charge port 402 or the user's PIN could reside in the user's ID device.

Either with the Quick-Lock lock-charge port 402 interfacing with a VAP 422 or Quick-Lock accessory pack, once the ID device data and PIN data, if necessary, is known the Quick-Lock would lock onto the ramped-shaped latch and will not release the charge plug 414 until sufficient data is presented to the Quick-Lock lock-charge port 402. The user may benefit from using the Quick-Lock lock-charge port 402 by charging their PEV as well as having a reasonably secure locking system with minimal effort. If someone attempts to overpower the locking mechanism, cuts the charge cord 404, or somehow successfully interrupts power from transferring from the Quick-Lock lock-charge port 402 into PEV 422, an alarm on the Quick-Lock lock-charge port 402 could sound, lights could flash, and surveillance cameras could be time stamped to begin taking higher resolution imagery of the surrounding area. Otherwise the PEV 422 will remain securely attached to the Quick-Lock lock-charge port 402 charging until the user returns.

Once the user returns and places his ID device on the PEV VAP ID device reader or the Quick-Lock charge port's ID device reader 418 the presented ID device data is compared to the stored ID device data. By placing the user's ID device on either ID device reader, the Quick-Lock lock-charge port user interface or the VAP user display could indicate, e.g., via LED 424 sound, or display message 430 that the user enter his PIN using a key pad 428 if that information is required to unlock the PEV 422. If the VAP 420 receives the correct user information, then the VAP 420 may send the data to the Quick-Lock lock-charge port 402 for interpretation or the VAP 420 may indicate that there was sufficient data entered to prompt the locking mechanism to energize the solenoid to allow the user to unplug their charge cord 412 from the Quick-Lock lock-charge port 402.

If the Quick-Lock lock-charge port 402 ID device reader 418 and PIN entry keypad are used to enter the user's ID device data and PIN, then that data will be compared to the stored data inside the Quick-Lock's embedded microprocessor memory. If the user ID information matches, the Quick-Lock lock-charge port 402 energizes the solenoid to allow the user to unplug PEV charge cord 404 from the Quick-Lock lock-charge port 402. In this configuration when a rented PEV with a rental accessory pack is unlocked from the Quick-Lock lock-charge port 402 the VAP's ID device reader 418 and PIN entry keypad 428 of either the VAP or the Quick Lock lock-charge port 402 can be used to unlock the PEV 422 with the same result.

### Self-Lock Feature

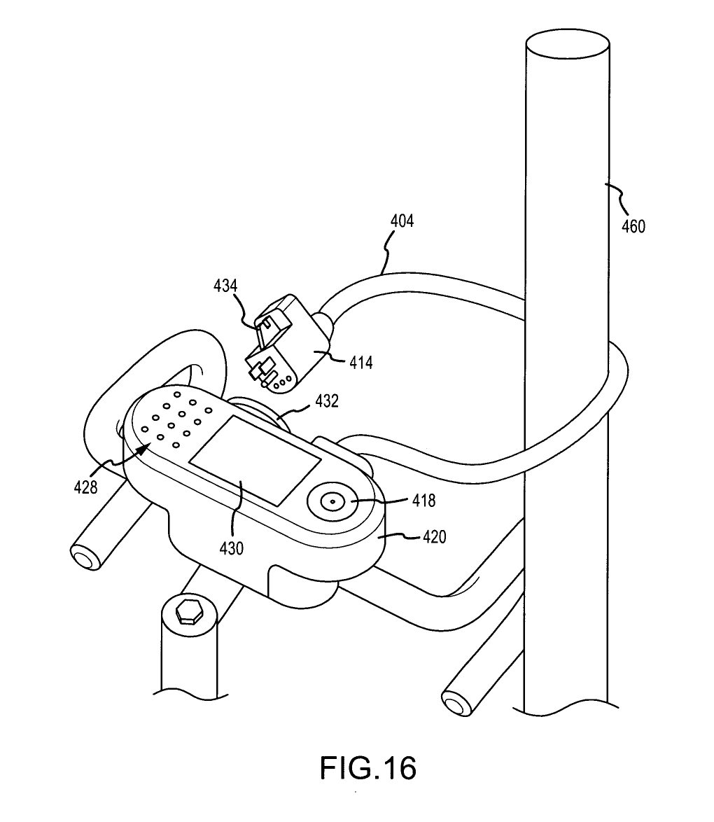

A Self-Lock assembly 432 with a locking mechanism capable of enduring mechanical stresses comparable to what is experienced by heavy duty bicycle locks or motorcycle locks may be mechanically anchored to the PEV within the VAP as shown in FIG. 16. The locking mechanism may be configured the same as the locking mechanism of the lock-charge port as described with respect to FIGS. 9-12 to ensure interoperability within the Port-Lock and Quick-Lock systems. The charge cord 404 could be wrapped around any available stationary object 460, e.g., a pole, and then retained in the self-lock assemble 432 to securely lock the PEV 422 to the stationary object 460. In addition to mechanically accepting the latch 434, the Self-Lock assembly 432 may also allow the male prongs 436 of the charge plug 414 to be inserted into the Self-Lock assembly. The Self-Lock assembly 432 on the VAP 420 could be configured in such a manner that the Self-Lock could only lock onto the charge plug 414 when the male prongs are also inserted into the Self-Lock assembly as suggested by FIG. 16.

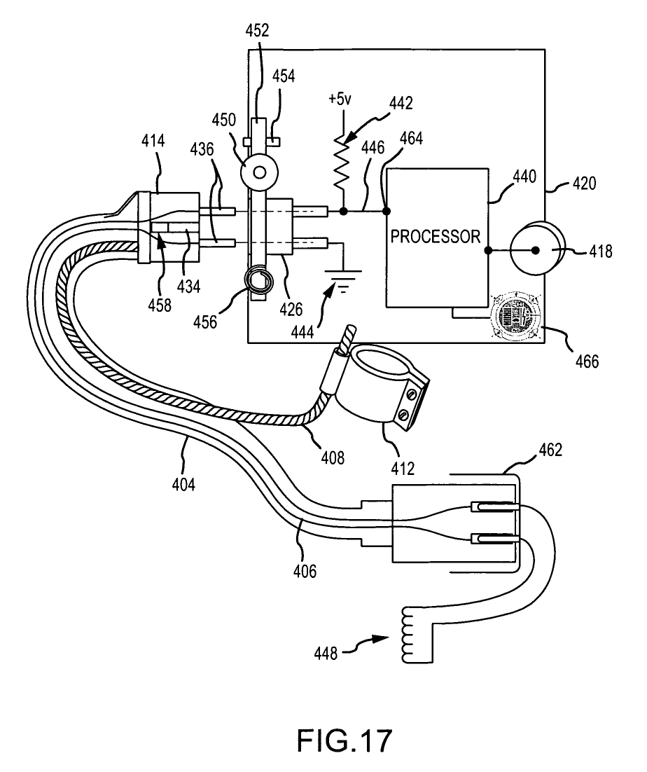

Once properly inserted into the Self-Lock assembly, one of the prongs 436 of the charge plug 414 could be electrically connected to the positive voltage supply 438 line of VAP's embedded microprocessor 440 through a 5 Kohm pull-up resistor 442 and any other of the prongs 436 (e.g., the neutral prong) of the charge plug 414 may be connected to the embedded microprocessor 440 of the ground with one possible embodiment shown in FIG. 17. When the charge plug 414 is inserted into the Self-Lock assembly 432, the transformer of the VAPs' battery charger and the transformer 448 of the PEV's battery charger, which are directly wired to the charge cord 404 and thus the charge plug 414, would short the 5 Kohm pull-up resistor 438 to ground 444. One of the logical I/O pins 464 of the microprocessor 440 may be wired to the low side of the 5 Kohm pull-up resistor 442 and could serve as the sense line 446 used to determine if the charge plug 414 is inserted into the Self-Lock assembly 432, indicating whether or not the Self-Lock is being utilized or not. If the Self-Lock assembly 432 is being utilized, the microprocessor 440 will sense a low voltage on the sense line 446 indicating the presence of the charge plug 414 that is shorting the 5 Kohm pull-up resistor 442 to ground 444.

This state of the VAP 420 would require the user to place the ID device on the VAP ID device reader 418 to activate the solenoid 450. The solenoid 450 rotates the locking bar 452 on the hinge 454 to raise the opposite end of the locking bar 452 in opposition to the force from the spring 456 and out of the notch 458 of the latch, thus enabling the user to remove the charge plug 414 from the Self-Lock assembly 432. After the VAP 420 has successfully identified the current user by their ID device, the VAP 420 could present text on the user information display 430 prompting the user to assist in uncoupling the charge plug 414 the Self-Lock assembly 432 while the VAP energizes the solenoid 450 enabling the user to remove the latch 434 from underneath the locking bar 452. Once the charge plug 414 is uncoupled from the Self-Lock assembly 432, the VAP 420 could sense that the user removed the charge plug 414 from the Self-Lock assembly 432 on the PEV 422 and turn off the solenoid 450 to conserve electrical energy, effectively locking the locking bar 452. After the PEV 422 is no longer locked to the stationary object 460, the VAP could instruct the user to stow the charge cord 404 back into the protective sheath or holster via the user information display 430 and turn on the PEV 422, allowing the user to take their PEV 422 to its next destination.

An alternative embodiment of the Self-Lock assembly 432 and its ability to sense its continuity could use one or both of the serial data signal wires or the signal shield. Since these data lines are not being used during the Self-Lock storage period of PEV usage it is possible to use these wires as continuity verification loops. Alternatively the VAP's battery charger could be designed with its own pull-up resistor to ground requiring only one of the charge plug prongs 436 to be used to sense for continuity of the charge cord 404. There are numerous methods of using the charge cord 404 as part of a continuity sensing circuit. By using the charge cord 404 as a locking cord, the electrical characteristics of the charge cord 404 can be used to verify the continual presence of a loop being made by the charge cord 404 ensuring that the thief is not able to take the PEV 422 with out the VAP 420 sensing a break in the locked charge cord loop.

### Vehicle Check Out

Charging status lights 426 and/or a text-based display in each lock-charge port may indicate which PEVs 422 in the rental station 400 are available for rent. A user information display 430 in the VAP 420 corresponding to sufficiently charged PEVs 422 could request that the user present an ID device to initiate a rental. A potential PEV renter may select a PEV by placing the ID device onto the ID device reader 418 in the VAP 420 on the PEV 422 of their choice. If the ID device is recognized by the embedded microprocessor 440 contained within the VAP 420, the user information display 430 may then present text to the user asking for a PIN to be entered using a keypad 428. Alternatively, an ID code entered into the keypad may be used as described. After the user enters the PIN through the keypad 428, the VAP 420 may communicate the ID device data or ID code, PIN data, PEV identification data, and port address data to the kiosk computer or communication gateway to request that the PEV 422 be rented to the user. The kiosk computer or server may either refer to a resident copy of the rental system's database or access the database resident in a electric vehicle management system (EVMS) central computer server via the Internet or an Intranet to determine whether the user is authorized to rent the selected PEV 422. If the user is not authorized to rent the selected PEV, the kiosk computer or server could then instruct the VAP 420 to deny access of the PEV 422 and present relevant text to the user information display. If the user is authorized to rent the selected PEV 422 the kiosk computer may instruct the VAP 420 to remember the user ID device data and PIN data as the data needed to activate the PEV 422. The VAP user information display 430 may indicate that the user should unplug the PEV 422 from the lock-charge port 402 at the same time the lock-charge port 402 may be instructed by the kiosk computer to actuate the solenoid 450 to unlock the PEV 422. Once the user unplugs the PEV 422 from the lock-charge port 402, the VAP 420 may sense the absence of alternating current and activate the PEV 422. The charge cord 404 could have an automatic or preformed recoil mechanism to aid the user in stowing the charge cord 404 in a protective sheath or other structures and keeping the charge plug 414 dry and protected from the elements encountered during the rental. The user could then ride the PEV 422 to any desired destination.

### Vehicle Operation During the Rental

Once the user reaches a desired destination, the user may turn the PEV 422 off by pressing a momentary kill switch on the VAP 420. The Self-Lock latch 432 on the PEV 422 may always be locked whenever the PEV 422 is turned off. The PEV may then be easily secured to a stationary object 460 such as a pole, tree, or bike rack by rapping the charge cord 404 around the stationary object 460 and inserting the charge plug 414 on the charge cord 404 into the Self-Lock latch 432 on the PEV. The user may then safely leave the unattended PEV 422 secured to a stationary object 460.

When the user returns to the PEV 422 the user may unlock the PEV 422 from the secure stationary object 460 by presenting the ID device to the ID device reader 418 in the VAP 420; the user may enter a PIN; or the user may present both an ID device and enter a PIN, depending on the security needs of the electric PEV rental system. The VAP embedded microprocessor 440 recalls the user identification information presented during the PEV's most recent check out procedure. Once the user is positively identified, the VAP 420 may then sense if Self-Lock assembly 432 is being utilized. If the Self-Lock assembly 432 is being utilized, the VAP 420 may turn on the solenoid, effectively unlocking the latch, while the VAP 420 may present text on the user information display 430 prompting the user to assist in uncoupling the charge plug 414 of the charge cord 404 from the Self-Lock assembly 432. Once the charge plug 414 is uncoupled from the Self-Lock assembly, the VAP 420 may sense that the user removed the charge cord 414 from the Self-Lock assembly on the PEV 422 and turn the solenoid 450 off to conserve electrical energy, effectively locking the Self-Lock locking mechanism until the next turn-on cycle of the PEV 422. After the PEV 422 is unlocked, the VAP may turn on the PEV 422, allowing the user to take the PEV 422 to its next destination.

If the user chooses not to use the Self-lock feature, the PEV's VAP 420 would sense that the Self-Lock feature is not utilized and the VAP 420 could turn the PEV 422 on after the user presents the ID device to the ID device reader 418. Alternatively, the user may enter a PIN or the user may have to present both an ID device and enter a PIN, depending on the security needs of the PEV rental system. If the user leaves the PEV 422 unattended without using the Self-Lock feature and somebody maliciously locks the unattended PEV 422 to a stationary object 460, assuming the PEV 422 was not moved or hidden, the user may simply present the ID device to the VAP ID device reader 418 enter a PIN, or both.

The embodiment described above provides an effective method of locking and unlocking the latching mechanism in the Self-Lock assembly 432 in the VAP 420 attached to the PEV 422 using the same ID device reader 418 and/or PIN entry keypad 438 to activate the PEV 422. This embodiment eliminates the need for additional switches, readers, or devices to lock and unlock the Self-Lock latching mechanism attached to the PEV 422. Because of the minimal interface required to operate the Self-Lock assembly 432, the user interface and user interaction steps are also minimized making the Self-Lock feature simple and intuitive to use.

### Vehicle Return

Once the user is done with the PEV 422 the user will need to return it to an available lock-charge port to complete the rental. After parking the PEV 422 in the lock-charge port 402 the user may withdraw the charge cord 404 from its sheath on the PEV 422 and insert the charge plug 414 into the electrical receptacle 424 in the lock-charge port 402 to complete the rental process. The lock bar 452 will automatically lock the charge port 414 by mechanically engaging the notch 458 on the latch 434 when the charge plug 414 is inserted into the lock-charge port 402. The VAP 420 may then sense alternating current in the charge cord 404 causing the VAP 420 to turn the PEV 422 off. The VAP 420 may then begin to attempt communication with the lock-charge port 402. If communication over the lock-charge port/VAP serial bus is possible, the VAP 420 may then relay PEV identification information and ID device information for use in identifying the returned PEV 422 to the to the kiosk computer. Once the kiosk computer acknowledges the PEV return, the VAP 420 may be instructed by the kiosk computer to erase the internal record of all the user identification information stored on the VAP 420 used to activate the PEV 422.

Invalid user identification information may be written into the VAP 420 making it impossible to activate the PEV 422 using the VAP 420 until new identification information is programmed into the VAP 420. An indicator 426, e.g., an LED on the lock-charge port 402 may indicate that the PEV 422 was returned and the user information display 430 on the VAP 420 may display text assuring the user that the rental return is complete. From the user standpoint all that is required is to plug the PEV 422 into the lock-charge port 402 and the rest of the PEV return process is performed by the PEV rental system. This minimal amount of interaction required by the user assures that returned PEVs will be plugged in and charging for their next rental.

### Vehicle Opportunity Charging

The charge plug 414 on the charge cord 404 may be designed to allow the user to perform opportunity charging of the PEV 422 in a standard household electrical receptacle. To provide this ability and facilitate the locking feature of the charge plug 414 end, the male prongs of the charge plug 414 may extend past any other features of the charge plug 414 ensuring the ability to insert the charge plug 414 into a standard household electrical receptacle. To initiate opportunity charging, the user may plug the PEV 422 into a standard household electrical receptacle. To terminate opportunity charging the user may unplug the PEV 422 from the standard household electrical receptacle.

Once plugged in to a standard electrical receptacle, the VAP 420 may sense alternating current on the charge cord 404 and could then attempt to communicate with the kiosk computer through a lock-charge port 402. If no communication link to the kiosk computer via a wired or wireless link can be established, the VAP 420 may deduce that the PEV 422 is being opportunity charged and the rental period would continue with the VAP 420 maintaining the user ID device and PIN data in memory for PEV activation. The VAP user information display 430 may indicate that the rental is still in process and the PEV 422 is opportunity charging.

If the wireless VAP 420 of the recently returned PEV 422 is able to establish a wireless communication link with a kiosk computer, the VAP 420 of the recently returned PEV 422 may request to be located within the lock-charge ports 414 controlled by the kiosk computer by asking the kiosk computer to sequentially turn off power to all the kiosk charge ports 414. If after the kiosk computer turned off power to all the lock-charge ports 414 that it controlled and the newly returned PEV VAP 420 still senses alternating current on its charge cord 404, the kiosk computer may then deduce that the recently returned PEV is not plugged into one of the kiosk lock-charge ports 402 but must be opportunity charging at an electrical receptacle that is within the wireless communication range of the VAP/kiosk computer communication link. In this situation the VAP user information display 430 would indicate that the PEV 422 is not successfully returned, but rather the VAP 420 would indicate on its user information display 430 that the PEV 422 is still being rented and is currently opportunity charging. The user ID device data and PIN data stored in the VAP 420 would continue to reside in the VAP 420 until the PEV 422 is returned to an actual lock-charge port 402. Electrical power may be activated for all the PEVs in the rental station lock-charge ports 402 and wireless communications between the opportunity charging PEV 422 and the kiosk computer could continue to update the kiosk computer until the PEV 422 is longer opportunity charging. Once the PEV 422 is unplugged, and no longer opportunity charging, the PEV 422 may report that information to the kiosk within wireless communication range to alert a change in status of the PEV 422. Once the PEV 422 is no longer opportunity charging, the wireless communication mission of the VAP 420 could switch from either reporting an opportunity charge session, trying to be located in a lock-charge port 402, to trying to be located within the PEV operational environment. At this point the PEV 422 that just terminated its opportunity charging session would be treated like any other wirelessly linked PEV 422 moving through the wireless communication range of a wireless kiosk.

### PEV Phone Home

Cable locks can be cut and are known to provide less than ideal security for small PEVs. A secondary use of the above described Self-Lock assembly 432 relies on the ability of the VAP 420 to monitor the electrical continuity of the charge cord 404 and the electrical connection between the PEV's charging receptacle 462 and the Self-Lock sensing circuitry. If the charge cord 404 is cut or the charge plug 414 is forcibly removed from the Self-Lock assembly 432, the VAP 420 will sense the situation immediately by reading a logical high on the I/O pin of the processor 440 wired to the low side of the 5 Kohm pull-up resistor 442. The only time this I/O pin 464 should go from logic low to logic high is after the VAP 420 has successfully identified the current user, energized the solenoid 450 and the user has successfully assisted in uncoupling the charge plug 414 from the Self-Lock assembly 432. The microprocessor 440 in the VAP 420 monitors the unlocking process preceding the sensor signal transitioning between a logic low to logic high state. If the sensor signal were to transition from a logic low to a logic high state at some other time besides when the VAP 420 actively unlocking the Self-Lock assembly 432, it would indicate that the charge cord 404 was cut or that the Self-Lock assembly 432 was being physically overpowered. In either case the microprocessor 440 may be interrupted from its current task and alerted of a possible stolen PEV situation.

The VAP 420 could be programmed upon sensing a stolen PEV situation to sound an audible alarm from within the VAP unit. Additionally, if the VAP 420 was installed on an InfoKey® activated Segway® the VAP 420 could drive a “stolen-vehicle” signal to a logical high. The stolen-vehicle signal could be wired to a Segway® InfoKey® or other manufacturer control device 466 embedded within the VAP 420 which could turn on the Segway's alarm feature where the PEV 422 itself could sound an alarm while resisting any attempt to roll the PEV 422. The VAP 420 could also flash a LED headlight 468 while sounding the alarm.

The VAP 420 as shown in FIG. 17 may be adapted to integrate with virtually any PV (personal vehicle) or PEV (personal electric vehicle). The VAP 420 may have a control panel common to all of the shared vehicle systems, for example, as previously described with respect to FIG. 3, so that the users of such systems have a universal, standardized interface. The mechanical housing or shroud of the VAP 420 can be customized for each vehicle type as necessary. In the housing of the VAP 420, interface electronics and electromechanical components may adapt to or connect to the original vehicle manufacturer equipment 466, translating the signals and commands from the VAP control panel into the equivalent signals and commands necessary to operate the vehicle. If the vehicle is a manual pedal bicycle where there are no signals or commands used by the original vehicle, the VAP 420 may be used to control a locking connector nose or similar locking device necessary to return a vehicle to the shared vehicle system and secure it until unlocked by the next user, using the VAP interface. The VAP 420 in this example may provide the user of the pedal bicycle all of the features common to other shared vehicles in the system. These features may include, for example, speed monitoring, vehicle tracking, and directional information.

Another example of adapting a universal VAP 420 involves a more complex PEV such as a Segway Personal Transporter® (PT®). The Segway PT® uses an RF identification and control device 466 called an InfoKey® Controller. The InfoKey® Controller provides display information to the rider and includes a few controls to turn on and off the Segway® PT® as well as to activate alarms and perform other control functions. It should be noted that the InfoKey® Controller is not permanently mounted to the Segway®. The user removes the InfoKey® Controller upon leaving the vehicle, keeping it in his or her purse or pocket or elsewhere, leaving the vehicle without controls during the operator's absence. The InfoKey® Controller therefore operates much like a conventional key that is associated with only a single vehicle and physically taken from the vehicle when not in use. The InfoKey® Controller as it is implemented by Segway® essentially prevents the Segway® PT® vehicles from being used in fleet rental operations.

By mounting the InfoKey® Controller components 466 inside a VAP 420 and electrically connecting those components to the VAP microprocessor 440 and other electronic circuits as shown in FIG. 17, the InfoKey® display and controls can be interfaced with the VAP 420. In this way, the buttons of the InfoKey® Controller can be “pushed” (i.e., activated) by the VAP 420 based on pushbutton commands from the VAP control panel 428 interpreted by the microprocessor 440. The information from the InfoKey® Controller display may thereby be “read” (i.e., input and translated) by the VAP microprocessor 440 and displayed as desired on the VAP display 430. In this configuration the VAP would provide the ability to use the Infokey® Controller RF transmissions to turn the Segway ON and/or OFF without any need to understand the particulars of the RF transmissions between the Infokey® Controller and the vehicle (information that any vehicle manufacturer would keep confidential). The electronic interface to the InfoKey® Controller can be done with pulse trains or other modulation methods that would prevent a would-be thief from simply breaking open the VAP 420 and using the embedded InfoKey® to operate the Segway®.

The VAP housing or shroud for use with the Segway PT® may be customized to mount to the Segway handle bar assembly, but the control panel 428 is essentially the same as with any VAP 420 mounted on any vehicle in the shared vehicle fleet, making the user interface for a subscriber of the shared vehicle service consistent from vehicle to vehicle regardless of type. The Segway PT® example is only one illustration of how the shared vehicle system VAP 420 can be adapted to control an existing commercial PEV or PV. This not only converts vehicle types that are incompatible with fleet operations in their native form to fleet rental vehicles, it also provides the important attribute of consistency of operation to the fleet application. This includes but is not limted to consistency of docking, charging, locking, and unlocking, as well as vehicle on/off controls, operational control functions, and information displays.

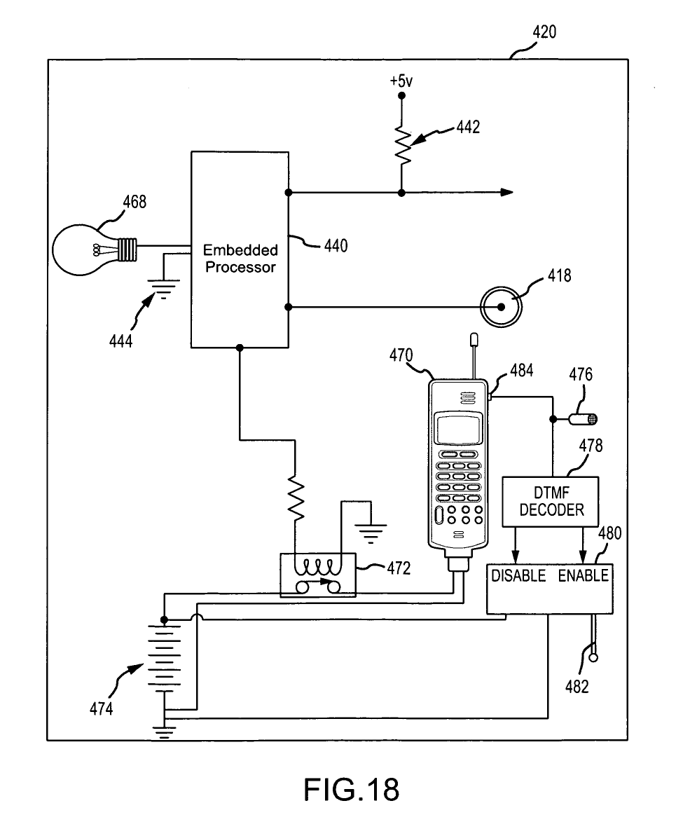

Additionally, with respect to FIG. 18, the VAP 420 may be programmed upon sensing a stolen PEV situation to instruct a mobile telephone 470 embedded into the VAP 420 to alert the PEV system manger of the stolen PEV situation through a number of different methods. The VAP 420 could control a solenoid or series of solenoids sized and positioned to enable the solenoid(s) to press a push button or series of push buttons on the keyboard of the phone 470 to instruct the mobile phone 470 to alert the PEV system manager of the situation. Alternatively, the hardware of a mobile phone could be integrated into the VAP 420 and placed under control of the microprocessor 440, which could access and control all the functionality of the mobile phone 470 via a software interface. This could be performed by the mobile phone 470 by having the mobile phone 470 call the system manager with caller ID on to enable identification of the phone number of the mobile phone 470 and the corresponding PEV 422 that was stolen. Alternatively the mobile phone 470 could be preprogrammed to generate a Short Message Service (SMS) message or generate an e-mail over the Internet when a certain button was pressed on the keypad. Further, the mobile phone 470 could have a global positioning system (GPS) chip embedded within it to provide location information about the PEV 422 to the system manager. A GPS chip could alternatively be included in the VAP 420 and placed under direct control of the microprocessor 440.

In an implementation as shown in FIG. 18, the VAP 420 could interrupt electricity from reaching the battery charging circuitry of the mobile by activating or deactivating a small relay 472 between the VAP battery and the mobile phone charging circuitry. This charge interruption could initiate a program resident within the mobile phone 470 that would alert the PEV system manager by SMS, e-mail, or phoning the system manager with caller ID enabled. Alternatively, an electrical interface signal inside the mobile phone 470 could be connected to the VAP 420 in such a manner that when the VAP 420 activated or deactivated the interface signal, the mobile phone 470 would alert the PEV system manager of the stolen PEV situation via either SMS, e-mail, or phoning the system manager with caller ID enabled.

Once the mobile phone 470 is instructed to alert the PEV system manager, a number of methods may be used to notify the PEV system manager of the possible stolen PEV situation. The mobile phone 470 may be programmed to call a pre-programmed phone number of the PEV system manager to notify a possible stolen PEV situation. Alternatively, an Internet enabled mobile phone 470 may be programmed to send an SMS or e-mail to the PEV system manager regarding the possible theft of the PEV 422. The mobile phone 470 could attempt to call the PEV system manager phone and, upon receiving a busy signal, reattempt to call a number of times in succession. If the dialed number is repeatedly busy or the call is otherwise unsuccessful after a predetermined number of attempts, the mobile phone 470 may stop trying to call the system manger and send an SMS or e-mail to the system manager instead. The mobile phone 470 could then wait for a predetermined period of time before reattempting to call the system manager of the possible stolen PEV 422. In cases where a number of PEVs are stolen at once, it would be helpful for the mobile phone 470 to stop attempting to call the system manager after a reasonable number of unsuccessful calls are attempted, thus freeing up the phone system for other types of communication.

Depending upon whether the PEV system manager was alerted to the possible stolen PEV situation by an incoming phone call, e-mail, or an SMS text message, the system manager may then use a number of tools at his disposal to locate the PEV. An incoming SMS text message or e-mail could provide the mobile phone number and reveal the PEV's current latitude and longitude position and speed within the incoming SMS text or e-mail message using information provided by the GPS chip. An incoming phone call from the mobile phone 470 will provide the system manager with the phone number of the mobile phone 470 making the call. The mobile phone number could be tied to a PEV identification in a database to identify the particular PEV. Knowledge of the mobile phone number may also enable the system manager to locate the possible stolen PEV service provider's GPS tracking information. The system manager may be provided real-time information regarding the PEV's current and past location history. For example, if a PEV with a 12 mph top speed were detected going 35 mph down a major roadway it would be fairly obvious that the potentially stolen PEV was being moved by another vehicle. If the thief kept the VAP 420 on the stolen PEV 422 the mobile phone 470 could continue to report its location to the system manager either through a GPS locating service like Accutracking or through SMS or e-mail messages that contain the PEV's current latitude and longitude. To perform the communication necessary to report a potentially stolen PEV, the mobile phone 470 could be programmed to respond to input information such as the mobile phone power being interrupted or a button or series of buttons being pressed on the mobile phone keypad to initiate the reporting of a potentially stolen PEV.

### PEV Phone Home Mobile Phone Modifications

Upon sensing a stolen PEV situation the VAP 420 could either press a button on the mobile phone keypad, halt the battery charging power to the mobile phone 470 or change the state of an I/O signal of the mobile phone 470. The VAP 420 could use any of these methods singularly or in combination with one another to trigger the embedded mobile phone 470 to notify the PEV system manager of a possibly stolen PEV 422. An application program may be provided on the mobile phone to determine the actions that the mobile phone takes to notify the PEV system manager.

Before installation into the VAP 420, the mobile phone's ringer/speaker could be muted to prevent an audible phone sound from emanating from the VAP 420. Further, the mobile phone's vibrator could be turned off and the mobile phone 470 could be set to not accept messages or voice mail. The mobile phone 470 may be programmed to not answer any incoming calls except when a call originates from certain phone numbers identified by the mobile phone caller ID. This would eliminate the possibility of someone intentionally tampering with the mobile phone functionality unless they had access to the system manager phone. One phone number answered by the mobile phone 470 when identified by the caller ID could be a default number that is not field programmable. A second number that the mobile phone 470 would answer when identified by the caller ID could be field programmable through the mobile phone keypad.

The field programmable phone number could also be programmed remotely from any push button phone that the mobile phone 470 has been programmed to answer. To program the mobile phone remotely the system manager could call the mobile phone 470 and enter a series of dual-tone multi-frequency (DTMF) inputs to place the mobile phone 470 into a mode where the field programmable phone number could be entered into mobile phone 470 via the system manager phone. After the field programmable phone number is entered, the mobile phone 470 could pause, then generate its own DTMF sound to prompt the system manager to verify the field programmed number a second time. If both numbers entered by the system manager are the same number, then the mobile phone 470 will answer incoming calls from the newly programmed phone number.

This functionality of the program residing in the embedded mobile phone 470 allows the system manager to assign a different phone to each stolen PEV, allowing each stolen PEV to have its own telephone number to communicate to lessen the possibility of busy signals. The default number that is not field programmable can also be used to communicate with the mobile phone 470 in case something happens to the telephone at the field programmable number. After the remote field programming is complete, the mobile phone 470 may then answer when it receives a phone call from the phone with the newly programmed phone number. This also allows the system manager phone number to be changed if necessary without having to enter into the VAP 420 to gain access to the mobile phone keypad.

The phone numbers that the mobile phone 470 is programmed to answer could be the same number or a different number from the phone number that the mobile phone 470 calls when the VAP 420 indicates that a potential stolen PEV situation has occurred. This response number could also be field programmable with a programming sequence similar to the one described above. When the mobile phone 470 successfully initiates a phone call to the system manager phone, the mobile phone caller ID can be recognized by the system manager phone enabling the system manager to identify the particular phone reporting the potentially stolen PEV. Once the mobile phone 470 has successfully connected to the system manager phone, the mobile phone 470 may continue to keep the phone line connected for a predetermined time before terminating the call to ensure successful caller ID. By staying connected to the system manager phone for only a brief period of time, other PEV mobile phones could call in and report additional thefts. After the mobile phone 470 has terminated the call, the mobile phone 470 will remain on and able to answer calls from the two phones that it has been preprogrammed to answer; all other calls from other phones will be ignored. If it is required to suspend the GPS locating service to answer an incoming call or initiate an outgoing call, the mobile phone 470 will suspend the GPS locating service software, answer or initiate the call, then enable the GPS locating service software to enable the GPS locating software to track the PEV 422 in real time.

One of the above embodiments suggests that the mobile phone 470 could be programmed to call or send an SMS text message to a preprogrammed phone number or send an e-mail to a predetermined e-mail address whenever the mobile phone lost its battery charger power to alert the PEV system manager that the PEV was potentially stolen. To enable the mobile phone 470 to behave in this manner, a program that monitors the mobile phone input battery charging voltage sensor would need to be installed on the mobile phone 470. The program would monitor the mobile phone battery charger inputs to determine if they are removed from the internal battery power of the VAP 420. The program residing in the mobile phone 470 could either send out an SMS text message to the system manager or call the system manager phone number that was pre-programmed into the mobile phone 470.

An additional benefit of initiating the call to the PEV system manager upon noting the absence of the mobile phone battery charger power would be to provide an alert to the system regarding a PEV 422 with a VAP battery that is completely depleted of stored electrical energy. In this situation the mobile phone 470 would be able to provide an alert regarding the discharged status of the VAP battery and also communicate the location of the PEV 422 to enable dispatch of service personnel to the stranded PEV 422. In this situation if it were determined that the PEV VAP 420 should not have run out of stored electrical energy during the user's trip, the service personnel could deliver a replacement PEV 422 for the user to avoid any inconvenience to the user due to a dead VAP battery. Additionally, if the PEV 422 had been abandoned or the user forgot that they had rented a PEV 422 and left it unattended for several days, the PEV VAP internal battery pack would eventually become depleted of its stored energy causing the embedded mobile phone 470 to notify the system manager of the location and status of the abandoned PEV. The mobile phone 470 could perform the necessary communications to the system manager phone even though the VAP battery pack was depleted because the mobile phone internal battery would have been fully charged by the VAP battery until the VAP battery became depleted. Typically the mobile phone would have a few days of standby power available to send and receive calls from the system manager once the VAP internal battery pack became depleted.

The mobile phone 470 could be field programmable via the system manager phone to disable and enable the GPS locating software to conserve battery power. Additionally the halting of the VAP power to initiate distress call to the system manager does not need to be continued after the distress call is made. The mobile phone 470 could be reconnected to the VAP internal battery pack by the VAP embedded microprocessor 440 by deactivating or activating the relay 472 between the VAP battery pack and the mobile phone battery charger after a brief period of time, ensuring the mobile phone 470 would remain operational for as long as either the VAP internal battery pack or the mobile phone battery contained stored electrical energy. This could allow the mobile phone 470 to operate off of the VAP battery pack to extend the mobile phone operation time, which could be important when trying to locate a stolen PEV 422 using the mobile phone 470.

In an alternative scenario, a user could return to a site where he left the PEV, but find the PEV 422 stolen or misplaced. The user could call the system manager to report the stolen PEV 422 and the system manager could call the mobile phone 470. By pressing a series of keystrokes, as described in the “plea for help” paragraphs below, the system manager could prompt the mobile phone 470 to send out a SMS text message or e-mail indicating the current geospatial coordinates of the PEV 422 or the system manager could use a GPS locating service to determine the current position and speed of the PEV 422. That information could be communicated to the user in case the user forgot where the PEV 422 was last parked. If on the other hand the PEV 422 was found to be traveling 60 mph on the freeway, the system manager could verify that the PEV 422 was stolen and ask the user if they utilized the Self-Lock feature to secure the PEV 422. It should also be mentioned that most GPS locating service providers include alarms that can be set by the system manager to initiate an SMS text message if the PEV 422 is traveling faster than its maximum speed or is beyond a preset geo-fenced region making it likely that the 60 mph PEV would be identified by the system manager as a stolen PEV 422 long before the user called to report the PEV 422 stolen.

With a mobile phone 470 programmed to call into a specific phone number or generate an SMS or an e-mail message when its battery charging power is interrupted, it may be possible to monitor power outages of various types of electrical power supplies. For example, the mobile phone 470 could be attached to the standard alternating current transformer that comes with the phone to charge the batteries. The internal circuitry of the mobile phone 470 could detect the absence of the battery charging power when the alternating current supply was removed due to a power outage. The mobile phone internal program could then call a preprogrammed phone number or send an SMS text or e-mail message to alert the system manager of the faulty grid power supply. If a mobile phone 470 was connected to grid power at each kiosk computer in the PEV rental system, this embodiment could provide the system manager with an overview of the power outages being experienced by the PEV rental system by mapping out the locations that reported their mobile phone 470 lost grid power.

Alternatively the mobile phone 470 in the current embodiment could be used to monitor the presence and effective operation of electrical equipment that generate grid power in remote locations where it is infeasible or not cost effective to provide human security surveillance. By requiring the presence of grid power, the mobile phone 470 could call maintenance personnel to the site whenever grid power is lost. The mobile phone 470 could be set up to monitor grid power in a cabin or second home that needed grid power to prevent the plumbing pipes from freezing. If the mobile phone 470 detected a loss of grid power, the owners of the structure could be notified of the loss in power and the owners could attempt to restore power to the structure before the plumbing pipes burst avoiding huge expense and hassle. In the above stationary applications where it is not necessary to know the location of the mobile phone 470, it would be possible to utilize a standard mobile phone that does not supply GPS information to the user. Most mobile phones are capable of detecting when their battery charger is connected to grid power making it feasible to use the mobile phone as a remote grid power detector without altering the mobile phone internal hardware.

Alternatively it may be possible to use the mobile phone display to indicate when the mobile phone battery is being charged. Typically a mobile phone LCD display is lit by an LED backlight when connected to a battery-charging power source. Once the battery charging power source is unplugged or the grid power is interrupted the mobile phone LED backlight display is turned off after a few moments. By directing a light sensitive sensor towards the mobile phone display and masking off any other incident light, it may be possible to externally detect when the mobile phone 470 is no longer being charged. The light sensor could be electrically connected to a circuit that could energize a solenoid that could press a preprogrammed button on the mobile phone 470 or the microprocessor 440 in the VAP 420 could control the mobile phone 470 to initiate a call to the system manager regarding the absence of power to the mobile phone 470. Alternatively, the sensor could be energized whenever a simple voltage circuit detected that the battery charging power was not present at the input to the mobile phone 470. There are numerous methods of implementing the mobile phone ability to detect an absence of power and then initiate a call to a preprogrammed phone number to remotely announce the loss of power.

### PEV Plea for Help

Although most GPS-equipped mobile phones 470 are capable of locating their position on the planet, in ideal conditions most GPS antenna are not able to pinpoint their location when enclosed in metal or concrete structures. Since thieves are known to hide their newly stolen property, it would be likely that the newly stolen PEV 422 would be hidden in an enclosed structure for some time making it likely that the VAP internal battery and the mobile phone battery would run down before the PEV 422 was located. Additionally, law enforcement agents are unlikely to enter into a building without a search warrant based on the last GPS location identified by the mobile phone 470. To resolve the shortfalls of the mobile phone 470 ability to accurately track a PEV 422 in less than ideal conditions, a radio micro-transmitter 480 could be integrated to the mobile phone 470 embedded in the VAP 420 as shown in FIG. 18. The micro-transmitter 480 may be plugged into the earphone/microphone jack 484 of the mobile phone 470 with a DTFM circuit 478 between the mobile phone earphone jack 484 and the micro-transmitter 486.

Additionally, the mobile phone microphone 476 may be utilized to “listen in to” the location of the PEV, possibly providing additional clues to the location of the PEV. When the system manager calls the mobile phone 470, the system manager will be able to hear the surrounding sounds being received by the microphone 476. Similarly the DTFM circuit 478 plugged into the mobile phone headphones would be able to “hear” any sounds the system manager made on his phone. For example, the system manager could push button number 7 on his phone and the DTFM circuit 478 would sense the corresponding tone for push button 7, which could turn on the micro-transmitter 480. The micro-transmitter 480 could then draw on the VAP internal battery for transmission power. If it were desirable to turn off the micro-transmitter 480, the DTFM circuit 478 could be implemented to recognize the tone for push button 0 from the system manager push button phone and turn off the micro-transmitter 480.

With the ability to turn the micro-transmitter 480 on and off, is possible to locate the PEV 422 with a PEV recovery team by using a Yagi or other highly directional antenna tuned to the frequency of the micro-transmitter 480 attached to a radio receiver 482 that had the ability to attenuate the incoming micro-transmitter signal.

With this type of configuration it is possible to locate a PEV 422 inside a home, warehouse, car, parking structure, etc. Basically the mobile phone 470 could be used to determine the rough location of the stolen PEV 422 by relying upon either GPS information, if available, or cell tower location if the mobile phone 470 could communicate with the cell tower but not track GPS satellites. Once the rough location of the stolen PEV 422 is known, the PEV recovery team would go to the general location where the stolen PEV 422 is known to be located. The micro-transmitter 480 could be turned on as described above. The Yagi antenna and radio transmitter, capable of attenuating its receiver circuitry could be used to locate the stolen PEV 422 to the confines of a building or structure down to the precision of about 2 feet if obscured by a wall. Once the structure that contains the PEV 422 is located, local law enforcement agents could be called upon to assist in the PEV recovery. In the United States of America if a felony is in process, a law enforcement officer can enter a building.

With the micro-transmitter 480 broadcasting its own unique data signal it would be possible to ensure law enforcement that the micro-transmitter 480 is inside the identified building, is an electronically identifiable radio transmission, and is legally considered an electronic plea for help. If there was any question about it being the micro-transmitter 480 producing the plea for help, the micro-transmitter 480 could be turned off and back on via the mobile phone 470 demonstrating to law enforcement that it is indeed the stolen PEV micro-transmitter signal that is being received. Once law enforcement is confident that an electronic plea for help is being made by a stolen PEV 422 there is sufficient proof that a felony is in progress and law enforcement would have probable cause to enter into the identified building and retrieve the stolen property without a warrant or court order. Law enforcement officers generally appreciate the opportunity to go into a building where a suspected felony is in process as they know there is probably more than one unlawful activity occurring within the building. This system provides the probable cause that allows them in the door with out a search warrant or court order, making it likely to receive supportive law enforcement assistance.

### Alternative Embodiments of Port-Lock and Self-Lock

The above embodiments describe locking mechanisms on both the lock-charge port and PEV that accept an integrated latch and electrical plug at the end of the PEV charge cord to support both Port-Lock and Self-Lock. An alternative embodiment may entail a latch on both the lock-charge port and PEV that a locking mechanism at the end of the charge cord could lock onto. The VAP may control the locking mechanism at the end of the PEV charge cord. The locking mechanism may be positioned to allow the charge plug at the end of the charge cord to be plugged into a standard electrical receptacle enabling opportunity charging. The locking mechanism and latch on the lock-charge port may be positioned such that the only way the charge plug could receive electrical power would be to lock the locking mechanism to the latch. The VAP may unlock the locking mechanism at the end of the charge cord, which could enable PEVs with a wireless communication link the ability to lock to electrical receptacles containing an appropriate latch. In this type of system there may be no ability to precisely identify the location of each PEV within the lock-charge port, but the PEV rental system could know how many PEVs were available for rent at a given PEV rental kiosk. To function effectively within this alternative PEV rental system configuration, the PEV's battery charge current monitor could be contained on the VAP. The alarm indicating a PEV was stolen could also be integrated into the VAP.

In this configuration, reservations may be handled by the PEV rental system by evaluating which PEVs at a kiosk are available for rent using a wired link between the PEV's VAP and the kiosk computer or communication gateway to a central server. When a PEV is available for rent because its batteries are sufficiently charged, the VAP may inform the kiosk computer of its availability. For example, three reservations for PEVs were being served by a particular kiosk, the kiosk would insure that three PEVs had yellow indicator lights, corresponding to three reserved PEVs, illuminated in the kiosk serviced area. A user who had a reservation could select a PEV with a yellow indicator light illuminated on its VAP or the user could select a PEV with a green indicator light illuminated on its VAP, indicating that it was charged and not reserved, and the kiosk could reduce the number of VAPs with yellow indicator lights to two once the user with the reservation successfully rented a PEV.

During the rental check-out, after the user is sufficiently identified from their ID device and/or PIN entry, the VAP energizes the unlocking solenoid and notifies the user via the user information display that the user should unplug the PEV. Once the charge plug is removed from the electrical receptacle in the lock-charge port the VAP battery charging current sensor could detect that the charging current ceased, indicating that the PEV has been unplugged. Once unplugged the VAP could continue to activate the unlocking solenoid for a specified additional amount of time to ensure that the user has sufficient time to fully remove the PEV and does not accidentally lock the PEV back onto the lock-charge port. Once the additional amount of time passes, the PEV would be considered unplugged and the VAP would stop activation of the unlocking solenoid to save electrical power.

The lock at the end of the charge cord may be designed, as stated in the above embodiments, to allow the lock to engage the latch when the latch is inserted into the lock with no power required. By plugging into an electrical receptacle that contains a latch, the VAP on the PEV would sense electric current flowing through its current sensor enabling the VAP to know that the PEV is plugged in. An additional sensor may be included in the lock at the end of the charge cord to sense whether the lock is actively locked onto a latch. This could indicate that the PEV was returned to a lock-charge port or not locked onto a latch, whereby if current is sensed by the alternating current sensor it may be deduced by the VAP that the PEV is not plugged into a lock-charge port and is merely opportunity charging. Once plugged into a lock-charge port, the VAP may turn the PEV off and request that the kiosk computer acknowledge the rental return via its wired or wireless communication link with the kiosk computer. The PEV would then be locked, turned off, and returned with a user activity of merely plugging the PEV into a lock-charge port.

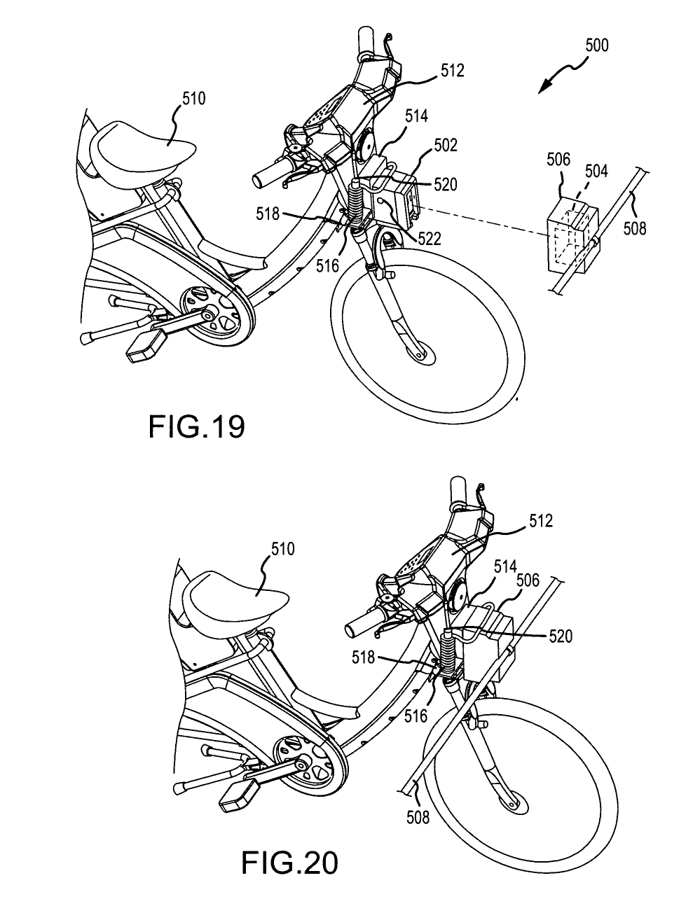

One exemplary implementation of an alternative port lock system 500 is presented in FIGS. 19-29. The port lock system 500 provides a very simple method for users of PEVs, either through rental or subscription, to checkout and return PEVs in an intuitive way that eliminates the normal burden of unlocking or parking and locking PEVs. The port lock system 500 does not require the use of a kickstand to hold the PEV upright after dismounting. Compared to previously described embodiments, the port lock system 500 eliminates the process of locating and orienting a charge cord and plugging a charge plug into a lock-charge port. In fact, the users hands do not come anywhere near the electrical outlet or plug, thus increasing safety in wet weather conditions.

As shown in FIGS. 19-22, a PEV 510 is equipped with a structure on the head post below the handlebars and the VAP 512, hereinafter referred to as a nose connector 502. A nose mount 514 may be interposed between the nose connector 502 and the head tube or other similar structure on a PEV 510 to orient the nose connector 502 generally parallel to vertical when the PEV 510 is being operated. A rack bar 508 provided in the rental area as part of a Port-Lock strip or alternately as a Quick-Lock strip is configured with a number of Lock-charge ports 504 sized and designed to interface with the nose connectors 502 on the PEVs 510. The lock-charge port 504 may further be covered by a port shroud 506 for reasons described below. Both the lock-charge port 504 and the port shroud 506 are mechanically affixed to the rack bar 508. Alternatively, the lock-charge port 504 may be physically attached to the rack bar 508 while the port shroud is only attached to the lock-charge port 504. The lock-charge port 504 is also electrically connected to a power source running through power cables within the rack bar 508.

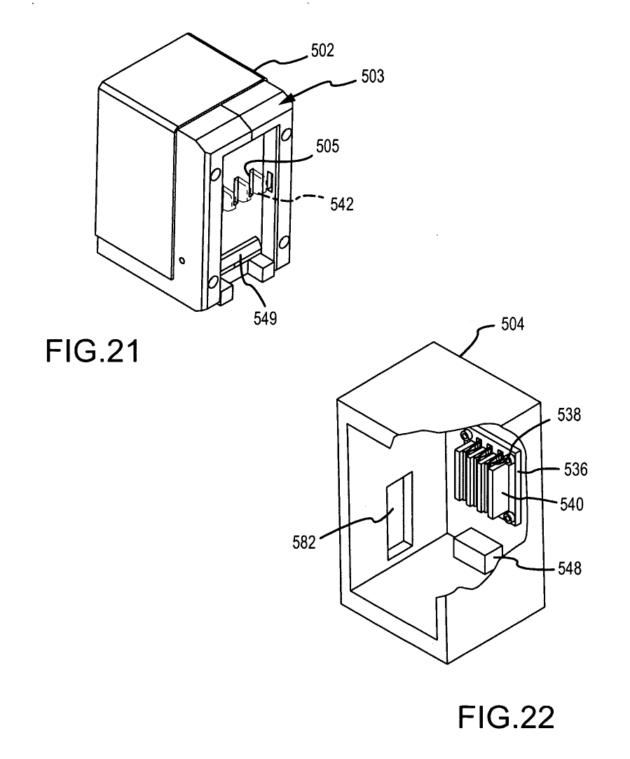

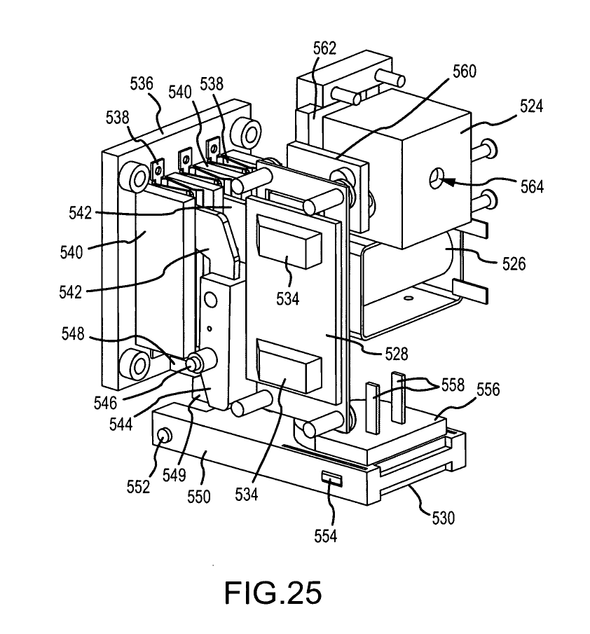

As indicated in FIGS. 19 and 20, locking the PEV 510 upon rental return is a very simple process. The user simply rides the PEV 510 up to the rack bar 508, aligns the nose connector 502 on the front of the PEV 510 with the lock-charge port 504 within the port shroud 506, and inserts the nose connector 502 into the lock-charge port 504 through an opening in the port shroud 506. Once the nose connector 502 is fully received in the lock-charge port 504, a lock latches within a latch plate opening 582 and the PEV 510 is connected to a power supply to recharge the batteries of the PEV 510. As shown in FIGS. 21 and 22, a set of three contact blades 542 are housed within the housing 503 of the nose connector 502 and are forced through vertical openings 505 in the housing 503 when the nose connector engages the lock-charge port 504. The contact blades 542 interface with an electrical receptacle 536 in the lock-charge port 504 configured with three corresponding vertically-oriented receptacles 538 separated by a set of insulating panels 540. The contact blades 542 are mounted on a spring hinge 546 (see FIG. 25) and are rotated out the vertical openings 505 when an engagement bar 548 in the lock-charge port 504 presses against a push bar 549 that is connected to an opposite end of the contact blades 542 and pushes them to rotate about the hinge 546.

Due to the rectangular interface between the lock-charge port 504 and the nose connector 502, the PEV is held vertically upright against the rack bar 508 and will not fall over. No kickstand is needed to support the PEV 510 when the nose connector 502 is inserted into the lock-charge port 504. The port lock system 500 may also be designed to place the rack bar 508 at a height corresponding to the height of the placement of the nose connector 502 on the PEV 510. In this manner, the user merely has to ride or drive the PEV 510 directly into the lock-charge port 504 and the PEV 510 is locked, charging, and held firmly in place while a user mounts or dismounts. The user never has to dismount before the PEV 510 is locked securely in place and never has to take his or hands off the handlebars. There is also some vertical play in the interface between the nose connector 502 and the lock-charge port 504 as further described below to allow for some margin of error in the vertical alignment between the nose connector 502 and the lock-charge port 504, for example, due to uneven ground or a flat or low pressure tire.

Several additional features of the port lock 500 system are shown in FIGS. 19 and 20. Each PEV 510 is equipped with a VAP 514 and a cable lock 516 for remotely securing the PEV 510 to a stationary structure in a Self-Lock operation. The cable lock 516 may be a self-coiling, steel cable for ease of storage and to ensure that the cable lock 516 is out of the way of moving parts when the PEV 510 is operating. The cable lock 506 may be stored on a post 520 mounted to the PEV 510, for example, as a part of the nose mount 514. Alternatively, the first end of the cable lock 516 may be fixed to a side or frame of the nose connector 502 in order to perform a continuity test to monitor for a potential theft of the PEV 510 when in a Self-Lock situation as previously described herein. A first end of the cable lock 516 may be securely attached to the frame of the PEV 510 in any of the manners previously described herein with respect to security cables in charge cords. The second end of the cable lock 516 is a latch head 518 that may be secured within the nose connector 502 through a Self-Lock receiver 522 in one the side of the nose connector 502. The locking mechanism in the nose connector 502 for the latch head 518 of the cable lock 516 is described in greater detail below.

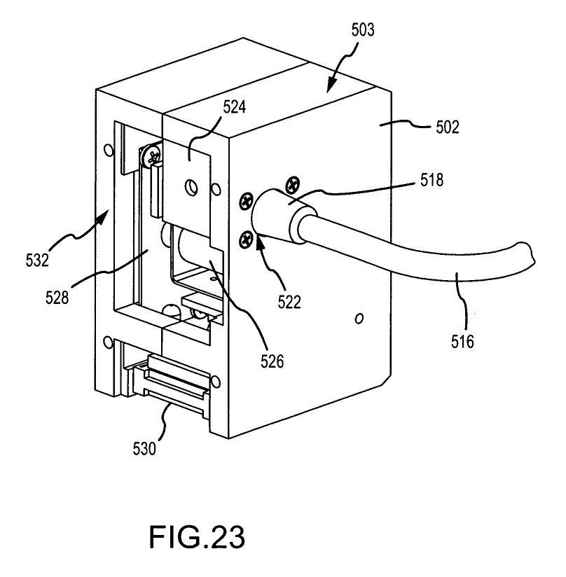

Turning now to FIGS. 23 and 24, the exterior of the nose connector 502 is presented in greater detail. FIG. 23 in particular depicts the latch head 518 of the cable lock 516 inserted within the self lock receiver opening 522. A rear face 532 of the nose connector is shown, which provides a mounting surface for mounting the nose connector 502 against the nose mount 514. As shown in FIG. 24 two ramped bolts 534 protrude from the opposite side of the nose connector assembly. These ramped bolts 534 securely hold the nose connector 502 within the lock-charge port 504 as further described below. While two ramped bolts are shown, a single ramped bolt could also suffice and the plurality of ramped bolts, if desired, would not be limited to two. An electrical receptacle 536, which is part of the lock-charge port 504 is shown engaged with the front of the nose connector 502. Additional components visible in FIGS. 23 and 24 are a cable lock mechanism 524, a solenoid 526, and a convenience charge plate 530, each of which is described in greater detail below.

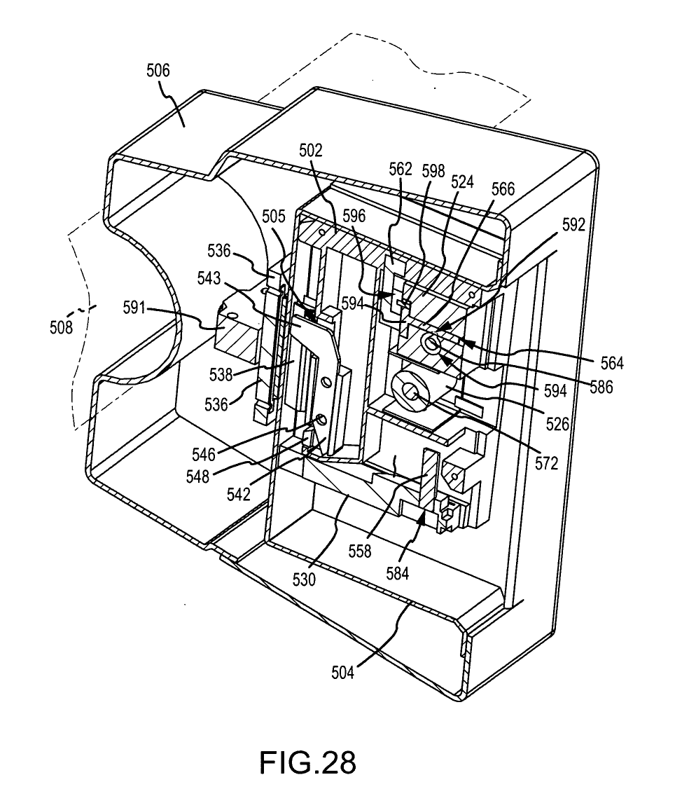

FIG. 25 depicts the components of the nose connector 502 with the external housing 503 removed and engaged with the electrical receptacle 536 of the lock-charge port 504. The nose connector 502 houses three vertically oriented contact blades 542 held in a rotating blade mount 544 that interface with the electrical receptacle 536. The electrical receptacle 536 defines three vertical receptacles 538, which are sized and positioned to mate with each of the three contact blades 542 to transmit power from the lock-charge port 504 into the nose connector 502 to ultimately charge the batteries of the PEV 510. The vertical receptacles 538 are separated by insulating panels 540 to ensure that there is no short between each of the contact blades 540 and receptacles 538. The electrical receptacle 536 is further configured with a ground fault interrupt (GFI) circuit breaker 591 as seen to good advantage in FIG. 28. The GFI breaker 592 limits the possibility of an electrical shock accident, especially when the lock-charge port 504 is mounted outside in the elements. The GFI breaker may further be configured to prevent the flow of electricity to the vertical receptacles 538 when the contact blades 542 of the nose connector 502 are not in contact. This prevents accidental electrocution if someone were to improperly access the interior of the lock-charge port 504.

The contact blades 542 rotate within the blade mount 544 about a spring-loaded hinge 546. The hinge 546 is biased to hold the contact blades 542 at an angle within the housing 503 so that the contact blades 542 are not exposed when the PEV 510 is being used by a renter or subscriber, The housing 503 defines three vertical openings 505 (as seen to good advantage in FIG. 28) through which a head portion 543 of the contact blade 542 protrudes to interface with the vertical receptacles 538. When the nose connector 502 of the PEV 510 is placed within the lock-charge port 504, an engagement bar 548 on the bottom of the electrical receptacle 536 enters a horizontal opening in the housing 503 and pushes against a push bar 549 at the bottom of the blade mount 544, thus rotating the position of the contact blades 542 about the spring-loaded hinge 546 and pushing the blade heads 543 out the vertical openings 505 in the housing 503 to mate with the vertical receptacles 538.

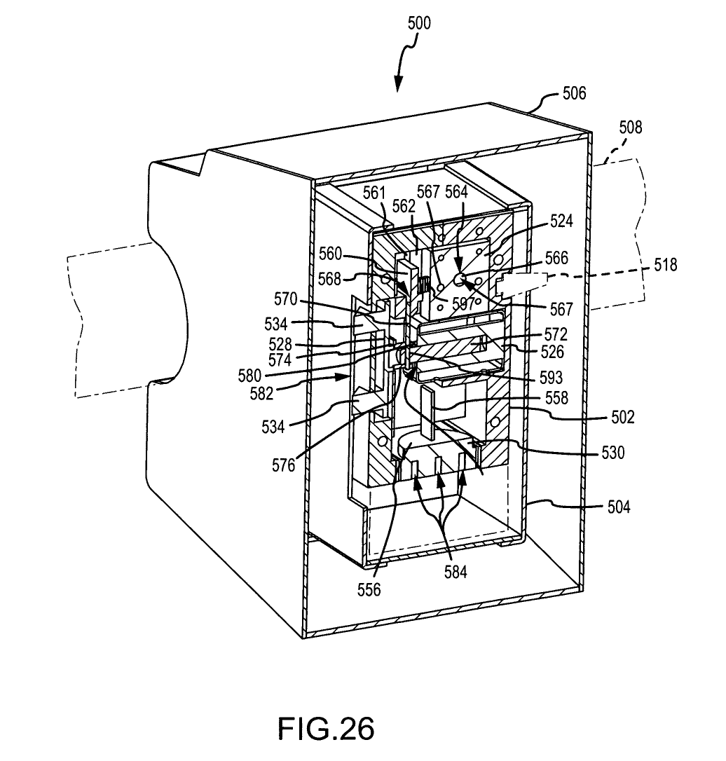

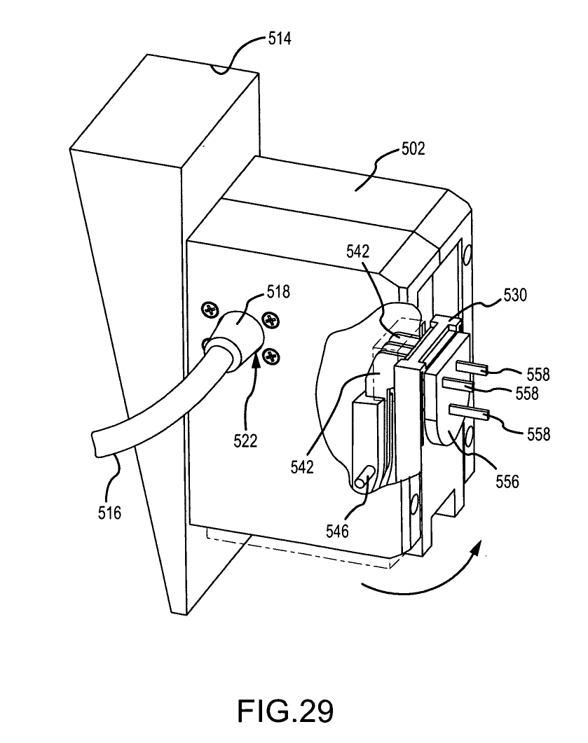

The nose connector 502 is also configured to provide a convenience charge mode. A convenience charge plate 530 forms the bottom panel of the housing 503. The convenience charge plate 530 rotates at one end on a hinge 552 and is held in place in a normal position by detents 554 on either side of the convenience charge plate 530 which protrude through openings 555 in a frame structure 557. The convenience charge plate 530 forms a convenience plug 556 that is stowed within the interior of the nose connector 502 when not in use. The convenience plug 556 defines three slotted receptacles 584 in a bottom face (as seen to good advantage in FIG. 26) that mate with the contact blades 542 when the convenience charge plate 530 is rotated upwards as shown in FIG. 29. The opposite side of the convenience plug 556 supports three electrical prongs 558 formed, for example, in a standard configuration for attachment with a universal computer power cord. The electrical prongs 558 are electrically connected through the convenience plug 556 to the slotted receptacles 584 and thus will be electrically connected to the contact blades 542 when the convenience charge plate 530 is engaged. In this way by simply flipping up the convenience charge plate 530, the user may charge the PEV 510 at any power outlet at any time.

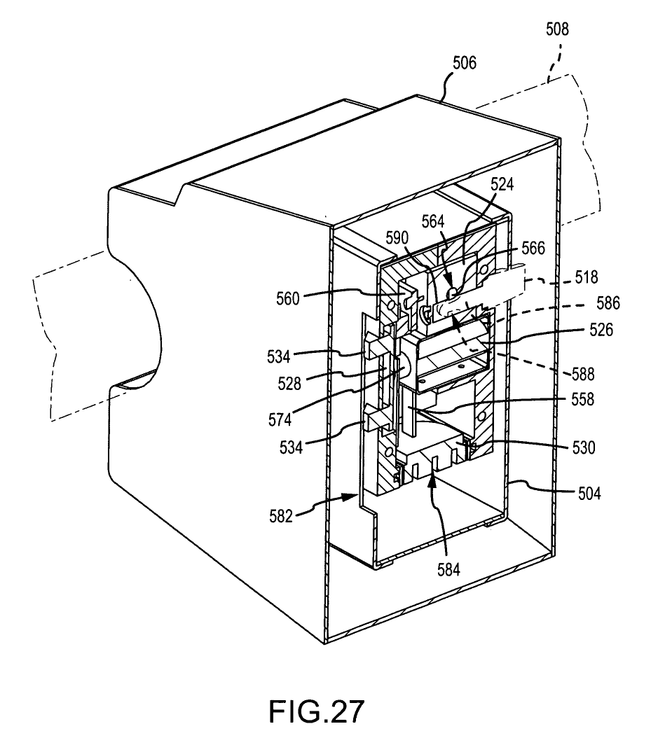

It may be noted that the length of the vertical receptacles 538 is significantly longer than the blade heads 543. It may also be observed in FIGS. 26 and 27 that the height of the housing 503 of the nose connector 502 is significantly shorter than the opening in the lock-charge port 504. This provides the lock-charge port 504 a large amount of vertical play in the alignment between the contact blades 542 and the vertical receptacles, further adding to the ease of engaging the PEV 510 with the lock-charge port 504. The same vertical play can be seen in the interface between the ramped bolts 534 and the opening in the side of the lock-charge port 504 forming a latch plate opening 582 that receives and retains the ramped bolts 534 to lock the nose connector 502 within the lock-charge port 504. The length of the latch plate opening is significantly longer than the distance separating the two ramped bolts 534.

When the nose connector 502 is inserted into the lock-charge port 504, the ramped bolts 534 are pushed inward along the sidewall of the lock-charge port 504 (not shown in FIGS. 26 and 27 due to location of cross section; see FIG. 22) and then spring out under the force of the spring 580 within the latch opening 582 for retention therein. At this point, in a matter of a single snap action, in less than a second, the PEV 510 is both locked within the lock-charge port 504 (due to the fact that the latch plate opening 582 ends right behind the ramped bolts 534 and the undrawn portion of the bolt plate 528 behind the ramped bolts 534 is solid material that keeps the ramped bolts 534 from exiting the latch plate opening 582) and is charging. The single solenoid 526 generally under control of the VAP 512 operates to unlatch both the cable lock mechanism 524 and the ramped bolts 534 holding the nose connector 502 within the lock-charge port 504.

The ramped bolts 534 are mounted on a bolt plate 528, as seen to good advantage in FIG. 26. A bolt sleeve 574 extends normally from an opposite side of the bolt plate 528 and houses an end of a plunger 572 protruding from the solenoid 526. A compression spring 580 is positioned around the exposed end of the plunger 572 between the bolt sleeve 574 and an end wall of the solenoid 526. The bolt sleeve 574 further defines opposing longitudinal channels 576 which are oriented along a vertical axis. The exposed end of the plunger 572 also defines a vertical borehole 593 aligned along the same vertical access as the sleeve channels 576. A transfer pin 570 seats within both the vertical borehole 593 and the sleeve channels 576.

In operation, when the nose connector 502 is inserted into the lock-charge port 504, the ramped bolts 534 are pushed inward and the bolt sleeve 574 pushes against the spring 580. Once the ramped bolts 534 clear the sidewall of the lock-charge port 504 and reach the latch opening 582, the spring 580 pushes against the bolt sleeve 574 which transfers the force to the bolt plate 528 to maintain the ramped bolts 534 within the latch opening 582. Note that the ramped bolts 534 are only held in place by the force of the spring 580 against the bolt sleeve 574 and solenoid end wall 595 and can be pushed inward with minimal effort, If the ramped bolts 534 were pushed inward, the bolt sleeve 574 would merely slide around the plunger 572 and the transfer pin 570 would slide freely in the sleeve channels 576. Upon release of pressure on the ramped bolts 534, they would return to the locked position in the latch opening 582. Notably, however, the plunger 572 would not be pushed inward, which would release the cable lock mechanism 524 as further described below,

When the solenoid 526 is actuated, the plunger 572 is pulled inward. The inward movement of the plunger 572 also pulls on the transfer pin 570, which further pulls the bolt sleeve 574 inward due to the interface between the transfer pin 570 and the sleeve channels 576. The bolt sleeve 574 thereby pulls the bolt plate 528 and the ramped bolts 534 inward to unlatch the nose connector 502 from the lock-charge port 504. The VAP may actuate the solenoid 526 for a certain period of time adequate enough for a user to remove the PEV 510 from the lock-charge port 504.

As shown in FIGS. 27-29, the solenoid 526 also unlocks the cable lock mechanism 524. The transfer pin 570 extends upward from the borehole 593 in the plunger 572 to engage a perpendicular wall 560 of a rack 561. The top portion of the transfer pin is housed in a well 568 in the perpendicular wall 560. The perpendicular wall 560 is biased against the inward movement of the plunger 572 by a rack spring 597 positioned between the perpendicular wall 560 and the cable lock mechanism 524. The perpendicular wall 560 interfaces with a parallel wall 562 of the rack 561 that slides along the back wall of the cable lock mechanism 524. As shown to good advantage in FIG. 28, the cable lock mechanism 524 defines a cable latch bore 594 within which the latch shaft 586 of the cable latch head 518 is inserted. The cable lock mechanism 524 further defines a tumbler shaft 564 in which a tumbler 566 resides. The tumbler shaft 564 partially intersects with the cable latch bore 584 to create a latch aperture 592 at the interface of the tumbler shaft 564 and cable latch bore 584. Within the latch aperture 592, a flat face 567 of the tumbler 564 engages and disengages an annular catch 598 in the latch shaft 586 depending upon the orientation of the tumbler 566.

The tumbler 566 has a flat, disk-shaped head 594 that rotates within a recess in the cable lock mechanism 524. One end of a translating pin 598 is positioned within a bore hole in the tumbler head 594 and the other end is positioned within a translating well 596 in the parallel wall 562 of the rack 561. As the parallel wall 562 of the rack 561 moves inward under the force of the solenoid 526 via the plunger 572 and the transfer pin 570, the translating pin 598 is pushed inward. However, because the translating pin 598 is also attached to the tumbler head 594, it must move in a rotational arc and thus moves downward in the translating well 596 while the tumbler 566 rotates its flat face 567 away from engagement with the annular catch 588 in the latch shaft 588. When the solenoid 524 relaxes, the rack spring 597 pushes the rack 561 outward moving the translating pin 598 upward in the translating well 596 while the tumbler 566 rotates its flat face 567 toward engagement with the annular catch 588 in the latch shaft 588 and thus locking the cable latch head 518 within the cable lock mechanism 524.

Note that through the action of the transfer pin 570 and a rack system, the actuation of the solenoid 526 unlocks both the cable lock mechanism 524 and the ramp bolts 534 simultaneously. However, the cable lock 516 will not be used at the same time that the PEV 510 is locked to the lock-charge port 504. In fact, the port shroud 506 prevents access to the self lock receiver opening 522. Similarly, when the cable lock 516 is being used, the lock-charge port 504 will not be engaged.

The purpose of the port shroud 506 is thus now clear. The port shroud 506 protects against miscreants that might want to unlock the PEV 510 by pushing the ramped bolts 534 inward. The opening in the port shroud 506 provides a close fit with the housing of the lock-charge port 504 and prevents access to the ramped bolts 534. Note that when the nose connector 502 is not docked within the lock-charge port 504, the ramped bolts 534 are exposed in openings in the housing 503 as seen in FIG. 24. If the ramped bolts 534 were pushed inward and the bolt sleeve 574 was able to push against the plunger 572 or the transfer pin, the tumbler 566 would turn and release the cable head 518 from the cable lock mechanism. If a user were to use the Self-Lock feature with the cable lock 516 the cable lock mechanism 524 should not be able to be defeated by merely pushing the ramped bolts 534 inward. This is why the ramped bolts 534 are divorced from the transfer pin 570 and plunger 572 unless the plunger 572 is actuated.

In this implementation, the locking mechanism is in the nose connector 502 attached to the PEV 510. The only services provide by the lock-charge port 504 are electricity, monitoring in place, and an interface to receive the ramped bolts 534 and thereby provide a locking interface. Although wired data communications could be performed through the lock-charge system 500 in any of the ways previously described in this document, in this implementation data communications are wireless and handled by the VAP 512.

### Reservations, Balance of System

The ability to reserve a PEV to meet a user's local mobility needs greatly increases the usefulness of a PEV rental system. Once a user has easy access to convenient reliable local mobility solutions the user's modes of transportation may change with less reliance on single-occupancy, privately-owned automobiles to more dependence on rapid transit modes supplemented by PEVs providing mobility for the last few miles of the trip. In order for the user to commit to a bus ride downtown, the user will need to know there is an effective mode of transportation once off the bus. The user may log into the PEV rental system website from a desktop computer or an Internet enabled cell phone and review the number of PEVs available for rent at each kiosk in the system. This level of insight provides the user with some idea of how necessary it may be to reserve a PEV for the intended trip. If it appears the supply of available PEVs could be problematic, the user may reserve a PEV for a minimal fee to ensure that a PEV is available when the user arrives. Using an Internet enabled cell phone, a user may monitor the availability of PEVs in the region and also decide at the last moment to get off the bus a stop earlier or later due to the availability of PEVs at a given bus stop. This level of visibility into the resources available empowers the user to make smart decisions based upon the ability to sift through the huge amount of data made available through the information age. By setting up systems that can provide this level of information in a usable format, the user is more able and willing to take alternative forms of transportation that will ultimately reduce the cost of traveling to a given location.

### Locating Electric Fleet Vehicles Within Their Operational Environment

PEVs are unique in the fact that they require battery charging. If the battery is to physically remain within the PEV, time must be allotted to allow the batteries to charge. Since a PEV must remain connected to a lock-charge port while charging, the PEV is effectively unavailable for use until sufficiently charged. This time period required to charge a PEV's batteries can be costly as the charging PEV is not available to service the needs of the fleet until its battery is known to have sufficient energy content to complete the user's intended trip.

Typical PEV fleets provide at least one lock-charge port for each PEV in the fleet. Any PEV can be charged in any available lock-charge port. Lock-charge ports may have the ability to monitor the amount of electrical power, or charging current, going into the PEV's battery system. The magnitude of the charging current may be relayed from each lock-charge port to the EVMS central computer using either a wired or wireless communication link. Because of the static nature of the lock-charge port infrastructure and the dynamic positioning of fleet PEVs being charged at each port, there needs to be some method to determine which fleet PEV is located in each lock-charge port.

### Identifying a Vehicle in a Particular Lock-Charge Port

The EVMS central computer may assign each PEV a unique electronic identification number. That electronic identification number may be held in an electronic touch sensor, an optically read bar code, a radio frequency identification (RFID) fob or any other identification device capable of holding a unique PEV identification number that can be interpreted by a corresponding reader. Any one of these identification number holding devices may be applied utilizing an electronic touch sensor, but other identification number holding devices could also prove equally useful. The electronic touch sensor may be attached to a key ring that also holds the activation key for the PEV or the touch sensor could itself be the activation key. The key ring could also hold a PEV identification tag to remind the user which PEV the key ring corresponds to. Upon PEV checkout the user would be issued the key ring associated with the PEV to be used during the trip. After receiving the key ring, the user locates the corresponding PEV in the port, unplugs the PEV, and uses the activation device to activate the PEV.

Upon PEV return the user may park the PEV near an available lock-charge port and turn the PEV off. The user may then plug the PEV into the charging port. After plugging the returned PEV's power plug into the charging port, the user may then be instructed to present their touch sensor to a touch sensor reader at the charging port. This may allow the lock-charge port to read the unique PEV identification number of the PEV that has just been plugged into the lock-charge port. The lock-charge port could then relay the electronic identification number to the EVMS central computer either through a wired or wireless data communication link. This allows the user to return the electric PEV to any available lock-charge port and the EVMS central computer could know which PEV is plugged into which port. The EVMS central computer could then monitor the power going into the PEV by monitoring the power passing through its corresponding stationary lock-charge port.

Alternatively, the PEV may store the unique identification number in nonvolatile memory in the VAP. Upon connection with a charging port, the VAP may communicate the identification number to the kiosk or EVMS through a wired data connection with the charging port or wirelessly to the kiosk through a communication gateway to the EVMS central computer.

Identifying Vehicle in Particular Lock-charge port Utilizing Wireless Communication Link

It may be necessary to locate which charging port 618 a particular PEV 602 is plugged into for reasons of fleet auditing, vehicle maintenance, system balancing, battery charging, monitoring, or any other PEV or system related need. When a wireless communication link is utilized to relay information to and from a PEV 602 and an EVMS computer 610, there may or may not be an ability to identify which particular charging port the PEV 602 is plugged into. In one implementation, to facilitate the ability to locate which PEV is plugged into a particular charging port 624 at the charging station 618, the EVMS computer 610 via the wired or wireless communication link between the EVMS computer 610 and each charging port 624 may temporarily halt grid power from passing through the charging port 624 in question. The PEV 602 plugged into the charging port 618 where grid power was removed would then experience a loss of battery charging power. If each PEV 602 in the fleet is capable of monitoring its own battery charging current or battery voltage and can communicate the loss of grid power and PEV identification information through the PEV's wireless communication link to the kiosk 622, the kiosk 622 may then relay the loss of grid power and PEV identification information to the EVMS central computer 610 where it can be easily deduced which PEV 602 has lost its grid power.

Since the EVMS central computer 610 knows which charging port 624 had its grid power halted and the management system also receives information about which PEV 602 has experienced an interruption in grid power it is possible to identify which PEV 602 is plugged into which charging port 624. After the PEV alerts the management system central computer 610 via the wireless communication link that the power was unexpectedly halted, the charging port's power to the PEV may be turned back on via the communication link between the EVMS central computer 610 and the charging port. The PEV 602 may then report that grid power had been reapplied via the wireless PEV to management system central computer communication link and then the kiosk 622 may report to the EVMS central computer 610 that power had been reapplied providing a second verification of the PEV's presence at the charging port 624. This procedure may be repeated for each charging port 624 periodically to audit the PEVs located at each charging port 624 in the EVMS.

Charging ports 624 may be equipped to monitor and report to the EVMS central computer 610 the amount of grid power passing through the charging port's power outlet. It is then possible for the EVMS central computer 610 to detect when a PEV has been recently plugged into a particular charging port 624. The EVMS central computer 610 may then use PEV identification information passed over the wireless link between the newly plugged in PEV 602 and kiosk 622 which could then be passed from the kiosk 622 to the EVMS central computer 610 to reveal PEV identification information regarding a PEV 602 that is reporting being recently plugged into a charging port 624. With the lock-charge port's grid power consumption information and the PEV information both received by the EVMS central computer at approximately the same time, it is possible to positively identify the newly plugged in PEV 602 and the charging port 624 it is plugged into. This approach has the advantage that grid power used to charge the PEV's battery would not have to be removed to identify the PEV 602 being plugged into the charging port 624. This approach has the disadvantage that if multiple PEVs 602 are plugged into the system almost instantaneously, it might not be possible to positively identify which PEV 602 was plugged into which charging port 624. In this case, the technique of halting grid power to each charging port 624 in question could be used to positively identify which PEV 602 was plugged into each charging port 624.

In an alternate implementation to determine which charging port a particular PEV 602 is plugged into, the PEV 602 may be equipped with the ability to interrupt the power used to charge the PEV's battery. This ability to halt the incoming power to the PEV's battery may be initiated by the EVMS central computer 610 via the PEV's wireless link. Once the PEV's battery charging power has been halted, it may be possible for the EVMS central computer 610 to query the all the charging ports 624 in a given collection of charging ports 624 regarding the current passing through each charging port's electrical outlet. The charging port 624 that suddenly shows an interruption in charging current coinciding with the PEV 602 halting the power to its batteries could then be suspected of supplying electric power to the PEV 602 that was requested to stop charging its batteries. The charging power passing through the charging port 624 may then be monitored while the PEV is instructed to resume supplying power to its batteries via the wireless link between the PEV 602 and the EVMS central computer 610. If power starts passing through the charging port 624 at the same time as it is allowed to pass to the electric PEV's batteries, the EVMS central computer 610 would be able to correlate these two events and positively identify which charging port 624 a particular PEV is plugged into.

The above techniques describe stopping and starting the flow of power to the PEV's battery. Any other detectable method of communicating over the grid power wires and/or the ground wire may also be used to identify which PEV 602 is plugged into which charging port 624 or visa versa. For example, the EVMS central computer 610 may control a high frequency signal which could be injected onto the grid power lines between a particular charging port 624 and a PEV 602 plugged into the charging port 624. If this high frequency signal is detectable by the PEV 602 and the PEV 602 is able to communicate over the wireless communication link to the EVMS computer 610 regarding the presence or absence of the high frequency signal received over the grid power lines, this information may then be relayed to the EVMS central computer 610 and the charging port 624 which a particular PEV is plugged into may be positively identified by the EVMS central computer 610. Alternatively, the EVMS central computer 610 may request that the PEV inject the high frequency signal over the grid power lines between the PEV 602 and the charging port 624. The charging port 624 may be equipped to detect and report the presence or absence of the high frequency signal to the EVMS central computer 610 enabling positive identification of which PEV was plugged into a particular charging port 624. Although turning off the power is one implementation, there are numerous methods for communicating over the grid power lines to the PEV 602 including injecting high frequency signals into the grid power lines; passing time multiplexed data signals over the grid power lines; passing pulse width modulated signals over the grid power lines; detecting voltage spikes or dips with durations short enough to be disregarded by the battery charging circuitry, but with sufficiently long durations to be detected by digital signal processing circuitry connected to the grid power lines through filtering circuitry; and any other technique that would allow communication to occur between the charging ports 624 and the PEVs 602 plugged into these charging ports 624. There are many other possibilities available to communicate over grid power lines, but the examples above are meant to provide a sample of the communication possibilities between the charging port 624 and the PEV 602 plugged into the charging port and how all those examples still rely upon communicating over the power lines to prompt the PEV 602 or charging port 624 to report its detection of the information over the grid power lines.

### Estimating Electric Vehicle Battery State of Charge

The lock-charge port may be configured to measure the current going into the PEV that is plugged into the lock-charge port. The lock-charge port may then report the charging current to the EVMS central computer. The measured power going into the PEV can be used to roughly predict the state of charge of the PEV as most battery charging systems taper their power consumption towards the end of the charging cycle (near 80-90% state of charge). This tapering off of the battery charging power can be used as one method of determining a PEV's battery state of charge. During rush periods, an 80% state of charge would be sufficient to allow the PEV to be rented. During slow periods when there are plenty of fully charged PEVs, the EVMS central computer may require a PEV to be over 95% charged as indicated by the battery charging current before it is available for rent. This approach works well when the typical trip distances are known to consume a good portion of the PEV's battery capacity and the battery charging time is relatively short. When the charging time is measured in hours, the PEV may be unavailable for long periods of time before the charging current begins to taper off. If a typical PEV user wants to use a PEV for a short trip there may be plenty of stored energy in a slowly charging PEV's batteries to complete the user's intended trip. But if the PEV must remain unavailable until the charging current taper is encountered, the management system's PEV utilization will be unacceptably low.

To improve the electric PEV's utilization in a fleet environment it is useful to be able to estimate the PEV's battery state of charge more dynamically. Integration of the power input into the PEV's battery over time determines how much energy the PEV has received. Since the charging current and charging time are known for each PEV in each charging port, it is a fairly straightforward algorithm for the EVMS central computer to accurately estimate the increase of each PEV's battery state of charge for the entire fleet in real time. The real challenge in estimating a fleet of PEV's battery state of charge involves quantifying the amount of energy used during PEV operation. Once a PEV is returned from an hour long trip it is imperative to determine whether the PEV was driven for ten minutes, sat for forty minutes, and then returned after 10 more minutes of driving or was the PEV driven the entire hour. Because PEV usage occurs away form the charging ports, some way of evaluating the trip's impact on the electric PEV's battery state of charge must be implemented.

Estimation of an electric PEV's battery state of charge under variable load conditions has always been an imprecise procedure since there is no fluid fuel level or fuel volume to be easily monitored. Different methods have been implemented with varying levels of accuracy and cost of implementation. One method of estimating the electric PEV's battery state of charge during PEV usage is to monitor the battery voltage during certain operational periods of the PEV. These systems are known and prove to be reasonably accurate although the state of charge estimation algorithm is dependent upon the type of battery technology used.

The problem with using direct electrical measurements to estimate the state of charge of an electric PEV's battery is that the estimation hardware and data reside in the PEV and must be somehow transferred to the EVMS central computer. The need to communicate estimated state of charge information to the electric PEV's central computer typically results in the installation of some sort of computerized interface, or black box, connected to the battery measurement hardware. This black box could obtain the electric PEV's operational data, such as the PEV battery's state of charge, and could then communicate the data wirelessly to the EVMS central computer. For automotive sized electric vehicle applications the expense of the black box and its costs are minimal compared to the initial vehicle cost. When managing smaller low-cost neighborhood electric vehicles, e.g., scooters or electric pedal bikes, the cost of the black box and its integration into the PEV can be cost prohibitive making it economically infeasible to offer small PEVs to meet local mobility needs. In addition to this cost barrier, many of these smaller PEVs are unable to physically house a commercially available computerized black box within the PEV chassis.

### Using GPS to Estimate an Electric Vehicle Battery State of Charge

An electric PEV's battery state of charge can be estimated by monitoring the PEV's physical movements during PEV operation. Global positioning systems integrated to a mobile phone are commercially available. The small size of these mobile phones makes it possible to install a mobile phone with a GPS chip into each small electric PEV. The mobile phone may be programmed to periodically communicate wirelessly to a nearby cell tower. The cell tower may then transfer the PEV's current GPS coordinate information to a server via standard phone landlines. The server may record the physical location of the mobile phone, and consequently the electric PEV over time. This would allow the EVMS central computer the ability to access a returned PEV's movement data for the entire trip by accessing the server that has compiled the mobile phone movement data.

The movement data could then be used by the EVMS central computer to estimate the amount of energy depleted from the PEV's batteries during its trip. Terrain data could be included in the state of charge estimation if major hills and/or high rolling resistance ground surfaces were known to be a significant drain on the PEV's battery capacity. This data may also be compiled with temperature data to enhance the state of charge estimation model assuming the PEV's battery temperature is close to the outside ambient air temperature. Additionally, the EVMS central computer may also take into consideration the age of the PEV's batteries to enhance the state of charge prediction algorithm. Although not a direct measurement of the current discharging from the PEV's batteries, there is a range a PEV is capable of traveling before completely depleting the energy in a fully charged PEV. For example, if forty percent of the anticipated range were traveled during a trip, it would be reasonable to allow the PEV to perform a second trip of the same or lesser duration immediately upon return for the initial trip. Or if a longer trip was requested, it would be known that the PEV with a sixty percent state of chare would not be able to confidently complete the requested trip.

### Using Wireless Communication to Estimate an Electric Vehicle's Battery State of Charge

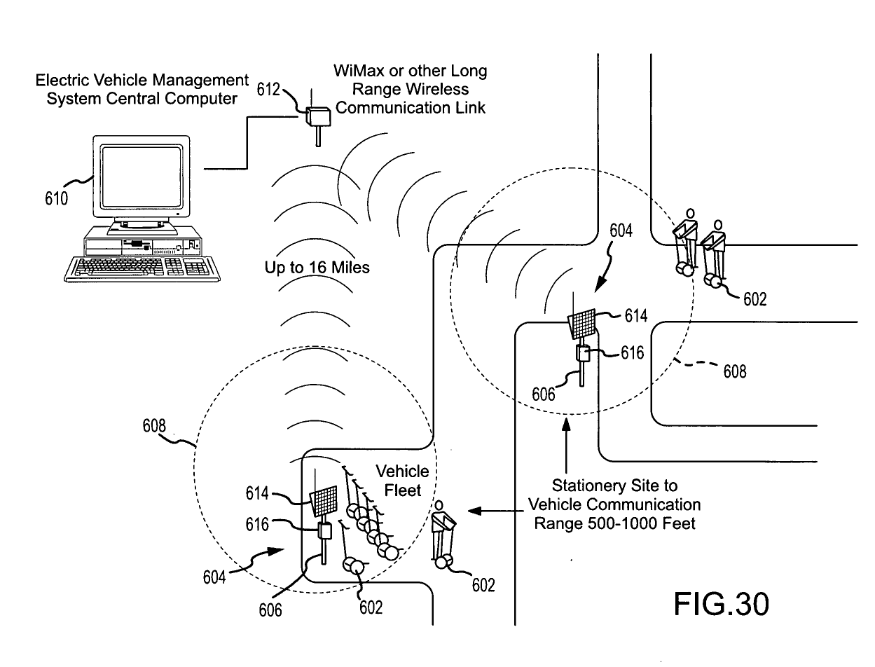

WiFi, WiMax, General Mobile Radio Service (GMRS) wireless transceivers, or any other wireless means of communicating between a mobile PEV and a stationary communication site may be used to monitor the location of an electric PEV operating within the fleet's operational environment. One exemplary implementation of a battery charge estimation system 600 is depicted in FIG. 30 uses the 900 Mhz electromagnetic spectrum used by cordless phones, however, any other available radio band or any other suitable segment of the electromagnet spectrum could be used to support wireless communication between a mobile platform and a stationary site. By performing time, code, or frequency division multiplexing of the digital radio data, a multitude of other wireless communication applications may also utilize the wireless communication system that the EVMS uses to monitor PEV trip distance and estimate PEV battery state of charge.

A mobile wireless transceiver (not shown) may be mounted onto each fleet electric PEV 602 and configured to communicate as a slave over a wireless network. Each stationary site 604 could be equipped with a similar wireless transceiver 606 configured to communicate as a master within the limited geographical range 608 of the stationary site 604, limited by the radio transmission output power of the stationary site. Each mobile transceiver could communicate with a stationary master in a time, frequency, or code divisional-shared manner when the PEV and stationary site 604 are somewhat nearby each other. The method of sharing the limited radio band could be time, code, or frequency divided depending on the radio communication protocol used. By strategically placing stationary sites 604 close enough together that a sufficient portion of the PEV's operational environment is capable of communicating with the PEV, it may be possible to determine approximate locations of all the PEVs 602 in the fleet in real time. The placement of the stationary sites 604 may, but does not need to, provide a continuous communication link between the PEV 602 and the stationary sites. Stationary sites 604 may be positioned at common intersections, charging ports, and popular destinations minimizing the number of stationary sites 604 needed to facilitate an effective PEV monitoring wireless network.

When a PEV 602 enters into the communication range of a stationary site 604 the PEV's wireless mobile communication system may communicate the PEV's identification information to the stationary site 604. The stationary site 604 may then add stationary site identification information to form a digital data transmittal packet that could be relayed to the EVMS central computer 610. An exemplary message might convey information like the following: PEV 1234 entered into stationary site 7B′s communication range at 09:24 on Dec. 15, 2007. This information may be sent by way of either the Internet, standard telephone landlines, cell phone service, long range WiMax, standalone wired communication link, or any other means or network that could facilitate the information transfer between stationary sites and the EVMS central computer 610. Long range WiMax 612 shown in FIG. 30 is one implementation to transfer PEV identification and location information from stationary sites 604 to the EVMS central computer 610 but any other communication protocol or electromagnetic spectrum could be used to support communication between stationary sites 604 and the EVMS central computer 610.

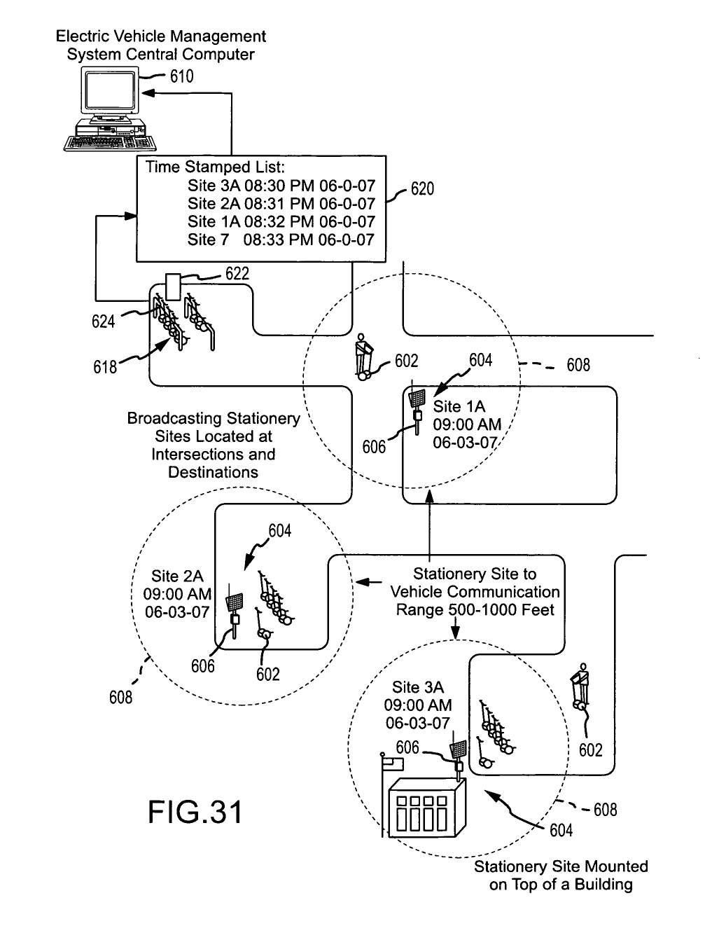

In an alternative embodiment depicted in FIG. 31, the EVMS central computer 610 may compile the list of stationary sites 604 that a given PEV 602 passes by during the PEV's trip. The distances between stationary sites 604 may be programmed into the EVMS central computer 610 making it possible to estimate the PEV's total trip distance from a list of the stationary sites 604 that a given PEV 602 passes during its trip. Distance traveled during a trip may then be translated into an estimated reduction in the PEV battery's state of charge. Terrain data may be included in the state of charge estimation if major hills and/or high rolling resistance ground surfaces were known to be a significant drain on the PEV's battery capacity. Battery age and ambient temperature may also be included in the algorithm used to estimate a PEV's state of charge. The time taken to go from one stationary site 604 to the next would give some indication of the speed the PEV 602 traveled during the trip further defining how hard the PEV 602 was used. Periodic updates of the current time may be transmitted from the EVMS central computer system 610 to each stationary site 604 via a wired or wireless link. An alternative method of keeping an accurate source of time in a stationary site 604 would be to include a low cost GPS receiver in each stationary site 604 that could read the current GPS satellite signals and interpret them into current local time to be included in the stationary site transmissions. Other ways of providing an accurate time reference could alternatively be integrated into the stationary site 604.

Electric power to the PEV's mobile communication system could remain on even when the PEV 602 is turned off. PEVs 602 that remain within a stationary site's wireless communication range 608 may continue to announce their presence to the stationary site 604. Once a PEV 602 has been continually inside a stationary site's communication range 608 for a pre-determined time, the PEV 602 may be considered parked or inactive. This adds an additional level of information about the impact of the PEV's trip on the PEV's state of charge. If it is known that a PEV 602 remains in a stationary site for some time and it can be assumed that the PEV 602 was probably parked or inactive near the stationary site 604, then the state of charge for that PEV 602 can be reduced less severely than if it is known that the PEV 602 was traveling for some time between stationary sites. When the PEV is no longer communicating to a given stationary site it may be assumed that the PEV 602 left the communication rage 608 of the stationary site 604.

The currently described embodiment may suffer from a high parasitic battery drain because of the wireless communication taking place while the PEV 602 is turned off within the communication boundary 608 the stationary site 604 for possibly a long period of time. In view of this concern, electric power to a PEV's mobile communication system may be designed to turn off when the PEV 602 is turned off making it difficult for the EVMS 610 to determine whether a PEV 602 was turned off within the stationary site 604 or that the PEV 602 just passed through the stationary site 604 before choosing a trip route that avoided any additional communication with a stationary site 604. This situation could be especially challenging at stationary sites 604 on the edge of the PEV's operational environment where the user could either drive the PEV 602 long distances without communicating with another stationary site 604 or the user could park the PEV 602 at the site with no difference in the information being received by the EVMS computer 610.

In the above descriptions the PEV mobile communication system needs a source of electric power and knowledge of the PEV's unique identification information so the PEV's unique identification information can be transmitted to a nearby stationary site 604. The PEV's mobile communication system could be further integrated into the PEV 602, for example, in the VAP, to allow the monitoring of any aspect of the PEV's operational parameters from battery voltage, battery current, speed, on/off state, estimated battery state of charge, grid power current, signals injected over the grid power lines, or any other operational parameter that could be useful. The PEV mobile communication system 600 may provide the measured operational information in real time over to the EVMS central computer 610. For example, if information regarding the PEV's on/off state was made available to the PEV's wireless communication link, the PEV could report being turned off to the stationary site 604 adding further information about the PEV's trip impact on the PEV's battery state of charge. Once the PEV's off state was successfully communicated via the PEV's wireless link to the stationary site 604 and then passed on to the EVMS central computer 610, the PEV's mobile communication system could be shut down to preserve battery power and turned back on when the PEV 602 is repowered. The added cost of integrating the mobile communication system further into the PEV's operational parameters would be traded off with the benefit provided by having more information about the PEV's operational status during a trip.

### Wireless Stationary Communication Sites

Installing entirely wireless stationary sites 604 within the PEV's operational environment could minimize the overall cost of the infrastructure required to support the wireless communication system 600. A combination of a pole mounted solar panel 614 and a stationary storage battery 616 along with short and long range wireless communication equipment shown in FIG. 30 may be installed in locations where there is no available grid power or wired communication link to support the needs of a stationary site 604. In one implementation, the communication link between the entirely wireless stationary sites 604 and PEVs 602 may use segments of the 900 Mhz electromagnetic spectrum and could be used to transmit PEV identification and possibly other operational PEV data to an entirely wireless stationary site 604. The entirely wireless stationary site 604 may be able to receive PEV data from the PEV 602 by using energy stored in the stationary electrical storage battery 616 mounted on or near the pole holding up the solar panel 614 of the entirely wireless stationary site 604. The stationary storage battery 616 may be charged during the day by the pole-mounted solar panel 614. The relatively small amount of energy needed by the low wattage radio communications and the relatively infrequent transmission sessions would enable a relatively small solar panel 614 be used to keep the relatively small storage battery 616 sufficiently charged.

Once the entirely wireless stationary site 604 wirelessly receives the PEV's information, it may then retransmit that information to the EVMS central computer 610 by a long range wireless communication link 612, such as WiMax, directly to a central receiver located at or near the EVMS central computer 610. Alternatively, a wireless communication link may be used to relay the PEV's information to a nearby stationary site 604 that has either a telephone landline, an Internet connection, an Intranet connection or some other communication or network connection that could relay the PEV information to the EVMS computer 610. In another implementation, a peer to peer communication network could be utilized to pass information wirelessly over multiple wireless “hops” from stationary site 604 to stationary site 604 leading towards the EVMS central computer 610. Some stationary sites could be situated where Internet, Intranet, grid power, landline telephone service, or other communication network capable of relaying the PEV information to the EVMS computer 610. These existing communication/power facilities may be utilized or a longer range, wireless link, such as WiMax could be used. It should be noted that the communication system used by the EVMS does not need to be solely dedicated to supporting the EVMS. By performing time, frequency, or code division multiplexing of the digital radio data, a multitude of other applications could also utilize the communication system that the EVMS is utilizing to track PEV usage and estimate PEV battery state of charge. The communication needs of the EVMS are so minimal that an existing WiMax, WiFi, or other wireless communication system could handle the needs of the EVMS system 600 without significantly burdening the existing communication system.

### Broadcasting Stationary Sites

In another implementation as shown in FIG. 31, each stationary site 604 may have a low wattage wireless transmitter capable 606 of transmitting the stationary site's unique identification information to PEVs 602 passing nearby the stationary site 604. A wireless receiver could be mounted to each PEV 602 in the fleet capable of receiving the information transmitted by the nearby stationary site 604. As a PEV 602 passes by each stationary site 604 the PEV 602 could store the stationary site's unique identification information and form a list of all the stationary sites passed by during its trip. The information communicated from the stationary site 604 to each passing PEV 602 may also include date and time of day data allowing the PEV 602 to record when the PEV 602 passed by each stationary site 604. Accurate time of day information may be derived from GPS satellite information interpreted via a low cost GPS based clock within the stationary site 604. Alternatively, atomic clock time references broadcast across most of the globe's continents using extremely low frequency radio waves may be received and interpreted by each stationary site 604 to provide a reliable distributed time reference ensuring that the time stamped data utilized the same time reference at each stationary site 604. Many alternative ways of accurately determining and distributing the time of day can be implemented. The above examples are only meant to demonstrate more then one method that time can be accurately measured and distributed across a distributed wireless network.

When the PEV 602 is returned to a charging station 618 at the end of its trip, the PEV 602 could then provide a time stamped list 620 of the stationary sites 604 that the PEV 602 passed by during its trip using either a wired or wireless communication link. Time stamped PEV on/off data may also be included in the time stamped list 620 if the PEV's mobile communication system has been integrated into the PEV 602 sufficiently to provide PEV on/off state information to the PEV's mobile communication system. A PEV 602 turned off within the transmission range of a stationary site 604 may record the time it is turned off and the time it is turned back on. The PEV 602 could then listen to the stationary site's wireless broadcast through the PEV's mobile communication system to determine when the PEV 602 was turned back on providing the PEV 602 an ability to document non-usage periods in the time stamped list 620. Alternatively a low power real time clock could be implemented in the PEV 602 to monitor the amount of time the PEV 602 is in the off state when it is not within the communication range of a stationary site. A running count of the seconds that the PEV 602 was turned off during the duration of the trip may be stored in the PEV's memory and transmitted to the EVMS central computer 610 upon PEV return, which could be useful in predicting how much a PEV's battery state of charge was affected by the recently completed trip. The kiosk computer at the charging station 618 could then relay the time stamped list 620 including the off time duration to the EVMS central computer 610 using a wired or wireless communication link. Alternatively, the kiosk computer at the charging port may use the time stamped list to perform its own estimated state of charge calculations for the returned PEV 602.

In this implementation the long-range wireless communication link between the stationary sites and the central computer 610 could be eliminated by relying upon the PEV's ability to remember trip information and the ability to communicate that information in the form of a time stamped list 620 to a central computer 610 capable of processing the time stamped list 620 and estimating the trip's impact on the PEV battery's state of charge. An added benefit of the stationary site providing only short range wireless communication to PEVs passing nearby is the relative simplicity of the information broadcast by each stationary site, i.e., only the stationary site's identification number and time of day needs to be broadcast. The period between broadcasts may be based upon the geographically size of the stationary site's communication range and the speed of the PEVs 602 being monitored. At a minimum a PEV 602 could receive at least one transmission from the stationary site 604 in the amount of time it would take for the PEV 602 to travel through the stationary site's communication range at top speed. More frequent broadcasts by the stationary site 604 during the PEV's top speed travel time across the stationary site's communication range could ensure a more reliable time stamped list 620 of the PEV's travels. Because the stationary site's electrical power requirements would be known due to the stationary site's relatively static operational behavior, it would be possible to accurately predict its electrical power requirements. This making it possible to design an appropriate sized photovoltaic panel and electric storage battery to power the stationary site 604 throughout the day and night. It may be noted that the short range communications between the stationary sites 604 and the PEV's 602 would not provide real time information regarding the PEV's current location within the operational environment.

### Global Shared Vehicle System

In the various implementations of a shared vehicle system as described herein, a subscriber can query the location of the closest vehicle to his or her location (e.g., via a wireless PDA which may have GPS features). The vehicle may then be acquired for use, for example, through a rental arrangement and, when the subscriber is finished with the use, he or she can generally return the vehicle at either a prearranged location or a location operated by the shared vehicle management system. However, it may be appreciated that the PEV can potentially inform the management system of its location and status from any location. With such a system, vehicles available for sharing can be located individually or in clusters (e.g., at rental centers or stations), and can be located anywhere on the earth where communications links and location information is available.

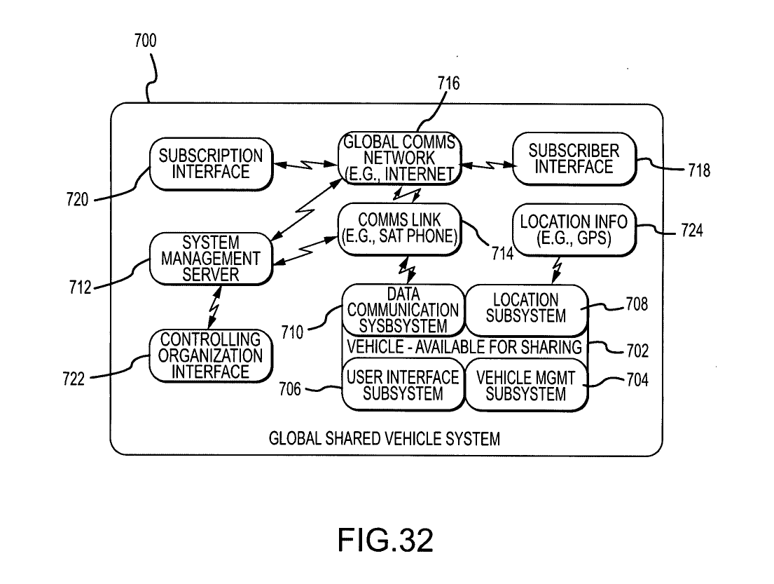

A schematic diagram of an exemplary implementation of a global shared vehicle system is depicted in FIG. 32. The primary component of the system 700 is vehicles 702 equipped, as needed, with operational subsystems such as those described below. The vehicles 702 can be of any type including automobiles (electric or conventional), bicycles (with either disposable batteries or rechargeable batteries to power a VAP, or with a wheel mounted dynamo energy source and/or external energy source), electric bicycles, electric scooters, Neighborhood Electric Vehicles (NEVs), or virtually any other vehicle type.

The vehicles 702 may be equipped with a vehicle management subsystem 704 which handles details required for vehicle operation and monitoring. These operations may include, but are not limited to, odometer and distance traveled monitoring; electric storage of system status; control of electric vehicle locomotion; electric energy storage system status and controls for the vehicle electronics package, accessory interface, monitoring, and data storage; tire pressure monitoring; or other functions as may be needed for proper vehicle operation and maintenance. Such monitoring may also include security sensors and algorithms to determine if the vehicle 702 is being moved without authorization and to take action such as sounding alarms and initiating a “plea for help” through the communications subsystem.

The vehicles 702 may also be equipped with a user interface subsystem 706 which allows the user to acquire use of the vehicle (e.g., rent the vehicle) by using a user identification apparatus, such as an electronic key, an RF ID chip, a magnetic strip card, a bar code, or via entry of codes or information using a keypad or similar input device. The user interface subsystem 706 may include a display or other means to communicate information to the user regarding status of the vehicle 702 or instruction prompts. Such indications may include, but are not limited to “Ready to Rent within N Miles Range,” “Charging,” “Reserved,” “Enter Your ID Code,” “Enter Your PIN,” or similar information. The display may also present information regarding the current location of the vehicle 702 (e.g., from the location subsystem, such as through GPS information), directions or information to guide the user to a desired location, or information that may be of interest to the user regarding nearby points of interest such as restaurants, shops, museums, businesses, public services, and so forth.

The vehicles 702 may further be equipped with a location subsystem 708 which obtains and provides information regarding the geographic location (e.g., latitude and longitude) of the vehicle. The location subsystem 708 may include information about past locations as well as the current location of the vehicle 702. The location subsystem 706 may also include information about current heading (e.g., magnetic or otherwise). Location information 724 may be queried from a GPS receiver or a similar ground location system, and may be augmented by “dead reckoning” calculations from a previously known position to determine a current position. Location may also be determined from other sources such as local transmitters or transceivers (e.g., cell phone towers) which, through triangulation or other methods, may assist in providing location information.

The vehicles 702 may also be equipped with a data communication subsystem 710 that provides a data link from the vehicle 702 to other points of communication, primarily, but not limited to, the system management server 718 or subsystems thereof. Data communications may be accomplished over a variety of network connections, including wireless networks. Wireless communications may include direct communications to earth orbiting satellites (i.e., “sat phone” communications), wireless phone and data services such as GSM or CDMA or any other form of wireless communication that may be available and useable. Data communications may be used for a variety of purposes including, but not limited to, providing subscriber information transfer to authorize the beginning of a vehicle use (i.e., start a rental period); to end the vehicle use (i.e., terminate the rental period); to report vehicle status (e.g., position, speed, maintenance needs, etc.); to transfer useful information (e.g., geographically pertinent information regarding local businesses, attractions, etc.), or report meaningful incidents (e.g., theft, power outage from electrical charging source, etc.). The data communication subsystem 710 may also be used to download new software or firmware to update or upgrade the systems within the vehicles 702.

Additional systems and services outside the vehicles 702 may be used to implement such a global shared vehicle management system 700. A system management server 712 may be a single computer system or a network of systems of data management equipment that receives, stores, processes, and reports information and interactions regarding subscribers, vehicles, accounts, maintenance, and all aspects of organization and operations of the global shared vehicle system 700. The network of systems may include kiosk computers, special purpose computers, or servers or similar data management equipment located locally near vehicles to support local rental or other shared vehicle operations.

A communication link 714 may connect the data communication subsystem 710 within the vehicle 702 to the system management server 712, either directly or through another communications network (e.g., the Internet). The communication link 714 may be wired or wireless, and may include satellite link or other wireless infrastructure links, for example, GMS or CDMA data/phone systems, or any other wireless data link that may be available and useable.

The data communication subsystem 710 and communications link may additionally interface with a global communication network 716, for example, the Internet. Such a global communication network may be used instead of or in addition to a private or closed local or wide area network connecting between the data communications subsystem 710 in the vehicle and the system management server 172 or other components or users of the global shared vehicle system 700.

A subscriber interface component 718 may be provided for the subscriber (i.e., customer, user) to interact with the shared vehicle system 700 to obtain information about shared vehicle availability, location, status, or other activities; to reserve, rent, or cancel reservation of a vehicle; and to conduct any number of typical subscriber-business interactions (e.g., billing, updating account information, etc.). The subscriber interface component 718 may be implemented in web browser program on a computer terminal connected to the Internet, a wireless PDA carried by the user, or any other interface device capable of making the connection with the system management server 712 over the communication link 714. In the case of a wireless PDA device, the user may query the global shared vehicle system 700 regarding proximity of closest available vehicles 702 and hold or reserve a vehicle for his or her use, as well as other related interactions.

A subscription interface component 720 may also be provided to allow a new user to create an account and become a subscriber (i.e., customer, user). The subscription interface component 720 may be implemented in web browser program on a computer terminal connected to the Internet for interactions typical of such business subscriptions (e.g., entering and verification of personal and credit or other financial information), or a custom kiosk provided by the shared vehicle system provider or its agent or contractor. The subscription interface component 720 may be any such data communications device or system that can facilitate such interactions.

A controlling organization interface component 722 may be implemented as part of the global shared vehicle system 700 to provide data interaction and interface to and from the company or agent of the company or other organization responsible for the operation of the system 700. Such an interface component 722 may include computer terminals, data storage devices, and any other such equipment to facilitate transfer of data, information and/or instructions to the system management server 712. Such interface equipment may be centralized at the headquarters of the controlling organization, or may include distributed interface equipment at satellite facilities of the controlling organization or agents thereof. Communication between the controlling organization interface component 722 and the system management server 712 may be direct, e.g., through a local area network, or may be distributed, e.g., using the communication link 714 or the Internet 716.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing an encoded computer program executable by a computer system. Another implementation of a computer program product may be provided in a computer data signal embodied in a carrier wave by a computing system and encoding the computer program. Other implementations are also described and recited herein.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A shared vehicle system comprising
a plurality of vehicles each having
a user interface configured to receive identification and authorization from a subscriber;
a vehicle management subsystem configured to monitor an operational state of the vehicle;
a data communications subsystem configured to access a communication network to transmit and receive data to and from the vehicle;
a system management server configured to manage location, assignment, and operational state data concerning the plurality of vehicles and further comprising
a communications link that communicates with each of the plurality of vehicles over the communication network;
a user interface that allows a user to subscribe to the system to access use of the vehicles.

2. The system of claim 1 further comprising a location subsystem configured to determine a geospatial location of the vehicle;

3. The system of claim 2, wherein the communications and location subsystems are global in nature, creating a global shared vehicle system accessible by any subscriber with access to the global communications network

4. The system of claim 3, wherein the vehicles may be individually dispersed.

5. The system of claim 1, wherein the vehicles are collocated at stations.

6. The system of claim 1, wherein the user interface further comprises a subscription interface configured to create a subscription account for a new subscriber to access and operate any of the plurality of vehicles.

7. A vehicle for use in a global shared vehicle system comprising
a user interface subsystem configured to receive identification and authorization from a subscriber;
a location subsystem configured to determine a geospatial location of the vehicle;
a data communication subsystem configured to provide a communication link to transmit the subscriber identification and authorization and the geospatial location information between the vehicle and a management server for the global shared vehicle system; and
an energy store for providing power to operate the user interface subsystem, the data communication subsystem, and the location subsystem.

8. The vehicle of claim 7 further comprising a vehicle management subsystem configured to monitor an operational state of the vehicle.

9. The vehicle of claim 7, wherein the vehicle comprises a personal electric vehicle.

10. A method for sharing vehicles in a global shared vehicle management system comprising
receiving a query for a shared vehicle from a subscriber of the system over a communication network;
maintaining a real-time geospatial inventory of locations of vehicles in a fleet,
locating one or more shared vehicles in the geospatial inventory in geographic proximity of the subscriber;
transmitting a location of a shared vehicle proximate to the subscriber;
receiving confirmation of identification and authorization of the subscriber from the proximate shared vehicle; and
assigning the vehicle to the subscriber for exclusive use for a period of time.

11. The method of claim 10 further comprising
receiving a request to reserve the proximate shared vehicle for the subscriber;
transmitting an instruction to the proximate shared vehicle to maintain an inactive status until the subscriber presents identification and authentication for activation.

12. A vehicle accessory pack (VAP) for use in conjunction with a personal vehicle (PV), personal electric vehicle (PEV), or both, the VAP comprising
a data communication system for communicating with a fleet management system; and
a user interface configured to provide user access to the data communication system and access to and control of the vehicle.

13. The VAP of claim 12 further comprising a vehicle control system that interfaces with manufacturer control system for a vehicle to provide control of the vehicle to the user interface.

14. A locking and holding mechanism for a personal vehicle comprising
a connection device mounted to the vehicle; and
a receptacle mounted to a solid fixture; wherein
the receptacle is configured to directly receive and engage the connection device of the vehicle; and
once received, the vehicle is locked to the receptacle held in a stable position.

15. The locking and holding mechanism of claim 14, wherein a vehicle operator can engage the locking and holding mechanism in a single motion of the vehicle without removing hands from the vehicle.

16. The locking and holding mechanism of claim 14, wherein the vehicle comprises an electric vehicle.

17. The locking and holding mechanism of claim 16 further comprising an electrical connector that automatically connects with the vehicle when the vehicle received by the receptacle to provide electrical power to the vehicle or its subsystems

18. A vehicle accessory pack (VAP) for a personal vehicle, a personal electric vehicle (PEV), or both, the VAP comprising
an auxiliary power connection device positioned apart from a manufacturer power connection on the PEV and configured to electrically mate with a charging port;
a locking mechanism configured to mate with a locking structure in the charging port;
a data communication system for communicating with a fleet management system controlling the locking mechanism;
a user interface configured control the locking mechanism and to provide access to the data communication system to request authorization from the fleet management system to control the locking mechanism.

19. The VAP of claim 18 further comprising a backup power supply connected to the locking mechanism, the data communication system, and the user interface.

20. The VAP of claim 18 further comprising a power cord connecting the auxiliary power connection device to the manufacturer power receptacle.

21. The VAP of claim 18, wherein the user interface is further configured to receive user identification and authorization commands to verify the authorization request to the fleet management system to control the locking mechanism.

22. The VAP of claim 18, wherein the user interface is further configured to receive user identification and authorization commands to actuate the vehicle, additional functionality of the user interface, or both.

23. The VAP of claim 18, wherein the user interface further comprises an electromechanical keyed switch for actuation of the user interface, the vehicle, or both.

24. The VAP of claim 18, wherein the VAP further comprises a fleet control system that interfaces with a manufacturer control system of the vehicle to provide control of the manufacturer control system through the user interface, the fleet management system, or both.

25. The VAP of claim 18, wherein the locking mechanism is configured to automatically engage the locking structure when the auxiliary power receptacle electrically mates with the charging port.

26. The VAP of claim 18 further comprising
a convenience locking cable fastened to the VAP at a first end and forming a latch at a second end; and wherein
the VAP further comprises a lock receptacle sized to receive the latch;
the locking mechanism retains the latch when received inside the lock receptacle; and
the user interface is further configured to control the locking mechanism to release the latch.

27. The VAP of claim 26, wherein the VAP further comprises a security subsystem connected to the data communication system and the backup power supply that
energizes the convenience locking cable when the latch is received inside the lock receptacle;
monitors electrical continuity of the convenience locking cable; and
transmits an alert to the fleet management system via the data communication system when the electrical continuity is broken without the latch being released from the locking mechanism pursuant to appropriate authorization.

28. The VAP of claim 18, wherein
the data communication system further comprises a wireless communication device; and
the VAP further comprises
a geospatial positioning subsystem;
a security subsystem that monitors a geospatial location and speed of the PEV to identify aberrant behavior; and that
transmits an alert to the fleet management system via the wireless communication device when aberrant behavior is detected.

29. The VAP of claim 27 further comprising a backup power supply.

30. A personal electric vehicle (PEV) comprising
a vehicle accessory pack (VAP) having
an auxiliary power receptacle positioned apart from a manufacturer power receptacle on the PEV and configured to electrically mate with a charging port;
a locking structure configured to mate with a locking mechanism in the charging port;
a data communication system for communicating with an external control system controlling the locking mechanism in the charging port; and
a user interface configured to provide access to the data communication system to request that the control system unlock the locking mechanism; and
a power cord connecting the auxiliary power receptacle to the manufacturer power receptacle.

31. The PEV of claim 29, wherein the user interface is further configured to receive user identification and authorization commands to verify the request to the external control system to unlock the locking mechanism.

32. The PEV of claim 30, wherein the user interface is further configured to receive user identification and authorization commands to actuate the PEV, additional functionality of the user interface, or both.

33. The PEV of claim 30, wherein the user interface further comprises an electromechanical keyed switch for actuation of the user interface, the PEV, or both.

34. The PEV of claim 30, wherein the VAP further comprises a fleet control system that interfaces with a manufacturer control system of the PEV to provide control of the manufacturer control system through the user interface, the external control system, or both.

35. The PEV of claim 30, wherein the locking mechanism is configured to automatically engage the locking structure when the auxiliary power receptacle electrically mates with the charging port.

36. The PEV of claim 30, wherein the auxiliary power receptacle comprises
a charge cord further comprising
a set of electrical wires; and
a security cable;
a charge plug connected to a first end of the charge cord and configured to electrically mate the electrical wires with the charging port and to form the locking structure that is mechanically coupled with the security cable.

37. The PEV of claim 36, wherein a proximal end of the security cable is affixed to a frame member of the PEV.

38. The PEV of claim 36, wherein
the charge cord further comprises a set of data wires; and
the charge plug is configured to communicatively mate the data wires to corresponding data receptacles within the charging port to provide a communication link between the VAP and the control system.

39. The PEV of claim 36, where in the electrical wires and the security cable are encapsulated in a plastic overmoulding.

40. The PEV of claim 36 further comprising a sheath mounted to the PEV for retention of the charge cord.

41. The PEV of claim 40, wherein the charge cord further comprises a curved tape structure for facilitating storage of the charge cord within the sheath in a folded configuration.

42. The PEV of claim 40, wherein the electrical wires and the security cable are encapsulated in a plastic overmoulding configured to form a curved plastic body for facilitating storage of the charge cord within the sheath in a folded configuration.

43. A rental station for personal vehicles (PV), personal electric vehicles (PEV), or both, the rental station comprising
a rack structure;
a plurality of locking-holding ports mounted on the rack structure each configured to couple and mechanically lock with a respective vehicle;
a communication gateway communicatively coupled with each of the vehicles at or near the rental station and providing a communication link between a fleet management system and one or more of the vehicles.

44. The rental station of claim 43 further comprising
an electrical power connection at each of the locking-holding ports; and wherein
each of the locking-holding ports is configured to electrically couple with a respective vehicle.

45. The rental station of claim 43, wherein the communication gateway is wireless.

46. The rental station of claim 43, wherein the communication gateway is wired.

47. The rental station of claim 43, wherein the communication gateway is optical.

48. The rental station of claim 43, further comprising a kiosk computer that provides a user interface to interact with the fleet management system.

49. The rental station of claim 43, wherein each of the charging ports further comprises a user interface for controlling the respective charging port, communicating with the fleet management system, or both.
